(19) United States
(12) Patent Application Publication
(10) Pub. No.: US 2015/0026708 A1
(43) Pub. Date: Jan. 22, 2015

(54) Physical Presence and Advertising

(71) Applicant: Biscotti Inc., McKinney, TX (US)

(72) Inventors: Syed Nadeem Ahmed, Allen, TX (US); Matthew B. Shoemake, Allen, TX (US)

(21) Appl. No.: 14/472,133

(22) Filed: Aug. 28, 2014

Related U.S. Application Data
(63) Continuation-in-part of application No. 14/106,263, filed on Dec. 13, 2013.
Application No. 14/106,263 is a continuation-in-part of application No. 14/170,499, filed on Jan. 31, 2014.
Application No. 14/170,499 is a continuation-in-part of application No. 14/341,009, filed on Jul. 25, 2014.
Application No. 14/341,009 is a continuation-in-part of application No. 14/106,279, filed on Dec. 13, 2013.
Application No. 14/106,279 is a continuation-in-part of application No. 14/106,360, filed on Dec. 13, 2013.
Application No. 14/106,360 is a continuation-in-part of application No. 14/464,435, filed on Aug. 20, 2014.
(60) Provisional application No. 61/872,603, filed on Aug. 30, 2013.
(60) Provisional application No. 61/737,506, filed on Dec. 14, 2012.
(60) Provisional application No. 61/759,621, filed on Feb. 1, 2013.
(60) Provisional application No. 61/858,518, filed on Jul. 25, 2013.
(60) Provisional application No. 61/877,928, filed on Sep. 13, 2013.

(51) Int. Cl. H04N 21/2668; H04N 21/81; H04N 21/422; H04N 21/258; H04N 21/442; H04N 21/4223

(52) U.S. Cl. CPC H04N 21/2668; H04N 21/44218; H04N 21/4223; H04N 21/42203; H04N 21/25883; H04N 21/25891; H04N 21/812
USPC 725/12

(57) ABSTRACT

Novel tools and techniques are provided for enabling or implementing presence detection and/or advertising based on detected presence and/or based on monitored media content or monitored users. In some embodiments, media content—including, without limitation, movies, television programs, music, video games, and/or the like—may be presented to a user(s) via a presence detection device (“PDD”), and information regarding such presented media content may be monitored and sent to a server for analysis. The user(s) (and the user(s)'s reactions) may be monitored, and such monitored data may also be sent to the server for analysis. The server might determine (and present to the user(s)) at least one advertisement, based at least in part on each of one or more of the monitored media content, the monitored user(s), presence information of the user(s), user profile of the user(s), demographic group(s) of each user, and/or the like.

### CROSS-REFERENCES TO RELATED APPLICATIONS

This application claims the benefit, under 35 U.S.C. §119(e), of provisional U.S. Patent Application No. 61/872,603, filed Aug. 30, 2013 by Shoemake et al. and titled “Physical Presence and Advertising” (attorney docket no. 0414.10-PR, referred to herein as the “'603 application”).

This application is also a continuation-in-part of U.S. patent application Ser. No. 14/106,263, filed on Dec. 13, 2013 by Shoemake et al. and titled “Video Capture, Processing and Distribution System” (attorney docket no. 0414.06, referred to herein as the “'263 application”), which claims the benefit of provisional U.S. Patent Application No. 61/737,506, filed Dec. 14, 2012 by Shoemake et al. and titled “Video Capture, Processing and Distribution System” (attorney docket no. 0414.06-PR, referred to herein as the “'506 application”). This application is also a continuation in part of U.S. patent application Ser. No. 14/170,499, filed on Jan. 31, 2014 by Shoemake et al. and titled “Video Mail Capture, Processing and Distribution” (attorney docket no. 0414.07, referred to herein as the “'499 application”), which claims the benefit of provisional U.S. Patent Application No. 61/759,621, filed Feb. 1, 2013 by Shoemake et al. and titled “Video Mail Capture, Processing and Distribution” (attorney docket no. 0414.07-PR, referred to herein as the “'621 application”). This application is also a continuation-in part of U.S. patent application Ser. No. 14/341,009, filed on Jul. 25, 2014 by Shoemake et al. and titled “Video Calling and Conferencing Addressing” (attorney docket no. 0414.08, referred to herein as the “'009 application”), which claims the benefit of provisional U.S. Patent Application No. 61/858,518, filed Jul. 25, 2013 by Shoemake et al. and titled “Video Calling and Conferencing Addressing” (attorney docket no. 0414.08-PR, referred to herein as the “'518 application”). This application is also a continuation in part of U.S. patent application Ser. No. 14/106,279, filed on Dec. 13, 2013 by Ahmed et al. and titled “Mobile Presence Detection” (attorney docket no. 0414.12, referred to herein as the “'279 application”), which claims the benefit of provisional U.S. Patent Application No. 61/877,928, filed Sep. 13, 2013 by Ahmed et al. and titled “Mobile Presence Detection” (attorney docket no. 0414.12-PR, referred to herein as the “'928 application”). This application is also a continuation-in-part of U.S. patent application Ser. No. 14/106,360, filed on Dec. 13, 2013 by Ahmed et al. and titled “Distributed Infrastructure” (attorney docket no. 0414.13, referred to herein as the “'360 application”). This application is also a continuation-in-part of U.S. patent application Ser. No. 14/464,435, filed Aug. 20, 2014 by Shoemake et al. and titled “Monitoring, Trend Estimation, and User Recommendations” (attorney docket no. 0414.09, referred to herein as the “'435 application”).

This application may also be related to the following applications: provisional U.S. Patent Application No. 61/874,903, filed Sep. 6, 2013 by Shoemake et al. and titled “Virtual Window” (attorney docket no. 0414.11-PR, referred to herein as the “'903 application”); and provisional U.S. Patent Application No. 61/987,304, filed May 1, 2014 by Shoemake et al. and titled “Virtual Remote Functionality” (attorney docket no. 0414.15-PR, referred to herein as the “'304 application”).

The respective disclosures of these applications/patents (which this document refers to collectively as the “Related Applications”) are incorporated herein by reference in their entirety for all purposes.

### COPYRIGHT STATEMENT

A portion of the disclosure of this patent document contains material that is subject to copyright protection. The copyright owner has no objection to the facsimile reproduction by anyone of the patent document or the patent disclosure as it appears in the Patent and Trademark Office patent file or records, but otherwise reserves all copyright rights whatsoever.

### FIELD

The present disclosure relates, in general, to content presentation, and, more particularly, to tools and techniques for sensing the presence of a user in a room and/or for customizing transmitted content (including advertisements) based on the sensed presence.

### BACKGROUND

The proliferation of capable user devices, pervasive communication, and increased bandwidth has provided opportunity for many enhanced services for users. One example is video calling. Once the domain of high-end, dedicated systems from vendors such as POLYCOM®, video calling has become available to the average consumer at a reasonable cost. For example, the Biscotti™ device, available from Biscotti, Inc., provides an inexpensive tool to allow video calling using a high-definition television and an Internet connection. More generally, a class of devices, which have been described as “video calling devices” but are referred to herein as video communication devices (“VCDs”) can be simultaneously connected to a display (such as a television, to name one example) and a source of content (such as a set-top box (“STB”), to name an example) in a pass-through configuration and can have a network connection and/or sensors such as a camera, a microphone, infrared sensors, and/or other suitable sensors. Such devices present a powerful platform for various applications. Examples include, without limitation, video calling, instant messaging, presence detection, status updates, media streaming over the Internet, web content viewing, gaming, and DVR capability. Another example of such value added services is the introduction of online gaming. Rather than playing a game by him- or herself, a user now can play most games in a multiplayer mode, using communication over the Internet or another network.

Enabling such services is a new class of user device, which generally features relatively high-end processing capability (which would have been unthinkable outside supercomputing labs just a few years ago), substantial random access memory, and relatively vast non-transient storage capabilities, including hard drives, solid state drives, and the like. Such user devices can include, without limitation, the VCDs mentioned above, the presence detection devices (“PDDs”) described in the '279 application, various video game consoles, and the like. Such devices generally have a reliable, and relatively high-speed, connection to the Internet (to enable the value added services) and significant amounts of downtime, in which the processing and other capabilities of the devices are unused.

In the context of advertisement generation/creation and/or advertisement presentation, advertisers typically generalize advertisements to target certain demographics (e.g., males within the ages of 15-35, or the like) when generating advertisements. Such advertisements are then chosen to be presented during television events (or the like) for which the target demographic group is likely to be watching (e.g., during the Super Bowl game, for instance), and advertisers sometimes pay a premium for particular time slots for advertisements (again, the Super Bowl is another example of an event that is associated with premium advertisement space). However, to date, there is no way for the advertisers to know whether the advertisements that they create (and sometimes pay a premium to have presented) is even being viewed by or listened to by particular users (for example, the user might step out of the room for a restroom break or to grab a drink and/or snack, etc.). Sometimes, even if the user is viewing or listening to the advertisement, and the user belongs to a targeted demographic, the advertisement may simply not interest the user due to other factors particular to the user. Thus, there currently exists a problem for the advertisers that their advertisements might not actually be viewed or listened to by particular users and/or that their advertisements might be mis-targeted. For the users, irrelevant advertisements might be getting in the way of desired media content, thus leading to frustration. In some cases, the users' frustrations might transfer to frustration with particular advertisers, which, in the aggregate, may hurt the bottom line for the advertisers.

Hence, there is a need for solutions that allow for more flexible and robust advertising functionalities based on presence information of a user, and some such solutions can employ the powerful user devices already resident in many users' homes.

### BRIEF SUMMARY

A set of embodiments provides tools and techniques to sense the presence of one or more users in a room. In some embodiments, an inline camera can be used to sense such presence; in an aspect, such devices can sense the number of people present in the room and/or can identify one or more of the people present in the room. In some cases, such devices can sense whether a user is actively engaged with (e.g., watching) a display or other television. In an aspect of certain embodiments, such information can be used for a variety of purposes, including without limitation identifying content (including, merely by way of example, advertising content) that should be provided based on such information.

In some embodiments, media content—including, without limitation, movies, television programs, music, video games, and/or the like—may be presented to a user(s) via a presence detection device (“PDD”), and information regarding such presented media content may be monitored and sent to a server for analysis. The user(s) (and the user(s)'s reactions) may be monitored, and such monitored data may also be sent to the server for analysis. The server might determine (and present to the user(s)) at least one advertisement, based at least in part on each of one or more of the monitored media content, the monitored user(s), presence information of the user(s), user profile of the user(s), demographic group(s) of each user, and/or the like.

The techniques described herein can also be employed in a variety of video calling environments, and with a variety of different hardware and software configurations. Merely by way of example, these techniques can be used with video calling devices and systems described in detail in U.S. patent application Ser. No. 12/561,165, filed Sep. 16, 2009 by Shoemake et al. and titled “Real Time Video Communications System” (issued as U.S. Pat. No. 8,144,182) and in the '304, '360, '279, '928, '903, '435, '009, '518, '499, '621, '263, and '506, applications, each of which is incorporated by reference, as if set forth in full in this document, for all purposes.

According to some embodiments, inline cameras (which in some cases can be a stand-alone device or a device embodied in another suitable device including, but not limited to, a PDD as discussed above, or a video calling device, and/or the like) can also contain cameras, microphones, and other sensors. These sensors, in conjunction with the internal processing capability of the device allow the device to know when someone is in room. Additionally, the devices can also recognize who is in the room. They can also tell if users are actually looking at the television. These capabilities allow for very customized advertising based on whether someone is in the room, the identity of the person(s) in the room, and if they are looking at the TV. For example, the ability to determine whether someone is looking at the TV is a very useful tool for advertising, as it allows for feedback and the ability to determine whether advertising is effective. Inline cameras can use this to customize advertising for a particular user and to gauge the effectiveness of ads for advertisers.

In some embodiments, inline cameras can also determine the content of the audio/visual (“A/V”) stream that is coming from a set-top box (“STB”) or other local content source. This can be done in a number of ways. One way in which content can be identified is to search for watermarks that are often embedded in the audio/video stream itself. Watermark identification can be accomplished by using the processor in the inline camera to search for a known audio and/or video pattern that is embedded in the stream. The watermarks are typically designed to not be perceptible to users that may be watching the content. Once the watermark is identified, the channel or content that the STB is set to can be identified. Another approach to determining the content of the STB is classify the source of the content in the A/V stream itself by searching either for keywords, phrases that can be used for identification purposes or by “fingerprinting” the A/V stream and comparing the fingerprint against a database of fingerprints that are either local to the inline camera or on a network (such as on a control server, as described below). By determining the content coming from the STB, inline cameras can overlay advertising that is relevant to the A/V source that is coming from the STB. For example, if a user is watching a football game, then advertising relevant to the situation (i.e., the name of a local pizza shop that delivers to the user's home, deals for football memorabilia or team merchandise for the user's preferred team(s), etc.) can be displayed.

In other embodiments, inline cameras with cameras (or other sensors) also have an advantage over typical broadcast type advertising. The sensors on such devices know when users are in the room. The timing of when advertising can be set specifically to when someone is known (or detected and identified) to be in the room. In this manner, the likelihood of ads being viewed is much higher than broadcast advertisers are typically accustomed to. Further, inline cameras with cameras can determine not only that someone is in the room, but they can also determine who is in the room, using their sensors and facial recognition capability, or the like. This information allows for much more targeted type of advertising, because a particular user's profile and personal preferences can be used for advertising. For example, an adult male watching a football game can be shown a particular ad, while a female child watching the same show can be shown something entirely different. Additionally, when groups of people are in the room, ads that best fit the demographic of the people in the room can be shown. For example, when a device detects 3 adult females in the room and 2 male children, the system might determine to target the adult females.

In another aspect, some inline cameras can also determine whether or not a user is actually watching the television using its cameras and the facial recognition/eye tracking technology. This capability can be used to determine whether or not a user is watching or has watched a particular advertisement that is being displayed. This type of feedback is invaluable to advertisers, as it provides information that can be gathered and analyzed. The statistics can be given or sold back to advertisers who can then gauge the effectiveness of their ads. Somewhat similarly, inline cameras can also use the fact that they know when someone is watching to help determine when to display ads. The timing of ads can be done based on whether someone is actually watching the television or based on who is watching the television. For example, ads can be displayed when anyone is watching a particular show, or only when adults over the age of 40 are watching a particular show, and so on.

Physical presence can also be used to create enhanced placements for TV ads. Ads placements can be sold to advertisers based on (i) whether users are confirmed to be in the room or not, (ii) based on the number of users in the room, (iii) demographic profile of user in the room, (iv) number of users in the room, (v) whether a particular individual is in front of their TV, (vi) whether a user has watched a particular ad or not, (vii) what content a user is watching, (viii) time of day an ad is played, etc.

The tools provided by various embodiments include, without limitation, methods, systems, and/or software products. Merely by way of example, a method might comprise one or more procedures, any or all of which are executed by an image capture device (“ICD”), a PDD, and/or a computer system. Correspondingly, an embodiment might provide an ICD, a PDD, and/or a computer system configured with instructions to perform one or more procedures in accordance with methods provided by various other embodiments. Similarly, a computer program might comprise a set of instructions that are executable by an ICD, a PDD, and/or a computer system (and/or a processor therein) to perform such operations. In many cases, such software programs are encoded on physical, tangible, and/or non-transitory computer readable media (such as, to name but a few examples, optical media, magnetic media, and/or the like).

In an aspect, a method might comprise collecting, with a presence detection device, presence information of a user and identifying the user, with a first computer, based at least in part on identifying information derived from at least a portion of the presence information. The method might further comprise determining, with a second computer, at least one advertisement based at least in part on profile information of the identified user and presenting the at least one advertisement to the user.

According to some embodiments, the presence detection device might comprise a video input interface to receive video input from a local content source, an audio input interface to receive audio input from the local content source, a video output interface to provide video output to a display device, an audio output interface to provide audio output to an audio receiver, an image capture device to capture at least one of image data or video data, an audio capture device to capture audio data, a network interface, at least one processor, and a storage medium in communication with the at least one processor.

In some embodiments, the presence information might comprise at least one of an image captured by the image capture device, a video segment captured by the image capture device, an audio sample captured by the audio capture device, or a detected presence of a user device in proximity to the first presence detection device. In some cases, collecting the presence information might comprise capturing one or more images of at least a portion of a room with the image capture device. In some instances, the one or more images might comprise a video stream. In some embodiments, collecting the presence information might comprise analyzing the one or more images. In some cases, analyzing the one or more images might comprise determining a number of people in the room. In some instances, analyzing the one or more images might comprise determining a collective demographic of a plurality of people in the room. According to some embodiments, at least one of analyzing the one or more images or identifying the user might comprise determining an identity of at least one person in the room, using facial recognition technology. In some cases, analyzing the one or more images might comprise determining that a person is watching a display device, using eye tracking technology. In some embodiments, determining that a person is watching a display device, using eye tracking technology, might comprise determining that a person is watching particular portions of a display device corresponding to particular portions of media content being displayed on the display device, using eye tracking technology.

According to some embodiments, the second computer and the first computer might be the same computer. In some cases, the presence detection device and at least one of the first computer or the second computer might be the same device. In some embodiments, at least one of the first computer or the second computer might be a control server in communication with the presence detection device over a network. In some cases, presenting the at least one advertisement to the user might comprise instructing, with the control server, the presence detection device to present the at least one advertisement to the user.

In some embodiments, presenting the at least one advertisement to the user might comprise presenting the at least one advertisement to the user by inserting the at least one advertisement into a video stream. In some cases, inserting the at least one advertisement into a video stream might comprise overlaying the video stream with the at least one advertisement using the presence detection device. The presence detection device might be inline between a set top box and a television, according to some embodiments.

Merely by way of example, in some embodiments, presenting the at least one advertisement to the user might comprise sending a message with the at least one advertisement to a user device associated with the first user. The at least one advertisement might be in a form of at least one of a video-based advertisement, an audio-based advertisement, an image-based advertisement, a text-based advertisement, and/or a multi-media-based advertisement. The message might comprise one or more of a text message, a short message service message, a multi-media messaging service message, a chat message, an e-mail message, a videomail message, and/or a voicemail message. In some instances, the user device associated with the first user might comprise at least one of a laptop computer, a smart phone, a mobile phone, a portable gaming device, a desktop computer, a television, a set-top box, and/or a wearable computing device.

According to some embodiments, the method might further comprise collecting, with the presence detection device, feedback from the user regarding the at least one advertisement. In some instances, the at least one advertisement might be associated with an advertiser. In such cases, the method might further comprise providing the feedback to the advertiser.

In some embodiments, the method might further comprise receiving, with the presence detection device, first media content from a local content source, monitoring, with the presence detection device, information associated with the first media content, and sending, with the presence detection device, the monitored information associated with the first media content to the second computer over a network. The method might also comprise receiving, with the presence detection device and from the second computer, the determined at least one advertisement. In some cases, determining the at least one advertisement might be based at least in part on the monitored information associated with the first media content and at least in part on the profile information of the identified user. According to some embodiments, the first media content might comprise media content type selected from a group consisting of television program content, movie content, music content, gaming content, news-related content, sports-related content, video clip content, advertisement content, and Internet-based media content.

In some cases, the information associated with the first media content might comprise media content-based information comprising at least one of type of media content of the first media content; genre of media content of the first media content; duration of the first media content; time of day that the first media content is received or presented; performers associated with the first media content; producers associated with the first media content; year of release of the first media content; reviews of the first media content; and/or other media content related to the first media content.

In some embodiments, the method might further comprise monitoring, with the presence detection device, information associated with the presented at least one advertisement, and determining, with the second computer, at least one second advertisement, based at least in part on the monitored information associated with the first media content, at least in part on the monitored information associated with the presented at least one advertisement, and at least in part on the profile information of the identified user. In some instances, each of the information associated with the first media content or the information associated with the presented at least one advertisement might comprise audience-based information comprising at least one of number of audience members present during presentation of particular portions of the first media content or the presented at least one advertisement; identity of each audience member; gender of each audience member; age of each audience member; demographic group to which each audience member belongs; viewing patterns of each audience member; specific reactions of each audience member during presentation of particular portions of the first media content or particular portions of the presented at least one advertisement; overall reactions of each audience member throughout presentation of the first media content or the presented at least one advertisement; consistency of audience member reactions of each audience member compared with personal preferences of the audience member; and/or consistency of audience member reactions of each audience member compared with past reactions of the audience member.

According to some embodiments, each of the specific reactions or the overall reactions might comprise reactions selected from a group consisting of vocal expressions, facial expressions, hand gestures, body gestures, eye movement, eye focus, and shift in proximity with respect to the presence detection device. In some cases, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, and/or proximity detection techniques.

In some cases, the determination of the at least one advertisement might be based at least in part on analysis of one or more of identification of each person in a room in which the presence detection device is located, identification of each person viewing the first media content being displayed on a display device communicatively coupled to a video output interface of the presence detection device, and/or identification of each person listening to the first media content being presented over a speaker communicatively coupled to an audio receiver that is communicatively coupled to an audio output interface of the presence detection device.

In another aspect, an apparatus might comprise a non-transitory computer readable medium having encoded thereon a set of instructions executable by one or more processors to perform one or more operations. The set of instructions might comprise instructions for receiving presence information from a presence detection device and instructions for determining at least one advertisement to serve, based at least in part on the presence information.

In yet another aspect, a system might comprise a computer and a presence detection device. The computer might comprise one or more first processors and a first non-transitory computer readable medium in communication with the one or more first processors. The first non-transitory computer readable medium might have encoded thereon a first set of instructions executable by the one or more first processors to perform one or more operations. The first set of instructions might comprise instructions for receiving presence information of a user from the presence detection device and instructions for determining at least one advertisement to serve, based at least in part on the presence information of the user. The presence detection device might be configured to collect the presence information. The presence detection device might comprise a video input interface to receive video input from a local content source, an audio input interface to receive audio input from the local content source, a video output interface to provide video output to a display device, an audio output interface to provide audio output to an audio receiver, an image capture device to capture at least one of image data or video data, an audio capture device to capture audio data, a network interface, one or more second processors, and a second non-transitory computer readable medium in communication with the one or more second processors. The second non-transitory computer readable medium might have encoded thereon a second set of instructions executable by the one or more second processors to control operation of the presence detection device.

The second set of instructions might comprise instructions for controlling the image capture device to capture one of a video stream or at least one image of the user, instructions for controlling the audio capture device to capture an audio stream, instructions for encoding the captured video stream and the captured audio stream to produce a series of data packets comprising presence information of the user, and instructions for transmitting, using the network interface, the series of data packets comprising presence information of the user, for reception by the computer. The second set of instructions might further comprise instructions for receiving, from the computer, the determined at least one advertisement that is based at least in part on the presence information of the user, and instructions for presenting the determined at least one advertisement to the user.

In still another aspect, an image capture device might be configured to be accessible over a network. The image capture device might comprise an image sensor to capture at least one of image data or video data, a communication system, one or more processors, and a computer readable medium in communication with the one or more processors. The computer readable medium might have encoded thereon a set of instructions executable by the computer system to perform one or more operations. The set of instructions might comprise instructions for collecting presence information of a user and instructions for sending the collected presence information to a computer over a network to determine at least one advertisement to serve to the user, based at least in part on profile information of the user.

In some embodiments, the set of instructions might further comprise instructions for identifying the user, based at least in part on identifying information derived from at least a portion of the presence information. In some cases, the instructions for sending the collected presence information to the computer might comprise instructions for sending information pertaining to an identification of the user. According to some embodiments, the set of instructions might further comprise instructions for presenting the at least one advertisement to the user.

Various modifications and additions can be made to the embodiments discussed without departing from the scope of the invention. For example, while the embodiments described above refer to particular features, the scope of this invention also includes embodiments having different combination of features and embodiments that do not include all of the above described features.

### BRIEF DESCRIPTION OF THE DRAWINGS

A further understanding of the nature and advantages of particular embodiments may be realized by reference to the remaining portions of the specification and the drawings, in which like reference numerals are used to refer to similar components. In some instances, a sub-label is associated with a reference numeral to denote one of multiple similar components. When reference is made to a reference numeral without specification to an existing sub-label, it is intended to refer to all such multiple similar components.

FIG. 1 is a block diagram illustrating a system for enabling or implementing presence detection and/or advertising based on detected presence and/or based on monitored media content or monitored users, in accordance with various embodiments.

FIGS. 2A and 2B are process flow diagrams illustrating various methods of enabling or implementing presence detection and/or advertising based on detected presence and/or based on monitored media content or monitored users, in accordance with various embodiments.

FIGS. 3A and 3B are process flow diagram illustrating various other methods of enabling or implementing presence detection and/or advertising based on detected presence and/or based on monitored media content or monitored users, in accordance with various embodiments.

FIG. 4 is a process flow diagram illustrating yet another method of enabling or implementing presence detection and/or advertising based on detected presence and/or based on monitored media content or monitored users, in accordance with various embodiments.

FIG. 5 is a block diagram illustrating another system for enabling or implementing presence detection and/or advertising based on detected presence and/or based on monitored media content or monitored users, in accordance with various embodiments.

FIGS. 6A-6D are illustrations of user devices used by users that present exemplary graphical user interfaces for presenting advertisements to users, in accordance with various embodiments.

FIG. 7 is a generalized schematic diagram illustrating a computer system, in accordance with various embodiments.

FIG. 8 is a block diagram illustrating a networked system of computers, which can be used in accordance with various embodiments.

### DETAILED DESCRIPTION OF CERTAIN EMBODIMENTS

While various aspects and features of certain embodiments have been summarized above, the following detailed description illustrates a few exemplary embodiments in further detail to enable one of skill in the art to practice such embodiments. The described examples are provided for illustrative purposes and are not intended to limit the scope of the invention.

In the following description, for the purposes of explanation, numerous specific details are set forth in order to provide a thorough understanding of the described embodiments. It will be apparent to one skilled in the art, however, that other embodiments of the present invention may be practiced without some of these specific details. In other instances, certain structures and devices are shown in block diagram form. Several embodiments are described herein, and while various features are ascribed to different embodiments, it should be appreciated that the features described with respect to one embodiment may be incorporated with other embodiments as well. By the same token, however, no single feature or features of any described embodiment should be considered essential to every embodiment of the invention, as other embodiments of the invention may omit such features.

Unless otherwise indicated, all numbers used herein to express quantities, dimensions, and so forth used should be understood as being modified in all instances by the term “about.” In this application, the use of the singular includes the plural unless specifically stated otherwise, and use of the terms “and” and “or” means “and/or” unless otherwise indicated. Moreover, the use of the term “including,” as well as other forms, such as “includes” and “included,” should be considered non-exclusive. Also, terms such as “element” or “component” encompass both elements and components comprising one unit and elements and components that comprise more than one unit, unless specifically stated otherwise.

### Features Provided by Various Embodiments

Presence Detection Functionalities

Presence Detection Devices (“PDDs”) or Image Capture Devices (“ICDs”) provided by various embodiments can contain or communicate with, inter alia, cameras, microphones, and/or other sensors (including, without limitation, infrared (“IR”) sensors). These sensors, in conjunction with the internal processing capability of the device, can allow the device to detect when a person is in the room. Additionally, through means such as facial recognition and voice detection, or the like, the devices also can automatically recognize who is in the room. More specifically, such devices can detect the presence of a particular individual. In some aspects, ICDs might contain or communicate with, inter alia, image capture devices for capturing images or video of the person or people in the room. In some cases, ICDs might also contain or communicate with, inter alia, microphones, and/or other sensors (including, without limitation, infrared (“IR”) sensors). According to some embodiments, some ICDs might have similar functionality as PDDs.

In various embodiments, presence detection can be local and/or cloud based. In the case of local presence detection, the PDD or ICD itself might keep a list of all user profiles and will attempt to match an individual against its local list of all users. In cloud based detection, the functionality of user detection can be moved into servers in the cloud. A cloud based approach allows detection of a user's presence to be mobile among various devices (whether or not owned by, and/or associated with, the user). That same user can be detected on his or her device or on any other device that has the same capability and that is tied into the same cloud infrastructure.

The ability to automatically detect the presence of an individual on any device presents a powerful new paradigm for many applications including automation, customization, content delivery, gaming, video calling, advertising, and others. Advantageously, in some embodiments, a user's content, services, games, profiles (e.g., contacts list(s), social media friends, viewing/listening/gaming patterns or history, etc.), videomail, e-mail, content recommendations, determined advertisements, preferences for advertisements, and/or preferences (e.g., content preferences, content recommendation preferences, notification preferences, and/or the like), etc. can follow that user from device to device, including devices that are not owned by (or previously associated with) the individual, as described in detail in the '279 application (already incorporated herein). Alternatively, or in addition, presence detection functionality can also allow for mobile presence detection that enables remote access and control of ICDs over a network, following automatic identification and authentication of the user by any device (e.g., PDD, ICD, or other device) so long as such device has authentication functionality that is or can be tied to the access and control of the ICDs, regardless of whether or not such device is owned or associated with the user. In other words, the ability to remotely access and control one's ICDs over a network can follow the user wherever he or she goes, in a similar manner to the user's content and profiles following the user as described in the '279 application. Such remote control of ICDs, as well as post-processing of video and/or image data captured by the ICDs, is described in detail in the '263 application (which is already incorporated by reference herein).

Various sensors on a PDD or an ICD (and/or a video calling device) can be used for user detection. Facial recognition can be used to identify a particular individual's facial characteristics, and/or voice detection can be used to uniquely identify a person. Additionally, PDDs, ICDs, and/or video calling devices may also have local data storage. This local data storage can be used to store a database of user profiles. The user profiles can contain the various mechanisms that can be used to identify a person, including username and password, facial characteristics, voice characteristics, etc. When sensors detect the facial features or capture the voice of a particular individual, that captured presence information can be compared against the characteristics of the users on the local storage. If a match is found, then the individual has been successfully identified by the device. (As used herein, the term “presence information” can be any data or information that can be used to determine the presence of a user, and/or to identify and/or authenticate such a user. As such, presence information can include raw image, video, or audio data, analyzed data (e.g., video or image data to which preliminary facial recognition procedures, such as feature extraction, have been employed, as well as verification of audio self-identification or verification of audio challenge/response information), the results of such analysis, and even the end result of the detection process—i.e., a notification that a user is present and/or an identification of the user.)

Detection of a user's presence can also be performed via proximity of a PDD, an ICD, and/or a video calling device to another device. For example, if a user's mobile phone, smart phone, tablet, or PC is near the PDD, the ICD, and/or the video calling device, that person is automatically detected. In some instances, a unique device identifier for each of a user's devices might have previously been associated with the user's profile in a cloud database or the like (i.e., making the user's devices “known devices”), and detection of such unique device identifiers might serve as a basis for identifying the user, or might streamline the identification process by verifying whether the person with the device owned by or associated with the known device is the user or simply someone in possession of the device(s) (whether lawful or unlawful). Such verification might comprise one or more of facial recognition, voice recognition, audio challenge/response verification, biometric analysis, or the like. In some cases, audio challenge/response verification might include analysis of sub-vocal responses from the person challenged, to prevent undesired casual overhearing of audio passwords, audio keyphrases, or the like. In some instances, biometric analysis might include analysis of any suitable biometric (aside from facial and voice recognition) selected from a group consisting of fingerprint, iris, pupil, height, unique scar(s), other unique physical characteristics, and/or any combination of these biometrics. To capture biometric information such as fingerprints, iris, pupil, height, scar, or other unique physical characteristics, which might be image-based biometrics (which might be captured by a high resolution image capture device of the PDD, the ICD, and/or the video calling device), the PDD, the ICD, and/or the video calling device might prompt the person being detected to position himself or herself so that his or her fingerprints, iris, pupil, full body, scar, or other unique physical characteristics, respectively, are appropriately facing the image capture device of the PDD and/or the ICD.

In some embodiments, with detection of known devices and with automatic detection/identification processes being enabled, it may be possible for the system to identify persons not normally associated with a known device being in possession of the known device. In such a case, the system might notify the original user (via e-mail or other forms of communication indicated in the user's profile, or the like) of the situation. In some instances, the user might indicate that the unknown person does have authority or permission to use, or be in possession of, the user's device. In other cases, where the user indicates that the user does not have authority or permission to use the device, the user may be given options to proceed, including, without limitation, options to lock data, options to lock device functions, options to activate location tracking (including, without limitation, global positioning system (“GPS”), global navigation satellite system (“GNSS”), etc.) of the device (in case the system loses track of the device; e.g., in the case the device moves outside the range of the system's sensor/detection/communications systems), options to contact the unknown person, options to activate speakers to emit sirens, options to activate displays or lights (e.g., light emitting diodes (“LEDs”), organic LEDs (“OLEDs”), liquid crystal displays (“LCDs”), etc.), and/or options to notify authorities (e.g., police or other law enforcement personnel) of the situation and/or the location of the device (e.g., GPS coordinates, or the like), etc.

Additionally and/or alternatively, proximity detection can be done using GNSS location tracking functionality, which can be found in many electronic devices and authenticating the user when the secondary device is within a predefined distance of the PDD, the ICD, and/or the video calling device. Proximity detection can also be done wirelessly via Bluetooth or WiFi. With respect to Bluetooth, if the secondary device pairs with the PDD, the ICD, and/or the video calling device, the user can be considered detected. With respect to WiFi, one approach could be to see if the secondary device associates with the same WiFi access point to which the PDD, the ICD, and/or the video calling device is connected. Another approach to proximity detection is the use of near-field communications (“NFC”) commonly found in many electronic devices. When the secondary device is within range of the PDD, the ICD, and/or the video calling device, a NFC detector can be used to determine that the user is in the room. From these examples, a skilled reader should appreciate that many different techniques can be used to detect presence based on device proximity.

According to some embodiments, regardless of the specific manner in which the user's electronic device, personal device, or user device is detected, presence may be determined or inferred by knowing the location of the personal device (which might include, without limitation, at least one of a laptop computer, a smart phone, a mobile phone, a portable gaming device, a desktop computer, a television, a set-top box, or a wearable computing device, and/or the like). When the personal device is close to the display device (or the PDD, ICD, and/or video calling device), it may be determined that the personal device (and hence the user associated with the personal device) is present. Based on the presence of the user and information about the user, advertisement content (which may be determined to be relevant to the user) may be sent to the display device. In this manner, a highly targeted advertising may be implemented (which may be embodied, in some cases, as a highly targeted form of television advertisement, which may be thought of as being similar to what is done on web browsers today, but much more targeted). From the user's perspective, when he or she is in the room, the advertisements on the display device (e.g., a TV or the like) may become customized to him or her (based on detection of the presence of the user and/or based on detection of the presence of his or her personal device, and, in some cases, based also on the user's profile, other information about the user, and/or the like). In some embodiments, the PDD/ICD/video calling device may be one of the personal device itself, a computer/server in the cloud, and/or the personal device in conjunction with some computer/server in the cloud, or the like. The advertisement may be sent to a local content source (e.g., an STB or the like) or another PDD/ICD/video calling device that has the ability to control content being played or sent to the display device (and/or, of course, to receive the advertisement from a content server). Such a method or apparatus may allow for the targeted presentation (or selling) of advertisements directly to the display device (e.g., TV or the like), based on characteristics of the user. In some cases, among other information about the user that can be taken into account, determination of advertisements to send to the display device might be based on, or might otherwise take into account, the user's Internet browsing history, the user's Internet browsing patterns, the user's Internet browser bookmarks/favorites, and/or the like.

In some embodiments, detection of an individual can be fully automatic and might (in some instances) require no user interaction. For example, the system can characterize an individual's facial features (and/or unique physical characteristics or other biometrics) automatically, detect the presence of a secondary device, characterize an individual's voice print automatically, etc. Several detection methods can be used in combination to reduce errors in the detection process. For example, if the system detects a person in the room and first identifies that person's facial features, it can then prompt them for voice (e.g., “Bob, is that you?”). Once the user's voice is captured, that audio sample can be compared against the stored voice characteristics for that user, to reduce false detection. Another approach for the second step may be to prompt the user to speak a PIN or password to be compared against what is stored in the user profile. Using this approach, the characteristics of the speech (e.g., user's voice, cadence, syntax, diction) and the content of the speech (e.g., a PIN or password) can be jointly used to reduce false detections. To prevent eavesdropping of passwords or PINs, the audio capture device might be configured to capture sub-vocalizations of the passwords or PINs, for analysis. Alternatively and/or additionally, the system can prompt the user to position his or her body so as to allow the image capture device to face one or more of the user's fingers (e.g., for fingerprint analysis), the user's eyes (e.g., for iris and/or pupil analysis), the user's full body (e.g., for height analysis), portions of the user's body (e.g., for analysis of scars or other unique physical characteristics, or the like), etc.

In some embodiments, physical geography can be used as a metric in detection to reduce the possibility of errors. For example, if a user is known to use the system in Dallas, Tex., and then is detected in Madrid, Spain, the system can weigh detection in Spain lower than detection in Dallas. Additionally, if the user is detected in Spain, a secondary authentication method may optionally be invoked to reduce false detection. According to some embodiments, in the case that the system has access to profile or other personal information of the user such as communications, calendar items, contacts list, travel/itinerary information, or the like that might indicate that the user might be visiting a friend or relative in Spain having a similar PDD, ICD, and/or video calling device linked to a common network or cloud server, the system might determine that the user is or will be in Spain. In such a case, the user's profiles, media content, preferences, content recommendations, determined advertisements, preferences for advertisements, or the like (or access thereto) might be sent to the friend's or relative's device in Spain or to a local data center or the like to allow the user to access the user's own content or profiles on the friend's or relative's device during the visit; in particular embodiments, the user's profiles might include access and control information for remotely accessing and controlling the user's ICDs over a network, while the user's content might include image data and/or video data captured by the user's ICDs (either in raw or processed form). After the scheduled visit, it may be determined using any combination of the user's personal information, the user's devices (including the user's PDD, ICD, and/or video calling device, mobile devices, etc.), and/or the friend's or relative's device whether the user has left the friend's or relative's location (in this example, Spain). If so determined, the content and profiles (or access thereto, as the case may be) might be removed from the friend's or relative's device (and/or from the data center or the like that is local to said device).

In particular embodiments, a PDD, an ICD, and/or a video calling device can also be connected to a network, such as the Internet. In such a scenario, the database of user profiles, including identifiable facial and/or voice characteristics, as well as other identifying information (e.g., passwords, identifying information for other devices owned by the user, etc.), can be stored on servers located in the cloud, i.e., on the network or in a distributed computing system available over the network. In some cases, the distributed computing system might comprise a plurality of PDDs, a plurality of ICDs, and/or a plurality of video calling devices in communication with each other either directly or indirectly over the network. The distributed computing system, in some instances, might comprise one or more central cloud servers linking the plurality of PDDs, the plurality of ICDs, and/or the plurality of video calling devices and controlling the distribution and redundant storage of media content, access to content, user profiles, user data, content recommendations, determined advertisements, preferences for advertisements, and/or the like. When an individual's facial features are detected by a PDD, an ICD, and/or a video calling device, those features (and/or an image captured by the PDD, the ICD, and/or the video calling device) can be sent to a server on the network. The server then can compare the identifiable facial features against the database of user profiles. If a match is found, then the server might inform the device of the identity of the user and/or might send a user profile for the user to the device.

User profiles, including facial characteristics, can be stored both locally on the device and on a server located in the cloud. When using both device-based and cloud-based databases, user identification can be performed by first checking the local database to see if there is a match, and if there is no local match, then checking the cloud-based database. The advantage of this approach is that it is faster for user identification in the case where the user profile is contained in the local database. In some embodiments, the database on the device can be configured to stay synchronized with the database in the cloud. For example, if a change is made to a user profile on the device, that change can be sent to the server and reflected on the database in the cloud. Similarly, if a change is made to the user profile in the cloud-based database, that change can be reflected on the device database.

Matching presence information or identifying information with an individual having a user profile can be a form of authentication in some embodiments. User profiles can also contain information necessary for many authentication mechanisms. Such information may include challenge/response pairs (such as username and password combinations, security question/pass phrase combinations, or the like), facial recognition profiles, voice recognition profiles, and/or other biometric information, such as fingerprints, etc. An individual may be authenticated using any combination of such techniques.

In some cases, the system can also determine when a user is no longer present. Merely by way of example, a PDD, an ICD, and/or a video calling device might continually (or periodically) monitor for the user's presence. For instance, in the case of facial recognition, the device can continually check to detect whether a captured image includes the user's face. With voice recognition, after a period of inactivity, the device might prompt the user if they are there (e.g., “Bob, are you still there?”).

According to some embodiments, user profiles can work across heterogeneous networks. Not all user devices need to be the same. Some user devices might be PDDs, ICDs, and/or video calling devices. Other user devices might be computers, tablets, smart phones, mobile phones, etc. Each device can use any appropriate method (based on device capabilities) to determine the presence of, identify, and/or authenticate the user of the device with a user profile.

In an aspect, this automated presence detection can be used to provide user information (e.g., content, content recommendations, determined advertisements, preferences for advertisements, and/or services) to an identified user. With a PDD, an ICD, and/or a video calling device, when a user enters the room, and the camera sensors detect that user's facial features (or other biometric features) and authenticates the individual, the content associated with that user profile (including, without limitation, profile information for handling media content, for handling content recommendations, for handling notification of content recommendations, for handling determination of advertisements, for handling presentation of advertisements, and/or the like) can automatically become available to that individual. Additionally, with the cloud-based authentication approach described herein, that user's content, content recommendations, determined advertisements, preferences for advertisements, and/or profiles can become available on any device. More specifically, if a user is identified by another PDD, ICD, and/or video calling device, then his or her content (e.g., media content, and/or the like), content recommendations, determined advertisements, preferences for advertisements, profiles, etc., become available to him or her even if the PDD, ICD, and/or video calling device that he or she is in front of is not the user's own device. This functionality allows a new paradigm in which the user's content, content recommendations, determined advertisements, preferences for advertisements, and/or profiles follow the user automatically. Similarly, when upgrading PDDs, ICDs, and/or video calling devices, detection, identification, and authentication of the user on the new device can allow automatic and easy porting of the user's content, content recommendations, determined advertisements, preferences for advertisements, and/or profiles to the new device, allowing for an ultimate type of “plug-and-play” functionality, especially if the profiles include information on configurations and settings of the user devices (and interconnections with other devices).

PDDs, ICDs, and/or video calling devices also are capable of handling, transmitting, and/or distributing image captured content, which can include, but is not limited to, video mail and/or video mail data captured or recorded by the video calling devices. In some cases, the video mail and/or video mail data might be raw data, while in other cases they might be post-processed data. Video mail and/or video mail data can be stored on servers in the cloud, on PDDs, ICDs, and/or video calling devices in the cloud, and/or locally on a particular user device. When accessing video mail and/or video mail data from another device, the first PDD and/or video calling device that has the video mail and/or video mail data stored thereon needs to serve the video mail and/or video mail data to the new device that the user is using. In order to do this, the new PDD, ICD, and/or video calling device might need to get a list of video mail and/or video mail data that is stored on the first PDD and/or video calling device. This can, in some embodiments, be facilitated via a server that is in the cloud that all PDDs, ICDs, and/or video calling devices are always or mostly connected to. The server can communicate with all PDDs, ICDs, and/or video calling devices and help send messages between PDDs, ICDs, and/or video calling devices. When a user is authenticated with a new PDD, ICD, and/or video calling device, the new device can request the list of video mail and/or video mail data from the first device. If the user requests video mail and/or video mail data from the new device, then the first PDD, ICD, and/or video calling device (or the other user device) can serve the video mail and/or video mail data to the new device. This can be done either directly in a peer-to-peer fashion or can be facilitated by the server. In some embodiments, this communication can be accomplished by using protocols such as XMPP, SIP, TCP/IP, RTP, UDP, etc. Videomail capture, processing, and distribution is described in detail in the '499 application, which is already incorporated herein by reference.

As discussed above, identification and authentication of a user by a PDD, an ICD, and/or a video calling device (whether or not associated with or owned by the user) can provide the user with remote access and control of the user's PDD(s), ICD(s), and/or video calling device(s) over a network (e.g., by porting the user's profiles associated with remote access and control of the user's device(s), and/or the like to the current PDD, ICD, and/or video calling device in front of which the user is located). This functionality allows the user to remotely access media content, to remotely access and modify settings for content recommendations, to remotely access and modify settings for advertisements, and to remotely access and modify user profiles, and/or the like.

Master Account

Some embodiments employ a master account for access to a video calling device. In an aspect, a master account can be created on a per user basis. This master account might serve as the top-level identifier for a particular user. In some cases, the master account may be used to manage, control, and monitor a user's camera(s) and/or other device functionalities (whether hardware and/or software-based). Additionally, the master account can be used to control any account or device level services that are available.

For example, an email account and password can be used as a master account to manage a user's settings for accessing media content, for accessing and modifying settings for content recommendations, for accessing and modifying settings for advertisements, and for accessing and modifying user profiles, and/or the like.

Device Association

For proper management and control of a PDD, ICD, and/or video calling device, some embodiments provide the ability to reliably associate a PDD, ICD, and/or video calling device with a master account (i.e., assign the device to the master account). When a PDD, ICD, and/or video calling device is associated with an account, then it can be managed and controlled from within the master account. Association ensures that a PDD, ICD, and/or video calling device is being controlled by the appropriate user and not an unauthorized user.

A PDD, ICD, and/or video calling device may be associated with a particular master account at the time of the device setup. During device setup, the user is prompted to enter a master account and password. When doing so, a secure communications channel may be opened up between video calling device and servers. Then, a unique and difficult to guess key can be sent from the device to the server. Servers that have a master list of all keys then can associate that particular device, via its serial number, to a particular master account. A feature of this approach is that a user only needs to enter a password at the time of device setup. The user never needs to enter a password again, and in fact, passwords do not need to be stored on the device at all, making them very secure.

Device Management and Remote Configuration

Once a device has been associated with a master account, it may be managed from the master account via an interface such as a web interface, in accordance with some embodiments. The communication link between the device and server may, in some cases, be always encrypted and authenticated. This ensures that messages between device and server are secure and ensures that the device knows it is communicating with the server on behalf of the appropriate master account. Once the secure and authenticated link is established, devices can connect to the server and are able to send and receive commands.

The device and server can have a common set of command codes and responses. Servers can send commands down to the camera(s) to enact specific behavior. For example, the server can send remote configuration commands. These commands can be items such as changing the device address, changing the nickname that is associated with the device, changing the avatar image associated with the device. In addition to configuration, the commands can be used to enact specific behavior on the device, such as running network tests, or taking a live image(s) from the video calling device. New commands and features can be added by extending the set of command codes on the device and server.

Media Content Recommendation

PDDs, ICDs, and/or video calling devices also are capable of determining and/or generating media content recommendations, based on a number of factors. In some cases, the factors might include, without limitation, what the user is viewing, listening to, and/or playing, what friends of the user (e.g., known friends, social media friends, and/or the like) are viewing, listening to, and/or playing, trending media content, reactions of the user to media content, etc.

By analyzing what users are viewing, the various systems are able to determine what programs and television stations are of particular interest to particular users. This information can then be provided to the particular users, thereby helping them to find programs that are most interesting to them, in a timely fashion. The various embodiments include various methods and systems for determining what users are watching, various methods and systems for analyzing the collected data to determine trends, and/or various methods and systems for providing information to users to help guide their viewing, listening, and/or gaming experience.

In some embodiments, a PDD might connect to a server via an Internet connection. The server may be thought of as being in the cloud. In some cases, the PDD might also provide a pass-through connection between a set top box (“STB”; or other local content source) and a display device (e.g., a television or TV; which in some cases might have audio output capabilities), in some instances via high-definition multimedia interface (“HDMI”) cable connections or similar cable connections; that is, media content that is received from the STB is sent to the PDD and the PDD then passes that media content to the TV. In some cases, the PDD might modify the signals carrying the media content to enhance or add additional content and/or information prior to output of the media content. The PDD might monitor content coming from the STB and might determine what the content is. Alternatively, or additionally, the PDD might monitor content received through the network (e.g., Internet), which may not necessarily be sent from the STB. The PDD might subsequently provide the monitored data or information to the server for analysis. The server might analyze the monitored data or information from many PDDs and might form or generate recommendations of media content. These recommendations might then be provided to individual PDDs, which might make the recommendations to the user (i.e., by displaying or otherwise presenting the recommendations to the user). In some cases, the recommendation to the user may be via audio and/or video notice, and the recommendation may be made by passing the audio and/or video notice to the TV. Alternatively, or additionally, the recommendation to the user may be via e-mail message, text message, chat message, short message service (“SMS”) message, multi-media messaging service (“MMS”) message, videomail message, voicemail message, and/or other messaging communications.

Media content recommendations and generation thereof (in some cases, based on trend estimation) is described in detail in the '435 application, which is already incorporated herein by reference.

Advertising Based on Physical Presence

Various methods allow for analyzing programming to determine advertisements based on presence information of a user. Further, by analyzing what users are viewing, the various systems are able to determine what programs and television stations are of particular interest to particular users. This information can then be provided to advertisers, thereby helping them to find, generate, or create advertisements that are most interesting to the user, preferably in a timely fashion (so as to not be out of date with what the user is currently interested in). The various embodiments include various methods and systems for determining what users are watching, various methods and systems for analyzing the collected data to determine trends, and/or various methods and systems for determining and providing advertisements to users that are relevant to the user.

In some embodiments, a PDD might connect to a server via an Internet connection. The server may be thought of as being in the cloud. In some cases, the PDD might also provide a pass-through connection between a set top box (“STB”; or other local content source) and a display device (e.g., a television or TV; which in some cases might have audio output capabilities), in some instances via high-definition multimedia interface (“HDMI”) cable connections or similar cable connections; that is, media content that is received from the STB is sent to the PDD and the PDD then passes that media content to the TV. In some cases, the PDD might modify the signals carrying the media content to enhance or add additional content (including advertisements) and/or information prior to output of the media content. The PDD might monitor content coming from the STB and might determine what the content is. Alternatively, or additionally, the PDD might monitor content received through the network (e.g., Internet), which may not necessarily be sent from the STB. The PDD might subsequently provide the monitored data or information to the server for analysis. The server might analyze the monitored data or information from many PDDs and might determine advertisements that are relevant to the user. These advertisements might then be provided to individual PDDs, which might present the advertisements to the user (i.e., by displaying or otherwise presenting the advertisements to the user). In some cases, the advertisements may be presented via audio and/or video notice, and the advertisements may be made by passing the audio and/or video notice to the TV. Alternatively, or additionally, the advertisements may be presented via e-mail message, text message, chat message, short message service (“SMS”) message, multi-media messaging service (“MMS”) message, videomail message, voicemail message, and/or other messaging communications.

While the analysis function may be performed in the PDD, it is most typically performed in the server that is connected to the PDD over the Internet or other network. In some cases, there may be multiple PDDs (although multiple PDDs is not a requirement). The PDDs have the ability to monitor programming from their respective STB or local content source. The PDDs may also monitor content that are played directly from the Internet (e.g., from YouTube or some other media content source (e.g., an audio, video, and/or gaming content source)).

In some embodiments, data from the PDDs (some of which might be monitored by the PDDs) may be stored in a database, and the data may be accessed by the server (which might include an analysis server(s)). The server may then take into account various factors to calculate, determine, or generate an advertisement(s) that is(are) customized to a user or a group of users. Example factors might include, without limitation, age factor of a media content, trending quotient or characteristic of the media content, geographical factor of the media content, topic of the media content, and so on.

In some cases, the factors might include other media content-based information, audience-based information, and/or the like. In some embodiments, other media content-based information might include, without limitation, at least one of type of media content of the media content that is presented to the user and monitored by the PDD (herein, referred to as “first media content”), genre of media content of the first media content, duration of media content of the first media content, time of day that the first media content is received and/or presented (which may be determined using network time protocol (“NTP”) or the like), performers (e.g., actors, actresses, singers or vocalists, band members, musicians, orchestras, voice artists, etc.) associated with the first media content, producers (e.g., directors, film/video/music/game producers, game developers, artists, etc.) associated with the first media content, year of release of the first media content, reviews (e.g., by industry-based critics or by average viewers/listeners/gamers/etc.) of the first media content, and/or other media content related to the first media content. In some instances, audience-based information might include, but is not limited to, at least one of number of audience members present during presentation of particular portions of the first media content, identity of each audience member, gender of each audience member, age of each audience member, demographic group to which each audience member belongs (i.e., other than age or gender, which might include, without limitation, at least one of ethnicity, culture, language-proficiency, location, socio-economic grouping, income, political leanings, and/or the like), viewing patterns of each audience member, specific reactions of each audience member during presentation of particular portions of the first media content, overall reactions of each audience member throughout presentation of the first media content, consistency of audience member reactions of each audience member compared with personal preferences of the audience member, consistency of audience member reactions of each audience member compared with past reactions of the audience member, and/or the like.

Although a number of factors are listed above, not all these listed factors need be taken into account. In some instances, different weightings might be given to one or more of these factors, as appropriate or as desired. In some cases, the different weightings might be determined through iterative processes based on past decisions by the user, viewing/listening/playing patterns of the user, and/or the like, in order to better tailor or otherwise more effectively determine advertisements relevant to the user.

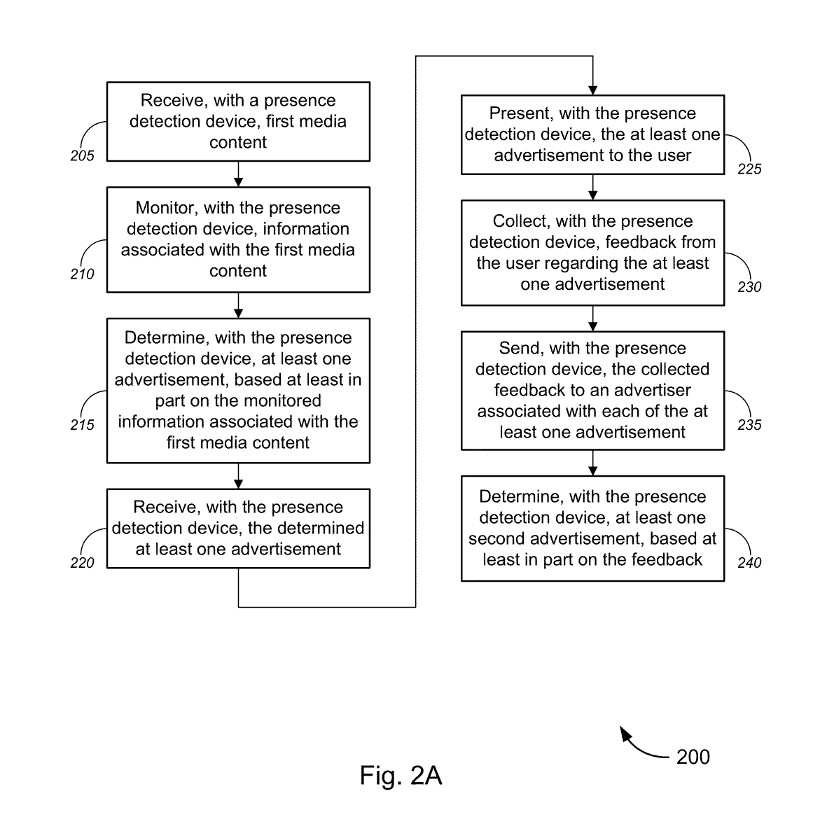

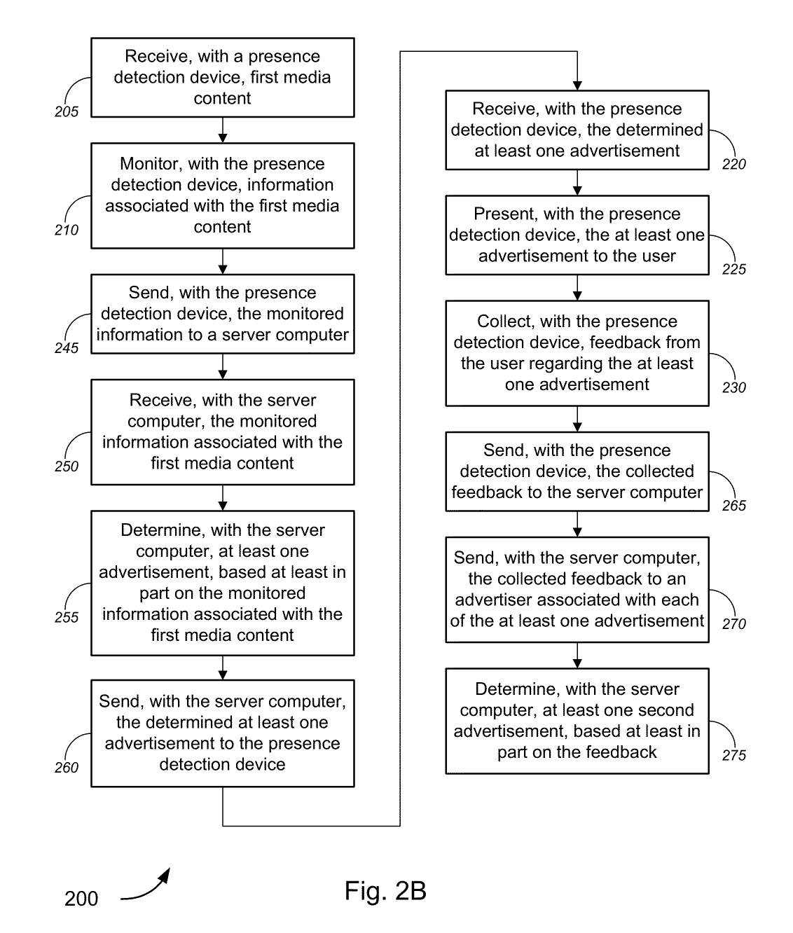

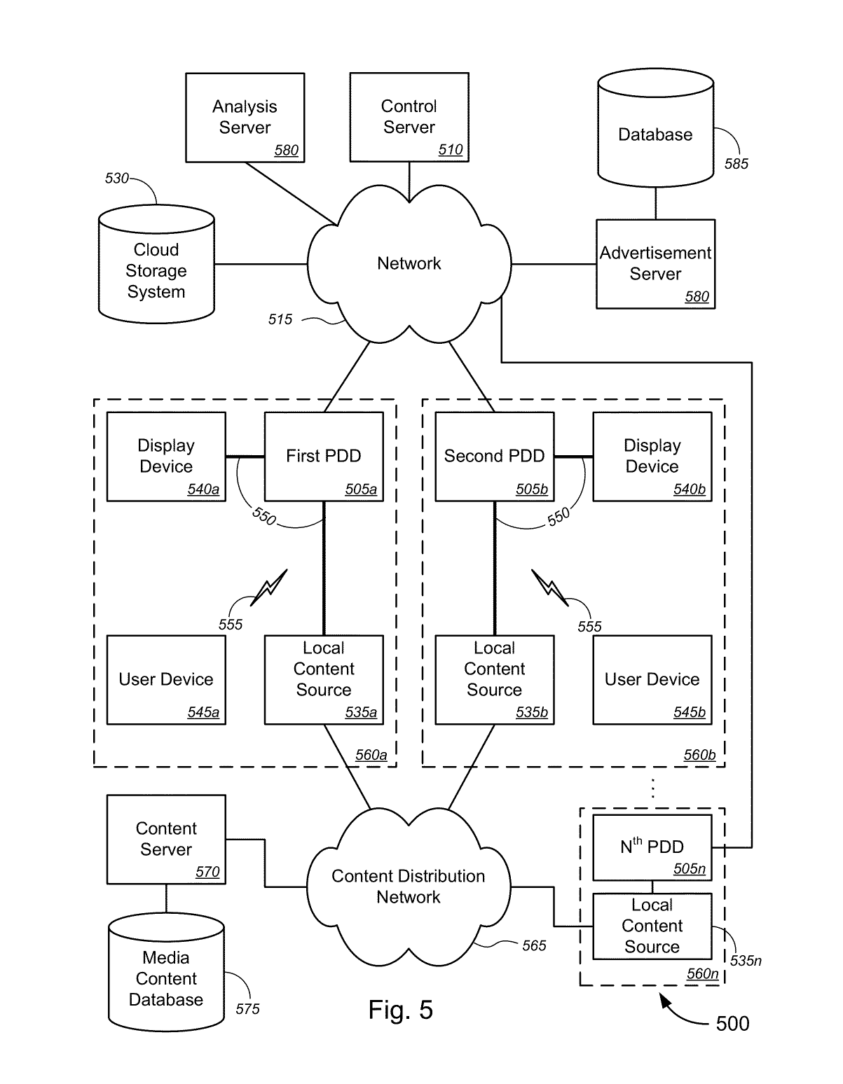

After determining the advertisements, the advertisements may be sent to the PDD and may be presented to the user. In some cases, the advertisements may be displayed on the TV by overlaying video on top of the video coming from the STB. Various configurations for such overlay is described in detail with respect to FIGS. 2 and 5 below. In some instances, audio advertisements may similarly be sent to the TV or other audio output device (e.g., speakers, etc.), either in conjunction with or separate from the video advertisements. According to some cases, any audio advertisements may be overlaid on top of currently presented audio, overlaid on top of a muted currently presented audio, played instead of currently or normally presented audio, or the like.

In some cases, the PDD might present advertisements together with an audio prompt (in some instances, accompanied by a video prompt). The PDD might play these audio prompts (possibly using text-to-speech technology) via the TV, via an audio output device (e.g., speaker) on the PDD, and/or via some other connected audio output device. Using a microphone (which, in some cases, might be built into the PDD), the device can obtain feedback from the user, and such feedback can be sent to advertisers and/or stored by the system to enhance future determinations of advertisements for the user.

In some embodiments, the PDD may also interface with (or have integrated therein) a camera or other video/image capture device. The camera may be used to determine the number of people in the room, as well as the mood, gender, age, identity, etc., of each person. As discussed above, these characteristics may be used to determine (or in some cases, optimize determinations of) advertisements.

Merely by way of example, in some embodiments, as part of the user's profile or options in the user's profile, the user may be given the option to opt in or opt out of having his or her data monitored or otherwise used in the determination of advertisements for him/her and/or for others.

According to some embodiments, inline cameras (which in some cases can be a stand-alone device or a device embodied in another suitable device including, but not limited to, a PDD as discussed above, or a video calling device, and/or the like) can also contain cameras, microphones, and other sensors. These sensors, in conjunction with the internal processing capability of the device allow the device to know when someone is in room. Additionally, the devices can also recognize who is in the room. They can also tell if users are actually looking at the television. These capabilities allow for very customized advertising based on whether someone is in the room, the identity of the person(s) in the room, and if they are looking at the TV. For example, the ability to determine whether someone is looking at the TV is a very useful tool for advertising, as it allows for feedback and the ability to determine whether advertising is effective. Inline cameras can use this to customize advertising for a particular user and to gauge the effectiveness of ads for advertisers.

In some embodiments, inline cameras can also determine the content of the audio/visual (“A/V”) stream that is coming from a set-top box (“STB”) or other local content source. This can be done in a number of ways. One way in which content can be identified is to search for watermarks that are often embedded in the audio/video stream itself. Watermark identification can be accomplished by using the processor in the inline camera to search for a known audio and/or video pattern that is embedded in the stream. The watermarks are typically designed to not be perceptible to users that may be watching the content. Once the watermark is identified, the channel or content that the STB is set to can be identified. According to some embodiment, rather than (or in addition to) the audio and/or video watermarks embedded in the stream, the watermarks might include digital watermarks that might be embedded in the stream; such digital watermarks might include headers, footers, or data packets embedded between headers and footers that provide identification information regarding the A/V stream and/or content source.

Another approach to determining the content of the STB is classify the source of the content in the A/V stream itself by searching either for keywords, phrases that can be used for identification purposes or by “fingerprinting” the A/V stream and comparing the fingerprint against a database of fingerprints that are either local to the inline camera or on a network (such as on a control server, as described below). By determining the content coming from the STB, inline cameras can overlay advertising that is relevant to the A/V source that is coming from the STB. For example, if a user is watching a football game, then advertising relevant to the situation (i.e., the name of a local pizza shop that delivers to the user's home, deals for football memorabilia or team merchandise for the user's preferred team(s), etc.) can be displayed.

In other embodiments, inline cameras with cameras (or other sensors) also have an advantage over typical broadcast type advertising. The sensors on such devices know when users are in the room. The timing of when advertising can be set specifically to when someone is known (or detected and identified) to be in the room. In this manner, the likelihood of ads being viewed is much higher than broadcast advertisers are typically accustomed to. Further, inline cameras with cameras can determine not only that someone is in the room, but they can also determine who is in the room, using their sensors and facial recognition capability, or the like. This information allows for much more targeted type of advertising, because a particular user's profile and personal preferences can be used for advertising. For example, an adult male watching a football game can be shown a particular ad, while a female child watching the same show can be shown something entirely different. Additionally, when groups of people are in the room, ads that best fit the demographic of the people in the room can be shown. For example, when a device detects 3 adult females in the room and 2 male children, the system might determine to target the adult females.

In another aspect, some inline cameras can also determine whether or not a user is actually watching the television using its cameras and the facial recognition/eye tracking technology. This capability can be used to determine whether or not a user is watching or has watched a particular advertisement that is being displayed. This type of feedback is invaluable to advertisers, as it provides information that can be gathered and analyzed. The statistics can be given or sold back to advertisers who can then gauge the effectiveness of their ads. Somewhat similarly, inline cameras can also use the fact that they know when someone is watching to help determine when to display ads. The timing of ads can be done based on whether someone is actually watching the television or based on who is watching the television. For example, ads can be displayed when anyone is watching a particular show, or only when adults over the age of 40 are watching a particular show, and so on.

Physical presence can also be used to create enhanced placements for TV ads. Ads placements can be sold to advertisers based on (i) whether users are confirmed to be in the room or not, (ii) based on the number of users in the room, (iii) demographic profile of user in the room, (iv) number of users in the room, (v) whether a particular individual is in front of their TV, (vi) whether a user has watched a particular ad or not, (vii) what content a user is watching, (viii) time of day an ad is played, etc.

### Exemplary Embodiments

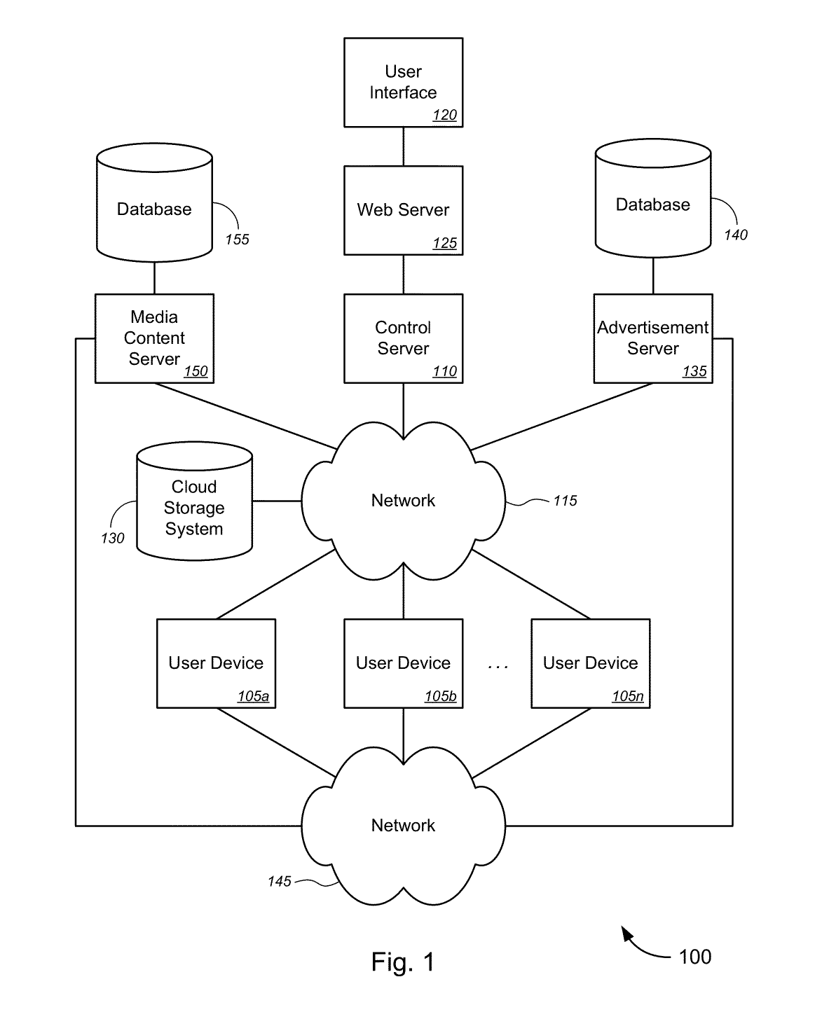

FIGS. 1-8 illustrate exemplary embodiments that can provide some or all of the features described above. The methods, systems, and apparatuses illustrated by FIGS. 1-8 may refer to examples of different embodiments that include various components and steps, which can be considered alternatives or which can be used in conjunction with one another in the various embodiments. The description of the illustrated methods, systems, and apparatuses shown in FIGS. 1-8 is provided for purposes of illustration and should not be considered to limit the scope of the different embodiments.

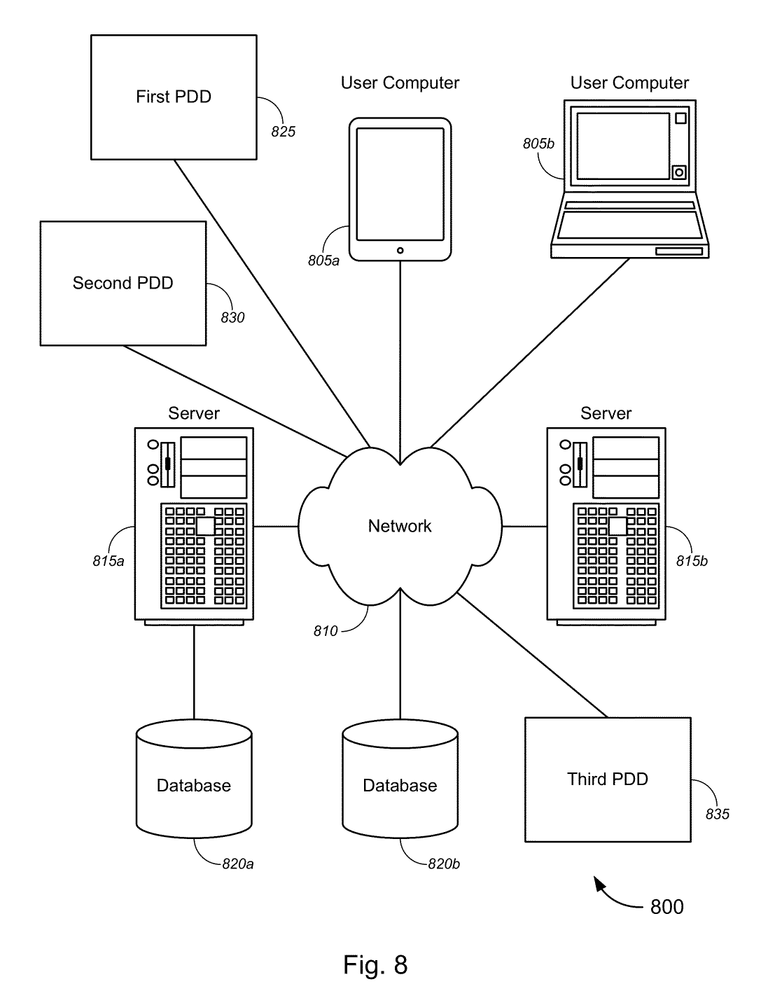

FIG. 1 illustrates a functional diagram of a system 100 for controlling one or more presence detection devices (“PDDs”), one or more image capture devices (“ICDs”), and/or one or more video calling devices (labeled user devices 105 in FIG. 1 for ease of illustration, but described herein as PDDs, ICDs, or video calling devices, each of which can be considered a type of user device). The skilled reader should note that the arrangement of the components illustrated in FIG. 1 is functional in nature, and that various embodiments can employ a variety of different structural architectures. Merely by way of example, one exemplary, generalized architecture for the system 100 is described below with respect to FIG. 8, but any number of suitable hardware arrangements can be employed in accordance with different embodiments.

An ICD 105, a video calling device 105, or a PDD 105 can be any device that is capable of communicating with a control server 110 over a network 115 and can provide any of a variety of types of advertisement determination functionality, content recommendation functionality, video communication functionality, presence detection functionality, and/or the like. Merely by way of example, in some aspects, an ICD 105, a video calling device 105, or a PDD 105 can be capable of providing pass through video/audio to a display device (and/or audio playback device) from another source (such as a local content source), and/or overlaying such video/audio with additional content generated or received by the ICD 105, the video calling device 105, or the PDD 105. In other aspects, an ICD 105, a video calling device 105, or a PDD 105 can comprise one or more sensors (e.g., digital still cameras, video cameras, webcams, security cameras, microphones, infrared sensors, touch sensors, and/or the like), and/or can be capable, using data acquired by such sensors, of sensing the presence of a user, identifying a user, and/or receiving user input from a user; further, an ICD 105, a video calling device 105, or a PDD 105 can be capable of performing some or all of the other functions described herein and/or in any of the Related Applications. Hence, in various embodiments, an ICD 105, a video calling device 105, or a PDD 105 can be embodied by a video calling device, such as any of the video communication devices (“VCDs”) described in the '182 patent, a video game console, a streaming media player, to name a few non-limiting examples.

In one aspect of certain embodiments, as described more fully with respect to FIG. 5 below (or as described in the Related Applications), an ICD 105, a video calling device 105, or a PDD 105 can be placed functionally inline between a local content source and a display device. A local content source can be any device that provides an audio or video stream to a display device and thus can include, without limitation, a cable or satellite set-top box (“STB”), an Internet Protocol television (“IPTV”) STB, devices that generate video and/or audio, and/or acquire video and/or audio from other sources, such as the Internet, and provide that video/audio to a display device; hence, a local content source can include devices such as a video game console, a Roku® streaming media player, an AppleTV®, and/or the like. When situated functionally inline between a local content source and a display device, the ICD, the video calling device, or the PDD can receive an audiovisual stream output from the local content source, modify that audiovisual stream in accordance with the methods described herein, in the '182 patent, and/or in the '279 application, and provide the (perhaps modified) audiovisual stream as input to the display device. It should be noted, however, that, in some cases, the functionality of a local content source can be incorporated within an ICD, a video calling device, or a PDD, and/or the functionality of an ICD, a video calling device, or a PDD can be incorporated within a local content source; further, it should be appreciated that an ICD, a video calling device, or a PDD (which might or might not include local content source functionality) can be disposed inline with one or more other local content sources or one or more other video calling devices/PDDs. Hence, for example, an ICD, a video calling device, or a PDD with some local content source functionality (such as a video game console) might be disposed inline between one or more other local content sources or one or more other ICDs/video calling devices/PDDs (such as a cable STB, satellite STB, IPTV STB, and/or a streaming media player) and a display device.

In an aspect of some embodiments, the system can include a software client that can be installed on a computing device (e.g., a laptop computer, wireless phone, tablet computer, etc.) that has a built-in camera and/or has a camera attached (e.g., a USB webcam). This client can act as an interface to allow remote control of the built-in and/or attached camera on the computing device. In some embodiments, the computing device might have a built-in microphone(s) and/or has a microphone(s) attached (e.g., a table-top microphone, a wall-mounted microphone, and/or a microphone removably mountable on a television, on the ICD, on the video calling device, on the PDD, and/or on some other suitable user device, or the like). The software client can alternatively and/or additionally act as an interface to allow remote control of the built-in and/or attached microphone on the computing device. In some cases, the camera and/or microphone can be automatically or autonomously controlled to obtain optimal video and/or audio input. Remote control of the video calling device and/or PDD is described in detail in the '263 application (already incorporated herein), and may be similarly applicable to remote control of the ICD.

The system 100 can further include a control server 110, which can have any suitable hardware configuration, and an example of one such configuration is described below in relation to FIG. 8. In one aspect, the control server 110 is a computer that is capable of receiving user input via a user interface 120 and/or performing operations for utilizing the ICD(s) 105, the video calling device(s) 105, and/or the PDD(s) 105 to perform one or more of receiving (and relaying) media content (either directly from media content server 150 or database 155 via network 115 or network 145, indirectly via a local content source (e.g., an STB or the like), directly from cloud storage system 130, and/or the like), monitoring the media content presented to the user(s), monitoring the user(s), sending the monitored data to the control server 110, determining at least one advertisement for the user(s) with the control server 110, receiving the at least one advertisement for the user(s) from the control server 110, presenting the at least one advertisement to the user(s), and/or the like. In some cases, the control server 110 might handle all of the processes for identifying and authenticating users and for providing access to the user(s)'s profiles, content, information, recommendations, advertisements, preferences (including, without limitation, preferences for advertisements and other user preferences, etc.), as well as handling the processes involved with determining or presenting the advertisements. Alternatively, or additionally, the processes involved with determining or presenting the advertisements (which might take into account the factors listed above or similar factors) might be handled by a separate server computer (denoted Advertisement Server 135 in FIG. 1), which might store determined or collected information in database 140. In other instances, control server 110 and advertisement server 135 might split the processing tasks in any suitable manner, as appropriate. In some cases, advertisement server 135 might also generate advertisements based on the monitored information and/or based on the factors discussed above, and such generated advertisements may be stored in database 140.

Merely by way of example, in some embodiments, the control server 110 can detect user presence, identify/authenticate users, and/or enable the user to remotely access the user's master account, user preferences, media content, recommendations of media content, advertisements, preferences for advertisements, and/or the like. In other cases, the control server 110 can receive and/or store user input and/or user preferences that can specify whether and how presence information should be used, whether and how the user's ICD(s), video calling device(s), and/or PDD(s) may be used in a distributed infrastructure, whether and how the user's content and profiles should be handled under certain situations, and/or the like.

For example, preferences might specify which account information, content, profile information, personal communications (e.g., videomail, voicemail, e-mail, etc.), media content, media content recommendations, determined advertisements, preferences for advertisements, and/or the like should be delivered to a user when present at a device not owned by the user, whether presence information should be collected for that user at all (and/or where such information should be collected); for example, a user might specify that his presence should only be monitored in selected locations or from selected devices, and the control server 110 might remove that user's profile from the search universe when provided with presence information from a device not at the selected location or from a device other than one of the selected devices. More generally, the user preference can include any types of parameters related to collecting presence information, using presence information, handling media content recommendations, handling advertisements, and/or serving content/information (including, without limitation, user account information, user content, user profile information, user's personal communications (e.g., videomail, videomail, voicemail, e-mail, etc.), media content, advertisements, and/or the). These preferences might be stored in a user profile at the control server 110, which might also include other user-specific information, such as the user's normal location(s), identifying information (such as MAC address, etc.) of other user devices owned by or associated with the user, lists of or links to content owned by the user, lists of or links to media content recommendations, lists of or links to preferences for handling media content recommendations, lists of or links to advertisements, lists or links to products or services associated with advertisements, lists of or links to preferences for handling advertisements, and/or the like.

In some embodiments, user preferences might specify how the user would like his or her user devices to participate (or not) in a distributed infrastructure arrangement. For instance, the user preferences might include, without limitation, preferences indicating whether or not to allow a user device owned by the user to be used for distributed infrastructure; preferences indicating what type of software applications, customer data, media content (of other user device users and/or subscribers of a cloud service), and/or advertisements are permitted to be hosted on a user device owned by the user; and/or preferences indicating amount of resources of a user device to dedicate to the distributed infrastructure; etc. In some embodiments, in addition to indicating how a user's user device may be used in distributed infrastructure implementation, user preferences might allow a user to indicate how the user's own applications, data, and/or media content may be hosted on other users' user devices. For example, the user might be given the option to encrypt any and/or all personal data, any and/or all personal applications, any and/or all files or lists indicating which media content are associated with the user, any and/or all files or lists pertaining to media content recommendations and/or preferences thereof, and/or any and/or all files or lists pertaining to advertisements and/or preferences thereof. Common media content (which might include popular media content, or any other media content) may remain unencrypted for common usage by any number of users on any number of user devices, subject only to any subscription, rental, or purchase restrictions on the particular media content as associated with any user and/or any user device. On the other hand, the user's personal communications (including, e.g., videomail messages and/or the like), preferences for media content recommendations, past decisions/patterns/history with regard to media content viewed/listened to/played by the user, preferences for advertisements, and/or the like may be encrypted.

The control server 110 can provide a user interface (which can be used by users of the ICDs 105, the video calling devices 105, and/or the PDDs 105, and/or the like). The control server 110 might also provide machine-to-machine interfaces, such as application programming interfaces (“APIs”), data exchange protocols, and the like, which can allow for automated communications with the video calling devices 105 and/or the PDDs 105, etc. In one aspect, the control server 110 might be in communication with a web server 125 and/or might incorporate the web server 125, which can provide the user interface, e.g., over the network to a user computer (not shown in FIG. 1) and/or a machine-to-machine interface. In another aspect, the control server 110 might provide such interfaces directly without need for a web server 125. Under either configuration, the control server 110 provides the user interface 120, as that phrase is used in this document. In some cases, some or all of the functionality of the control server 110 might be implemented by the ICD 105, the video calling device 105, and/or the PDD 105 itself.

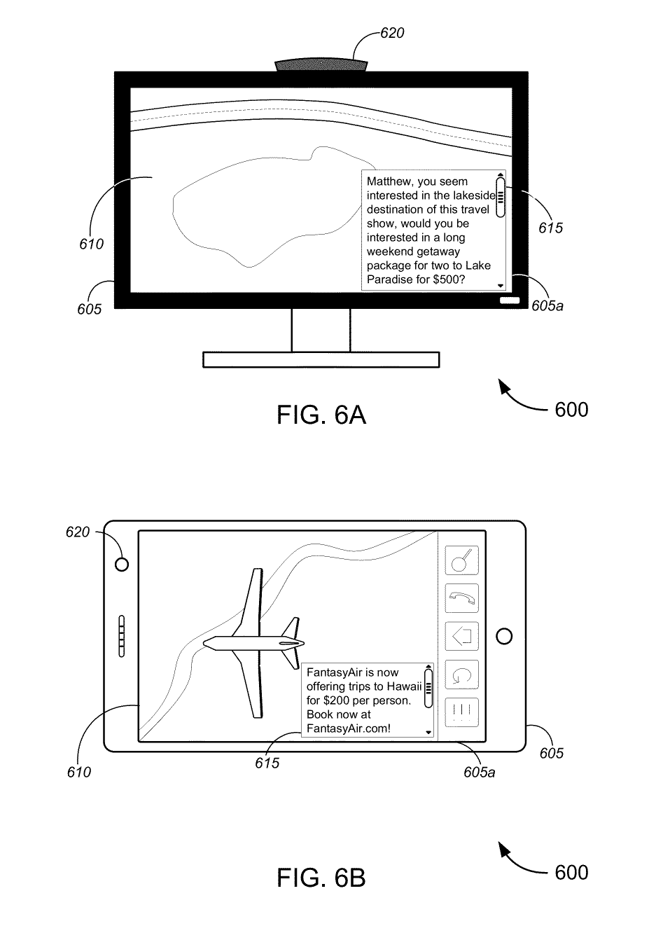

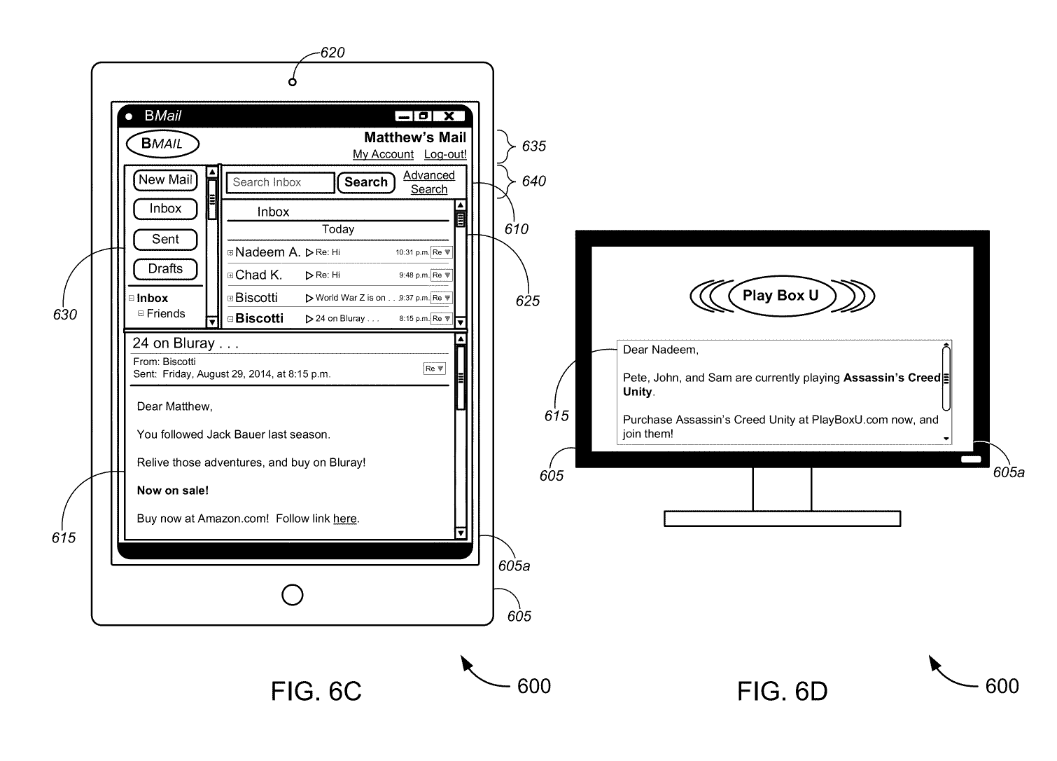

In an aspect, the user interface 120 allows users to interact with the control server 110, and by extension, the ICDs, the video calling devices 105, and/or the PDDs 105. A variety of user interfaces may be provided in accordance with various embodiments, including, without limitation, graphical user interfaces that display, for a user, display fields on display screens for providing information to the user and/or receiving user input from a user. Example graphical user interfaces are shown in FIG. 6 as described below.

Merely by way of example, in some embodiments, the control server 110 may be configured to communicate with a user computer (not shown in FIG. 1) via a dedicated application running on the user computer; in this situation, the user interface 120 might be displayed by the user computer based on data and/or instructions provided by the control server 110. In this situation, providing the user interface might comprise providing instructions and/or data to cause the user computer to display the user interface. In other embodiments, the user interface may be provided from a web site, e.g., by providing a set of one or more web pages, which might be displayed in a web browser running on the user computer and/or might be served by the web server 125. As noted above, in various embodiments, the control system 110 might comprise the web server and/or be in communication with the web server 125, such that the control server 110 provides data to the web server 125 to be incorporated in web pages served by the web server 125 for reception and/or display by a browser at the user computer.

The network 115, specific examples of which are described below with regard to FIG. 8, can be any network, wired or wireless, that is capable of providing communication between the control server 110 and the ICDs 105, the video calling devices 105, and/or the PDDs 105, and/or of providing communication between the control server 110 (and/or the web server 125) and a user computer. In a specific embodiment, the network 115 can comprise the Internet, and/or any Internet service provider (“ISP”) access networks that provide Internet access to the control server 110, the user computer, and/or the ICDs 105, the video calling devices 105, and/or the PDDs 105.

In some embodiments, the system 100 can include a cloud storage system 130, which can be used, as described in further detail below, to store advertisements, presence information, images, video, videomail messages, media content, media content recommendations, determined advertisements, preferences for advertisements, preference information of users, past viewing/listening/playing patterns or decisions of users, and/or the like that are monitored/captured, downloaded, streamed, and/or uploaded by the ICDs 105, the video calling devices 105 and/or the PDDs 105, and/or the like. In some cases, the cloud storage system 130 might be a proprietary system operated by an operator of the control server 110. In other cases, the cloud storage system 130 might be operated by a third party provider, such as one of the many providers of commercially available cloud services. In yet a further embodiment, the cloud storage system 130 might be implemented by using resources (e.g., compute, memory, storage network, etc.) shared by a plurality of video calling devices, and/or by a plurality of PDDs, that are distributed among various users of the system. Merely by way of example, as described in further detail below and in the '360 application (already incorporated by reference herein), a plurality of user video calling devices and/or PDDs might each have some dedicated resources (such as a storage partition), which are dedicated for use by the system, and/or some ad hoc resources (such as network bandwidth, memory, compute resources, etc.) that are available to the system when not in use by a user. Such resources can be used as cloud storage and/or can be used to provide a distributed, cloud-like platform on which a control server can run as a virtual machine, cloud container, and/or the like.

According to some embodiments, ICD 105, video calling device 105, and/or PDD 105 might comprise a first video input interface to receive first video input from a first local content source (which in some embodiments can include a STB and/or the like) and a first audio input interface to receive first audio input from the first local content source. Video calling device 105 might further comprise a first video output interface to provide first video output to a first video display device and a first audio output interface to provide first audio output to a first audio receiver. In some cases, the first video display device and the first audio receiver might be embodied in the same device (e.g., a TV with built-in speaker system, or the like). With the input and output interfaces, video calling device 105 might provide pass-through capability for video and/or audio between the first local content source and the first display device. In some instances, high-definition multimedia interface (“HDMI”) cables or other suitable HD signal cables may be used to provide the interconnections for the pass-through. Video calling device 105 may, in some cases, comprise a first image capture device to capture at least one of first image data or first video data and a first audio capture device to capture first audio data. Video calling device 105 may also comprise a first network interface, at least one first processor, and a first storage medium in communication with the at least one first processor.

In some aspects, a plurality of ICDs, PDDs, or video calling devices 105 might be communicatively coupled together in a network (e.g., network 115), each ICD, PDD, or video calling device being located in one of a plurality of customer premises. For implementing distributed infrastructure for cloud computing, cloud-based application hosting, and/or cloud-based data storage, a computer might establish one or more ICDs, PDDs, or video calling devices 105 of the plurality of ICDs, PDDs, or video calling devices 105 as distributed infrastructure elements and might provide at least one of one or more software applications, customer data, and/or media content to the one or more video calling devices 105 for hosting on the one or more video calling devices 105. These and other functionalities of the video calling devices related to distributed infrastructure are described in greater detail in the '360 application (already incorporated by reference herein).

Merely by way of example, in some aspects, a user can remotely access one or more ICDs, PDDs, or video calling devices 105 and/or remotely access at least one of the user's master account, the user's user preference, the user's profiles, any videomail messages addressed to the user, the user's media content, media content recommendations for the user, determined advertisements, preferences for advertisements, and/or the like over a network. For example, in a web-based implementation, a user could log into the user's master account by accessing a website hosted on a web server (e.g., web server 125, which might be hosted on a cloud server, hosted on distributed PDDs, hosted on distributed video calling devices, and/or the like) and entering commands into a user interface (e.g., user interface 120) associated with remotely accessing the user's video calling device(s) 105 and/or associated with remotely accessing at least one of the user's master account, the user's user preference, the user's profiles, any videomail messages addressed to the user, the user's media content, media content recommendations for the user, determined advertisements of the user, the user's preferences for advertisements, and/or the like. In some instances, the user might access and interact with the user interface over the network (e.g., network 115) by using a user computer selected from a group consisting of a laptop computer, a desktop computer, a tablet computer, a smart phone, a mobile phone, a portable computing device, and/or the like. In an application-based (or “app-based”) implementation, the user might interact with a software application (or “app”) running on the user's user device, which might include, without limitation, a laptop computer, a desktop computer, a tablet computer, a smart phone, a mobile phone, a portable computing device, and/or the like. The app might include another user interface (similar to the web-based user interface) that might allow for access of the user's video calling device(s) (or any paired video calling device(s)) over the network (e.g., network 115) and/or that might allow for access to at least one of the user's master account, the user's user preference, the user's profiles, any videomail messages addressed to the user, the user's media content, media content recommendations for the user, determined advertisements for the user, the user's preferences for advertisements, and/or the like.

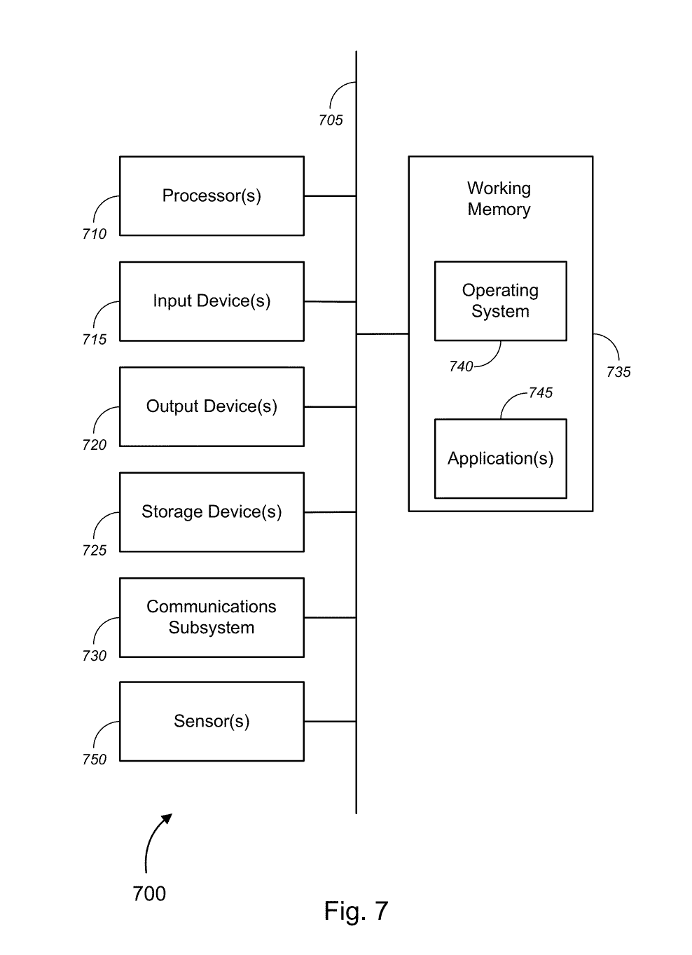

According to some embodiments, control server 110, which can have any suitable hardware configuration (an example of which is described below with respect to FIG. 7), might be a computer that is capable of receiving user input via a user interface 120 and/or performing operations for controlling the user device(s) 105 (which in some cases might comprise inline camera(s), which in turn might comprise cameras or other sensors, and the like). Merely by way of example, however, the control server 110 can provide advertisements to be inserted in a video stream, can interact with advertisers to provide presence information and/or receive advertisements (and/or advertising instructions) from the advertisers, and/or the like. In other cases, the control server 110 can receive and/or store user input and/or user preferences that can specify whether and how presence information should be used. For example, preferences might specify that presence information for identified adults can be used for advertising purposes, but that presence information about children should not be provided to advertisers. Alternatively and/or additionally, the preferences might specify which types of advertisers can receive presence information, which types of content can be supplemented with advertisements (e.g., television content can be supplemented, but video game content cannot, etc.), hours during which presence information can be collected and/or advertisements can be served, and/or any other type of parameter related to collecting presence information, using presence information, and/or supplementing content with advertisements.

In an aspect of some embodiments, the user might log onto his or her master account at the control server in order to access and/or control inline cameras assigned to that account. The user device 105 and/or the control server 110 might authenticate the user with a set of credentials associated with the master account (e.g., with any of several know authentication schemes, such as a userid/password challenge, a certificate exchange process, and/or the like). Once the user has been authenticated, the user interface can present the user with a variety of different information, including without limitation information about status of inline cameras (or user devices 105 comprising the inline cameras) assigned to the master account to which the user has logged on, options for controlling such inline cameras, and or the like.

Thus, in some aspects, the user device 105 and/or the control server 110 might receive user preferences (e.g., via a network, such as the Internet, to name one example), and in particular user preferences relating to the collection and/or use of presence information, including without limitation preferences such as those described above. The user device 105 and/or the control server 110 can further control and/or configure the inline camera, based at least in part on the user preferences. Merely by way of example, the user might have specified that the inline camera should not be used to collect presence information at all, in which case that feature might be turned off at the inline camera. Alternatively and/or additionally, the user might have specified some limitations on the collection of presence information (such as about whom such information may be collected, times at which information can be collected, and/or purposes for which information may be collected, to name a few examples). Of course, in some embodiments, these preferences can be set directly at the inline camera, e.g., through a menu system displayed on a video device. It should also be recognized that some preferences (such as with whom presence information can be shared) might not affect the inline camera and might be saved and/or operated on at the control server instead.

The amount of control imposed by the control server 110 can vary according to embodiment and implementation. Merely by way of example, as noted above, in some embodiments, there might be no control server, and the inline camera might incorporate all the functionality described herein with regard to the control server 110. In other embodiments, the control server 110 might provide fairly fine-grained control over the inline camera, such as instructing the camera to capture images for purposes of determining presence, and/or the control server 110 may receive the images directly and perform the present determination procedures at the controls server. The division of responsibility between the control server 110 and the inline camera or user device 105 can fall anywhere along this spectrum. In some cases, for instance, the control server 110 might provide the user preferences to the inline camera, which then is responsible for collecting presence information in accordance with those preferences and transmitting the presence information to the control server 110, which takes the appropriate action in response to the presence information, such as, selecting an advertisement based on the presence information. Alternatively and/or additionally, the inline camera itself might be responsible for taking such actions.

In some cases, the user device or inline camera might collect presence information. A variety of operations might be involved in the collection of presence information. For example, in some cases, the inline camera captures one or more images of at least a portion of a room where it is located. Such images can be digital still images, a digital video stream, and/or the like. Collecting presence information can further comprise analyzing one or more of the images. Merely by way of example, the images might be analyzed with facial recognition software, which can be used to determine the number of people in the room with the inline camera and/or to identify any of such people (e.g., by determining a name, an age range, a gender, and/or or other identifying or demographic information about a user, based on the output of the facial recognition software). Alternatively and/or additionally, analyzing the images can comprise determining that a person is watching a display device, for example using eye-tracking software to identify a focus area of the person's eyes and correlating that focus area with the location of a television. In some cases, if the number of people and the identities (or at least demographic characteristics) of each of the people in the room can be determined, analyzing the images can further include determining a collective demographic of the people in the room (based, for example on the demographic characteristics of a majority of people in the room).

In some embodiments, the user device (or inline camera) 105 and/or the control server 110 can serve the advertisement to a user. In some cases, this will comprise inserting the advertisement (which might be transmitted from the control server to the inline camera, or directly from the advertiser to the inline camera) into a video stream received by the inline camera from a STB (or game console, etc.) and output to a television screen. Other techniques can be used to serve an advertisement, however. For example, the advertiser (or a video provider) might insert the advertisement directly into the video stream provided to the STB, based on presence information collected by the inline device.

In some embodiments, the user device (or inline camera) 105 can collect and/or provide feedback to the advertiser (or another third party). Merely by way of example, the inline camera might capture audio and/or video while the advertisement is being displayed, which can indicate user reaction to the advertisement. This audio/video can be used to infer user acceptance (or rejection) of the advertisement, and these inferences (and/or the raw audio/video itself) can be provided to the advertiser (or a third party, such as a marketing research firm) to improve the effectiveness of future advertisements.

In some aspects, server 110 might perform the methods described in detail with respect to FIGS. 2-6 below, while data associated with user account(s) or preferences, data associated with monitored user(s), and/or data associated with monitored media content might be collected by the one or more user devices 105, by server 110, by server 135, or by any combination of these computing devices. The database 130 (and/or database 140) might store some or all of these collected data.

Aside from the content monitoring, advertisement determination, and/or advertisement presentation functionalities described above, the user devices 105, control server 110, and other components of system 100 may possess other functionalities and operations, which are described in greater detail in the Related Applications, and briefly mentioned below.

In some embodiments, the control server 110 can detect user presence, identify/authenticate users, and/or enable the user to remotely access the user's master account, user preferences, videomail messages, media content, media content recommendations, and/or the like. In other cases, the control server 110 can receive and/or store user input and/or user preferences that can specify whether and how presence information should be used, whether and how the user's video calling device(s) and/or user device(s) may be used in the distributed infrastructure, whether and how the user's content and profiles should be handled under certain situations, how to handle media content recommendations, and/or the like.

For example, preferences might specify which account information, content, profile information, personal communications (e.g., videomail, etc.), media content, media content recommendations, and/or the like should be delivered to a user when present at a device not owned by the user, whether presence information should be collected for that user at all (and/or where such information should be collected); for example, a user might specify that his presence should only be monitored in selected locations or from selected devices, and the control server 110 might remove that user's profile from the search universe when provided with presence information from a device not at the selected location or from a device other than one of the selected devices. More generally, the user preference can include any types of parameters related to collecting presence information, using presence information, and/or serving content/information (including, without limitation, user account information, user content, user profile information, user's personal communications (e.g., videomail, etc.), media content, media content recommendations, and/or the like). These preferences might be stored in a user profile at the control server 110, which might also include other user-specific information, such as the user's normal location(s), identifying information (such as MAC address, etc.) of other user devices owned by or associated with the user, lists of or links to content owned by the user, lists of or links to videomail messages addressed to the user, and/or the like. Videomail capture, processing, and distribution is described in greater detail in the '499 and '621 applications (already incorporated herein). Media content delivery and media content recommendation generation are described in detail in the '435 application (also already incorporated herein).

In some aspects, a plurality of video calling devices 105 might be communicatively coupled together in a network (e.g., network 115), each video calling device being located in one of a plurality of customer premises. For implementing distributed infrastructure for cloud computing, cloud-based application hosting, and/or cloud-based data storage, a computer might establish one or more video calling devices 105 of the plurality of video calling devices 105 as distributed infrastructure elements and might provide at least one of one or more software applications, customer data, and/or media content to the one or more video calling devices 105 for hosting on the one or more video calling devices 105. These and other functionalities of the video calling devices related to distributed infrastructure are described in greater detail in the '360 application (already incorporated by reference herein).

In some embodiments, user preferences might specify how the user would like his or her user devices to participate (or not) in a distributed infrastructure arrangement. For instance, the user preferences might include, without limitation, preferences indicating whether or not to allow a user device owned by the user to be used for distributed infrastructure; preferences indicating what type of software applications, customer data, and/or media content (of other user device users and/or subscribers of a cloud service) are permitted to be hosted on a user device owned by the user; and/or preferences indicating amount of resources of a user device to dedicate to the distributed infrastructure; etc. In some embodiments, in addition to indicating how a user's user device may be used in distributed infrastructure implementation, user preferences might allow a user to indicate how the user's own applications, data, and/or media content may be hosted on other users' user devices. For example, the user might be given the option to encrypt any and/or all personal data, any and/or all personal applications, any and/or all files or lists indicating which media content are associated with the user, and/or any and/or all files or lists pertaining to videomail messages that are addressed to the user (including the videomail messages themselves). Common media content (which might include popular media content, or any other media content) may remain unencrypted for common usage by any number of users on any number of user devices, subject only to any subscription, rental, or purchase restrictions on the particular media content as associated with any user and/or any user device. On the other hand, the user's personal communications (including, e.g., videomail messages and/or the like) may be encrypted.

In some examples, the user might indicate that her user device may be used for distributed processing, but not distributed cloud-based data storage, or vice versa. Alternatively, the user might indicate that her user device may be used for both distributed processing and distributed cloud-based data storage. In some embodiments, the user might allow the hosting, on his or her user device, of at least portions of software applications that are published by known and reputable software companies or published by companies on behalf of governmental agencies, or the like, while blocking hosting of software applications associated with marketing, spam, data mining, and/or potential copyright violations, etc. These and other preferences related to distributed infrastructure functionality, as well as distributed infrastructure implementation of user devices, are described in greater detail in the '360 application (which is already incorporated herein by reference).

In some embodiments, the system 100 can include a cloud storage system 130, which can be used, as described in further detail below, to store user addresses in at least one protocol (e.g. HTTP, SIP, XMPP, PSTN protocol, etc.); user preferences regarding call conferencing, conference addressing, etc.; and/or the like. In some instances, the cloud storage system 130 might further store advertisements, presence information, images, video, and/or videomail messages that are captured and uploaded by the video calling devices 105 and/or the user devices 105, and/or the like.

In some embodiments, access of one or more video calling device(s) and/or access to at least one of the user's master account, the user's user preference, the user's profiles, any videomail messages addressed to the user, and/or the like may be permitted in response to identification and/or authentication of the user by a presence detection device (“PDD”), as described in detail herein and in the '279 application. In some embodiments, a user device 105 might comprise a second video input interface to receive second video input from a second local content source (which, in some embodiments, might include a STB and/or the like) and a second audio input interface to receive second audio input from the second local content source. User device 105 might further comprise a second video output interface to provide second video output to a second video display device and a second audio output interface to provide second audio output to a second audio receiver. In some cases (as with video calling device 105 or user device 105 above), the second video display device and the second audio receiver might be embodied in the same device (e.g., a TV with built-in speaker system, or the like). With the input and output interfaces, user device 105 might provide pass-through capability for video and/or audio between the second local content source and the second display device. In some instances, high-definition multimedia interface (“HDMI”) cables or other suitable HD signal cables may be used to provide the interconnections for the pass-through. User device 105 may, in some cases, comprise a second image capture device to capture at least one of second image data or second video data, and a second audio capture device to capture second audio data. User device 105 might also comprise a second network interface, at least one second processor, and a second storage medium in communication with the at least one second processor. Similar to the video calling devices 105, a plurality of user devices 105 may be communicatively coupled together in a network (e.g., network 115), as distributed infrastructure elements for implementing distributed infrastructure for cloud computing, cloud-based application hosting, and/or cloud-based data storage.

Once a user has been automatically identified and/or authenticated by a user device having identification and/or authentication functionality (e.g., by a PDD as described herein or as described in the '279 application), regardless of whether or not the user is associated with (or owns) such user device, the user may be provided with access to the video calling device(s) over the network and/or remote access to at least one of the user's master account, the user's user preference, the user's profiles, any videomail messages addressed to the user, and/or the like. Such access (as discussed above) may be in the form of web-based user interfaces, app-based user interfaces, or other suitable user interfaces. Such user interfaces might be customized automatically based on the user preferences (i.e., based on the video mail capture, processing, and distribution user preferences discussed above). In some instances, the user interfaces might be configured to allow addition, modification, and/or deletion of such user preferences. According to some embodiments, the user interfaces might provide the user with options for uploading, locally storing, cloud storing, distributing/sharing, processing, and/or otherwise handling recorded videomail messages from the video calling device(s). Some of these options may be preselected (or established as default settings) in the user preferences. In some cases, processing of videomail messages from the video calling device(s) might include, without limitation, formatting, sharpening, and/or otherwise manipulating the videomail messages.

In some cases, the user device (e.g., PDD) might be configured to determine whether the user is no longer present. Based on such a determination, access to the video calling device(s) over the network, as well as access to at least one (if not all) of the user's master account, the user's user preference, the user's profiles, any videomail messages addressed to the user (whether in the raw or processed state), media content, media content recommendations, and/or the like, may be blocked. Blocking such access may include automatically logging out of the web-based or app-based user interface, or the like.

These and other functionalities are described in detail in the Related Applications.

FIGS. 2A and 2B (collectively, “FIG. 2) illustrate various methods 200 of enabling or implementing presence detection and/or advertising based on detected presence and/or based on monitored media content or monitored users, in accordance with one set of embodiments. FIG. 2A illustrates an example method in which the PDD or ICD itself determines and provides advertisement based on a number of factors, while FIG. 2B illustrates an alternative method in which the PDD or ICD sends monitored information associated with a first media content to a server computer (e.g., server computer 135 in FIG. 1) and the server computer determines and provides advertisement based on a number of factors. While the techniques and procedures are depicted and/or described in a certain order for purposes of illustration, it should be appreciated that certain procedures may be reordered and/or omitted within the scope of various embodiments. Moreover, while the method illustrated by FIG. 2 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 2 (e.g., by executing instructions embodied on a computer readable medium), the system 100 can also operate according to other modes of operation and/or perform other suitable procedures.

At block 205, method 200 might comprise receiving, with a presence detection device (e.g., a PDD or ICD 105 as shown in FIG. 1, or the like), first media content. In some cases, the presence detection device might receive the first media content from a local content source (e.g., local content source 535 as shown in FIG. 5 or the like) or from a remote content source (e.g., media content server 150 via network 115 and/or 145, and perhaps also via control server 110, as shown in FIG. 1). In some cases, the presence detection device might comprise a video input interface to receive video input from the local content source, an audio input interface to receive audio input from the local content source, a video output interface to provide video output to a video display device, an audio output interface to provide audio output to an audio receiver, an image capture device to capture at least one of image data or video data, an audio capture device to capture audio data, a network interface, at least one processor, and a storage medium in communication with the at least one processor.

The method 200, at block 210, might comprise monitoring, with the presence detection device, information associated with the first media content. In some embodiments, the information associated with the first media content might include at least one of media content-based information and/or audience-based information. In some cases, monitoring media content-based information might comprise analyzing the media content as it is passed through the presence detection device, to determine the media content-based information. Additionally, or alternatively, monitoring media content-based information might comprise analyzing identification information that is sent together with the media content, the identification information including general information, bibliographical information, or other information regarding the media content. In other cases, monitoring media content-based information might comprise querying the source of the media content for media content-based information. According to some embodiments, monitoring audience-based information might include monitoring persons in the same room as the presence detection device using at least one of the image capture device, the audio capture device, another sensor (e.g., infrared sensor, other heat sensor, motion sensor, electronic device communications link (e.g., Bluetooth communications device, Wi-Fi communications device, near-field communications device, and/or the like)), and/or the like. In some cases, monitoring audience-based information might include querying one or more databases, which might collect information about the persons monitored by the presence detection device, or persons associated therewith.

Media content-based information might comprise at least one of type of media content of the first media content, genre of media content of the first media content, duration of media content of the first media content, time of day that the first media content is received and/or presented, performers associated with the first media content, producers associated with the first media content, year of release of the first media content, reviews of the first media content, and/or other media content related to the first media content. The type of media content might include, without limitation, television program content, movie content, music content, gaming content, news-related content, sports-related content, video clip content, advertisement content, and Internet-based media content.

The genre of the media content might be classified in terms of movie/TV genres, music genres, video game genres, and so on. For example movie/TV genres might include, but is not limited to, dramas, comedies, thriller, suspense, science fiction, fantasy, honor, action, adventure, animated, children's shows, or the like, or any combination of these genres. Music genres might include, without limitation, pop, rock, rap, R&B, punk, jazz, alternative, electronic, folk, hip hop, ska, country, classical, instrumental, and so on, or any combination of these genres. Video game genres might include, but are not limited to, first-person perspective games (e.g., first-person shooter games, first-person slasher games, first-person fighting games, first-person adventurer games, and/or the like), third-person perspective games (e.g., third-person shooter games, third-person slasher games, third-person fighting games, third-person adventurer games, and/or the like), fighting games (e.g., one-on-one combat games, arena combat games, mascot fighting games, multiplayer online batter arena games, and/or the like), action-adventure games, puzzle games, role-playing games (e.g., fantasy role-playing games, tactical role-playing games, action role-playing games, open world or sandbox role-playing games, massively multiplayer online role-playing games (“MMORPGs”), and/or the like), simulation games (e.g., construction and management simulation games, life simulation games, vehicle simulation games, etc.), strategy games (e.g., real-time strategy games, real-time tactics games, tower defense games, massively multiplayer online real-time strategy games, turn-based strategy games, turn-based tactics games, wargames, and/or the like), sports games (e.g., racing games, single-player sports games, team-based sports games, etc.), and/or the like.

The performers associated with the first media content might include, without limitation, actors, actresses, singers or vocalists, band members, musicians, orchestras, voice artists, etc. The producers associated with the first media content might include, but are not limited to, directors, film/video/music/game producers, game developers, artists, etc. The reviews of the first media content can include, without limitation, reviews given by industry-based critics or by average viewers/listeners/gamers/etc.

Audience-based information might comprise at least one of number of audience members present during presentation of particular portions of the first media content (or portions of the advertisement), identity of each audience member, gender of each audience member, age of each audience member, demographic group to which each audience member belongs (i.e., other than age or gender, which might include, without limitation, at least one of ethnicity, culture, language-proficiency, location, socio-economic grouping, income, political leanings, and/or the like), viewing patterns of each audience member, specific reactions of each audience member during presentation of particular portions of the first media content (or particular portions of the advertisement), overall reactions of each audience member throughout presentation of the first media content (or presentation of the advertisement), consistency of audience member reactions of each audience member compared with past reactions and/or with personal preferences of the audience member, consistency of audience member reactions of each audience member compared with past reactions of the audience member, and/or the like.

In some cases, each of the specific reactions or the overall reactions might comprise reactions selected from a group consisting of vocal expressions, facial expressions, hand gestures, body gestures, eye movement, eye focus, and/or shift in proximity with respect to the presence detection device, or the like. In some instances, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like.

At block 215, method 200 might comprise determining, with the presence detection device, at least one advertisement, based at least in part on the monitored information associated with the first media content. In some cases, the determination of the at least one advertisement might be based at least in part on analysis of one or more of identification of each person in a room in which the presence detection device is located, identification of each person viewing the first media content being displayed on the video display device, identification of each person listening to the first media content being presented over the speaker communicatively coupled to the audio receiver, and/or determination of whether the at least one advertisement is likely to be relevant to friends of each person (or demographic group members), or the like. In some cases, friends of each person might comprise known friends from contacts lists of personal profiles of each person. In some instances, friends of each person might comprise social media friends including acknowledged social media friend(s), potential social media friend(s), or friend of acknowledged social media friend(s). Herein, “determining at least one advertisement” might refer to selecting at least one advertisement from existing sets of advertisements or generating/creating at least one advertisement, and either selection or generation of the at least one advertisement may be based at least in part on one or more factors discussed with reference to FIGS. 1-6.

The method 200 might further comprise receiving, with the presence detection device, the determined at least one advertisement (block 220). At block 225, method 200 might comprise presenting, with the presence detection device, the at least one advertisement to the user. In some instances, presenting the at least one advertisement to the first user might comprise at least one of displaying the at least one advertisement to the display device, presenting the at least one advertisement to a speaker communicatively coupled to the audio receiver, and/or sending a message (containing the at least one advertisement) to a user device associated with the first user, or the like. In some cases, the presence detection device and the display device are integrated within a single user device associated with the first user, while in other cases, the presence detection device and the display device might be separate devices that are communicatively coupled either in a wired manner or wirelessly. In some instances, displaying the at least one advertisement to the display device might comprise displaying the at least one advertisement as an overlaying video image or still image on at least a portion of a display screen of the display device. According to some embodiments, the overlaying video image might include, by is not limited to, one of an overlay arrangement (e.g., a picture-in-picture (“PIP”) display, with the a notification regarding the at least one advertisement overlaid on the main content), a split screen arrangement (with the notification regarding the at least one advertisement adjacent to, but not obscuring, any portion of the main content), a passive banner stream (with non-interactive notification including the at least one advertisement in a banner(s) along one or more of a top, bottom, left, or right edge of a display field in which the main content is displayed on display device), and/or an interactive banner stream (with interactive notification including the at least one advertisement streaming in a banner(s) along one or more of a top, bottom, left, or right edge of a display field in which the main content is displayed on display device). In some cases, the message containing the at least one advertisement might include, but is not limited to, one or more of a text message, a short message service (“SMS”) message, a multi-media messaging service (“MMS”) message, a chat message, an e-mail message, a videomail message, and/or a voicemail message, or the like. The user device associated with the first user, in some instances, might include, without limitation, one or more of a laptop computer, a smart phone, a mobile phone, a portable gaming device, a desktop computer, a television, a set-top box, and/or a wearable computing device, or the like.

In some embodiments, the method 200 might further comprise collecting, with the presence detection device, feedback from the first user regarding the at least one advertisement (block 230), and sending, with the presence detection device, the collected feedback to an advertiser associated with each of the at least one advertisement, in response to receiving the collected feedback from the first user (block 235). In some cases, method 200 might further comprise determining, with the presence detection device, at least one second advertisement, based at least in part on the collected feedback (block 240).

Although FIG. 2A as described above is directed to the presence detection device determining the at least one advertisement (or at least one second advertisement), the various embodiments are not so limited, and the advertisements may be determined or generated by a server over a network (e.g., server 110 or advertisement server 135 in FIG. 1, or the like), which is shown with respect to FIG. 2B.

In FIG. 2B, the processes at blocks 205, 210, and 220-230 are similar, if not identical to those at blocks 205, 210, and 220-230 shown and described with respect to FIG. 2A, and thus the descriptions above with respect to the processes at these blocks in FIG. 2A are applicable to those at the corresponding blocks in FIG. 2B, and are omitted here for simplicity and to avoid excessive repetition.

With respect to FIG. 2B, method 200 might further comprise blocks 245-260, in place of block 215. At block 245, method 200 might comprise sending, with the presence detection device, the monitored information associated with the first media content to a server computer (e.g., control server 110 and/or advertisement server 135 of FIG. 1 or the like) over a network (e.g., network 115 or 145 of FIG. 1, the network 810 of FIG. 8, or the like). Method 200, at block 250, might comprise receiving, with the server computer, the monitored information associated with the first media content. Method 200 might further comprise determining (or generating), with the server computer, at least one advertisement (block 255). In some cases, the server determinations (or generation) of the at least one advertisement may be determined (or generated) based at least in part on the monitored information associated with the first media content.

In some embodiments, method 200 might include determining, with the presence detection device, the at least one advertisement (at block 215) as in FIG. 2A, and sending the monitored information (at block 245) can include sending both the monitored information and the determination of the at least one advertisement by the presence detection device. In such embodiments, determining or generating, with the server computer, at least one advertisement (at block 255) can include determining or generating, with the server computer, the at least one advertisement based at least in part on the monitored information associated with the first media content and at least in part on the determinations of the at least one advertisement by the presence detection device.

Blocks 220-230, or similar processes, may be executed in response to block 260. According to some embodiments, after collecting the feedback from the user regarding the at least one advertisement (at block 230), method 200 might further comprise, at block 265, sending, with the presence detection device, the collected feedback to the server computer. At block 270, method 200 might comprise sending, with the server computer, the collected feedback to an advertiser associated with each of the at least one advertisement. In some cases, method 200 might further comprise determining, with the server computer, at least one second advertisement, based at least in part on the feedback. In some instances, the advertiser or the server computer might generate the at least one second advertisement, based at least in part on the feedback (and, in some cases, based at least in part on the monitored information associated with the first media content).

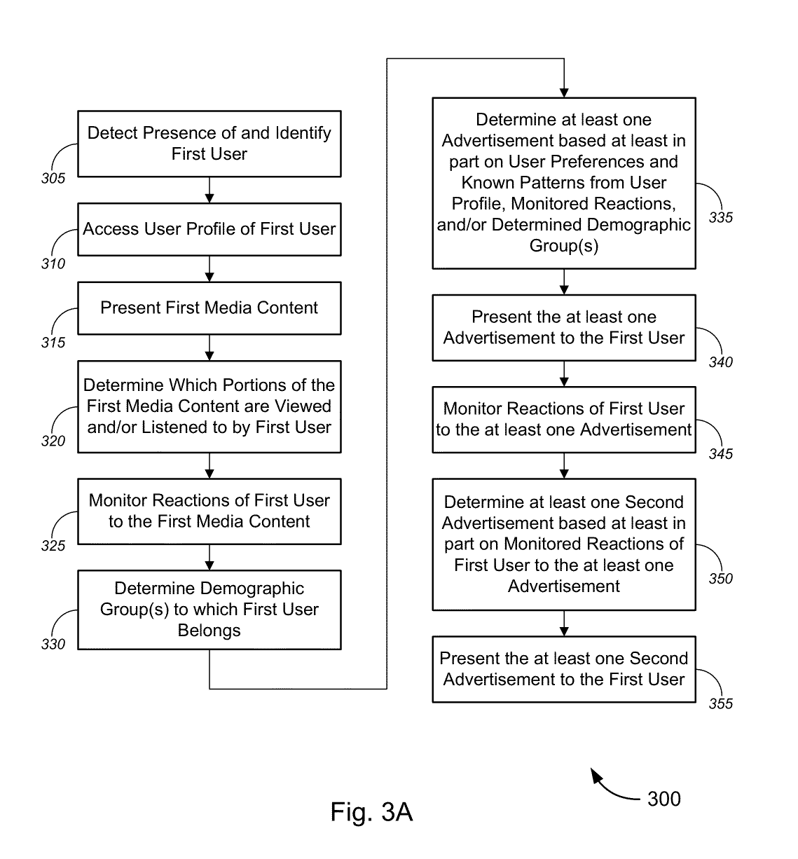

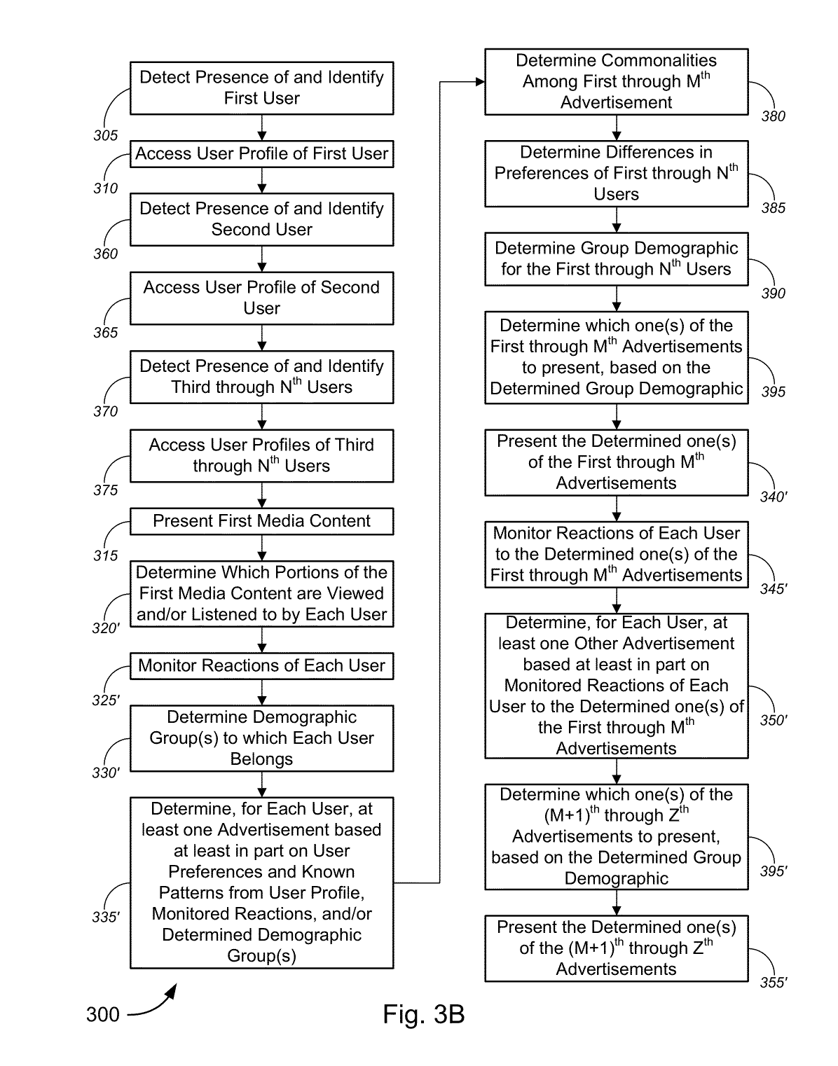

We now turn to FIGS. 3A and 3B (collectively, “FIG. 3”), which illustrate various methods 300 of enabling or implementing presence detection and/or advertising based on detected presence and/or based on monitored media content or monitored users, in accordance with one set of embodiments. FIG. 3A illustrates an example method in which a single user is present and the PDD or ICD detects, identifies, and monitors reactions of the single user, while FIG. 3B illustrates an alternative method in which multiple users are present and the PDD or ICD detects, identifies, and monitors reactions of each of the multiple users. In both cases, the PDD/ICD and/or the server computer determines advertisement to be presented to the user(s). While the techniques and procedures are depicted and/or described in a certain order for purposes of illustration, it should be appreciated that certain procedures may be reordered and/or omitted within the scope of various embodiments. Moreover, while the method illustrated by FIG. 3 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 3 (e.g., by executing instructions embodied on a computer readable medium), the system 100 can also operate according to other modes of operation and/or perform other suitable procedures. In some embodiments, method 300 might be implemented complementary to method 200 of FIG. 2, while in other embodiments, method 200 may be implemented independently, separately, or otherwise without implementing method 300.

With reference to FIG. 3A, the method 300 might comprise detecting presence of, and identifying, a first user (block 305). At block 310, method 300 might comprise accessing a user profile(s) of the first user. In some cases, the user profile(s) might be stored locally in a presence detection device (“PDD”), an image capture device (“ICD”), or user device associated with the first user, locally in a data store communicatively coupled (but external) to the PDD or ICD, remotely in a data store (e.g., database 130, 140, and/or 155 of FIG. 1, or the like), and/or the like. The PDD, ICD, or user device might present the first media content to the user (block 315). The PDD, ICD, or user device might monitor the first media content being presented and/or the first user during presentation of the first media content. For example, method 300 might comprise determining which portions of the first media content are viewed and/or listened to by the first user (block 320) and/or monitoring reactions of the first user (block 325). In some embodiments, each of the specific reactions or the overall reactions might include, without limitation, vocal expressions, facial expressions, hand gestures, body gestures, eye movement, eye focus, and/or shift in proximity with respect to the presence detection device, or the like. In some instances, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like.

In some embodiments, level of interest of the first user may be gauged by determining how much time the first user is actually viewing, listening to, or playing the media content, whether or not the first user replays one or more portions of the media content, the first user's proximity to display screen or speaker system, etc. For example, the eye movement tracking, eye focus determination, proximity detection, voice recognition, facial recognition techniques, and/or the like may be used to determine when the first user is paying attention to the media content being presented and to which portions the attention of the first user is drawn (e.g., the first user leaning in toward the display screen, the first user screaming or pumping his or her arms in encouragement of actions by a character in the media content, the first user shouting words like “awesome,” “cool,” or “whoa,” the first user staring intently (e.g., without blinking, etc.) at certain portions of the display screen corresponding to actions or characters in the media content, etc.). In a similar manner, media content and/or scenes of media content that the user is not interested in or repulsed by may be determined or identified using similar techniques (e.g., the first user cringing when presented with a gruesome scene of carnage or torture in a movie or video game, the first user exhibiting signs of wanting to throw up when presented with scenes of utter disgust, the first user backing away from the display screen, the first user forcefully closing his or her eyes or otherwise purposely looking away, etc.).

Monitoring of the presentation of the media content may be used to determine whether the user is replaying at least portions of the media content, and to determine which portions are being replayed. Similarly, monitoring of the presentation of the media content may also be used to determine whether the first user is skipping or fast-forwarding through scenes, and which portions of the media content are being skipped or fast-forwarded. The results of these determinations based on monitoring of the first user's reactions and monitoring of the media content may be used to determine advertisements, and/or to eliminate potential candidate advertisements from potential lists of existing advertisements that may be relevant to the user.

These detection techniques might utilize one or more of an image or image capture device, an audio capture device, a proximity detection device, a motion sensing device, a heat sensing device (e.g., an infrared sensor, a thermosensor, or the like), a communications device (e.g., Bluetooth communications device, Wi-Fi communications device, or near-field communications device, or the like), and/or the like.

At block 330, method 300 might include determining demographic group(s) to which the first user belongs. In some embodiments, determining demographic group(s) to which the first user belongs might include determining known friends and/or social media friends of the first user, and perhaps determining what advertisements are likely to be relevant to such known friends and/or social media friends of the first user. Such determination of likely relevant advertisements might be a factor in determining what advertisements might likely be relevant to the first user. Method 300 might further comprise, at block 335, determining at least one advertisement, based at least in part on user preferences and known patterns from the user profile(s), monitored reactions of the first user, determined demographic group(s), determined advertisements likely to be relevant to friends of the first user, and/or the like.

At block 340, method 300 might comprise presenting the at least one advertisement to the first user. Method 300 might further comprise monitoring reactions of the first user to the at least one advertisement (block 345). The monitoring process at block 325 may be repeated for the monitoring processes at block 345. In particular, in some embodiments, each of the specific reactions or the overall reactions to the at least one advertisement might include, without limitation, vocal expressions, facial expressions, hand gestures, body gestures, eye movement, eye focus, and/or shift in proximity with respect to the presence detection device, or the like. In some instances, the audience-based information might be monitored using one or more of facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like.

In some embodiments, level of interest of the first user toward the presented at least one advertisement (at block 340) may be gauged by determining how much time the first user is actually viewing, listening to, or playing the at least one advertisement, whether or not the first user replays one or more portions of the at least one advertisement (where replay functionality is available), the first user's proximity to display screen or speaker system, etc. For example, the eye movement tracking, eye focus determination, proximity detection, voice recognition, facial recognition techniques, and/or the like may be used to determine when the first user is paying attention to the at least one advertisement being presented and to which portions the attention of the first user is drawn (e.g., the first user leaning in toward the display screen, the first user screaming or pumping his or her arms in encouragement of actions by a character in the at least one advertisement, the first user shouting words like “awesome,” “cool,” or “whoa,” the first user staring intently (e.g., without blinking, etc.) at certain portions of the display screen corresponding to actions or characters in the at least one advertisement, etc.). In a similar manner, advertisements and/or scenes of advertisements that the user is not interested in or repulsed by may be determined or identified using similar techniques (e.g., the first user cringing when presented with an overly tacky scene in an advertisement, the first user exhibiting signs of wanting to throw up when presented with scenes of utter disgust, the first user backing away from the display screen, the first user forcefully closing his or her eyes or otherwise purposely looking away, etc.).

Monitoring of the presentation of the at least one advertisement may be used to determine whether the user is replaying at least portions of the at least one advertisement (where replay functionality for advertisements is available), and to determine which portions are being replayed. Similarly, monitoring of the presentation of the at least one advertisement may also be used to determine whether the first user is skipping or fast-forwarding through scenes, and which portions of the at least one advertisement are being skipped or fast-forwarded. The results of these determinations based on monitoring of the first user's reactions and monitoring of the at least one advertisement may be used to determine the at least one second advertisement, and/or to eliminate potential candidate advertisements (or types of advertisements) from potential lists of advertisements for the user.

These detection techniques, as with those for the media content, might utilize one or more of an image or image capture device, an audio capture device, a proximity detection device, a motion sensing device, a heat sensing device (e.g., an infrared sensor, a thermosensor, or the like), a communications device (e.g., Bluetooth communications device, Wi-Fi communications device, or near-field communications device, or the like), and/or the like.

Method 300, at block 350, might comprise determining at least one second advertisement based at least in part on the monitored reactions of the first user to the at least one advertisement. In some embodiments, similar to determination of the at least one first advertisement (at block 330), determining the at least one second advertisement might be based at least in part on user preferences and known patterns from the user profile(s), monitored reactions of the first user to the presented media content (at block 325), determined demographic group(s) (at block 330), determined advertisements likely to be relevant to friends of the first user, and/or the like. In some cases, determining the at least one second advertisement might additionally be based on the determined at least one advertisement (at block 335). At block 355, method 300 might comprise presenting the at least one second advertisement to the first user.

According to some embodiments, blocks 315-325 (and in some cases block 330 as well) may be omitted, in which case, the user's presence is detected and the user is identified (at block 305), the user's user profile is accessed (at block 310), (optionally) the demographic group(s) to which the user belongs may be determined (at block 330), the at least one advertisement may be determined based at least in part on the user preferences and known patterns from the user profile and/or based at least in part on the determined demographic group (at modified block 335), and the at least one advertisement may then be presented to the user (at block 340). Blocks 345-355 may be similar, if not identical, to blocks 345-355 in the embodiments of FIG. 3A described above in which blocks 315-325 are not omitted. In other words, advertisement may be generated based at least in part on presence detection of the user. This allows for targeted advertising to the user while ensuring that the user is present when the targeted advertisements are presented to the user; in such cases, the presentation of the advertisements should be relatively contemporaneous with detection/identification of the user to ensure presence of the user. In some cases, presence detection of the user (at block 305) may additionally be repeated just prior to presentation of the at least one advertisement (at block 340). In some instances, the at least one advertisement (at block 340) may be presented, in response to a detection of the presence of the user (at the repeated block 305, just prior to block 340).

Although FIG. 3A as described above is directed to basing advertisements on monitoring a single user and on information relevant to the single user (e.g., what the single user's friends, demographic group members, etc. are interested in), the various embodiments are not so limited, and the generation of advertisements may be based on monitoring two or more users simultaneously or concurrent, as well as on information relevant to each user (e.g., what each user's friends, demographic group members, etc. are interested in), which is shown with respect to FIG. 3B.

In FIG. 3B, the processes at blocks 305-315 are similar, if not identical to those at blocks 305-315 shown and described with respect to FIG. 3A, and thus the descriptions above with respect to the processes at these blocks in FIG. 3A are applicable to those at the corresponding blocks in FIG. 3B, and are omitted here for simplicity and to avoid excessive repetition.

With respect to FIG. 3B, method 300 might further comprise detecting presence of, and identifying, a second user (block 360), accessing a user profile(s) of the second user (block 365), detecting presence of, and identifying, each user from a third user up to an N^{th} user (block 370), and accessing a user profile(s) of each user from the third user to the N^{th} user (block 375). The processes at blocks 320′-330′ are modified for each of the plurality of users, rather than just the first user, but are otherwise similar to blocks 320-330 in FIG. 3A, respectively. At block 335′, method 300 might comprise determining first through M^{th} advertisements (i.e., determining at least one advertisement for each of the first through N^{th} users), based at least in part on user preferences and known patterns from the user profile(s) of each of the N users, monitored reactions of each of the first through N^{th} user, determined demographic group(s) for each of the first through N^{th} user, determined advertisements likely to be relevant to friends of each of the first through N^{th} user, or the like. In some cases, M might equal N (i.e., where each of the N users has a different determined advertisement). In other cases, M might be less than N (i.e., where at least two of the N users might have the same determined advertisement, while the other users might have different determined advertisement). In yet other cases, M might be greater than N (i.e., where at least one of the N users might have more than one determined advertisement, and where sufficient numbers of the N users have different determined advertisement, or the like).

Method 300 might include determining commonalities among the first through M^{th} advertisements (block 380), determining differences in preferences of the first through N^{th} users (block 385), and determining group demographics for the first through N^{th} users (block 390). If there are conflicting determinations of advertisements, it may be determined which one or more of the first through M^{th} advertisements would likely be accepted by, or relevant to, the first through N^{th} users. For example, in some cases, likes, dislikes, or indifferences of each user with respect to particular advertisements or type of advertisements might be taken into account when determine which one or more of the first through M^{th} advertisements would likely be accepted by, or relevant to, the first through N^{th} users. Viewing patterns of each user (either alone or in particular groups with one or more of the present users of the group) might also be taken into account.

At block 395, method 300 might comprise determining which one(s) of the first through M^{th} advertisements (corresponding to the determined at least one advertisement for each of the first through N^{th} users), based at least in part on the determined group demographic. In a non-limiting example, when the PDD detects 3 adult females in the room and 2 male children, it may be determined to present targeted advertisements to the adult females (i.e., determining one(s) of the first through M^{th} advertisements relevant to at least a majority of the adult females). In another non-limiting example, when the PDD detects 1 adult female and a number of children in the room, it may be determined to present advertisements for the children (i.e., determining one(s) of the first through M^{th} advertisements relevant to at least a majority of the children), unless local laws or regulations (and/or user preferences associated with the PDD) prohibit targeting children for advertisement. In a number of embodiments, if the PDD detects only children in the room, the PDD might prohibit any presentation of targeted advertisements to the children (in some cases, general, non-targeted advertisements may still be presented where only children are present; while in other cases, no advertisements might be presented where only children are present).

Method 300, at block 340′, might comprise presenting the determined one(s) of the first through M^{th} advertisements. According to some embodiments, at block 345′, method 300 might comprise monitoring reactions of each user to the determined one(s) of the first through M^{th} advertisements. Method 300 might further comprise determining, for each user, at least one other advertisement, based at least in part on monitored reactions of each user to the determined one(s) of the first through M^{th} advertisements (block 350′) and determining which one(s) of the (M+1)^{th} through Z^{th} advertisements (corresponding to the at least one second advertisement for each of the first through N^{th} users, as determined at block 350′) (block 395′). The processes at blocks 350′ and 395′ would otherwise be similar, if not identical, to the processes at block 350 in FIG. 3A and at block 395 in FIG. 3B, respectively, and thus the descriptions thereof would be similar to those for blocks 350′ and 395′ in FIG. 3B. At block 355′, method 300 might comprise presenting the determined one(s) of the (M+1)^{th} through Z^{th} advertisements.

According to some embodiments, as in the embodiment of FIG. 3A in which advertisement may be generated based at least in part on presence detection of the user, blocks 315, 320′, 325′ (and in some cases block 330′ as well) may be omitted, in which case, each user's presence is detected and each user is identified (at blocks 305, 360, and 370), each user's user profile is accessed (at blocks 310, 365, and 375), (optionally) the demographic group(s) to which each user belongs may be determined (at block 330′), the at least one advertisement, for each user, may be determined based at least in part on the user preferences and known patterns from the user profile of each user and/or based at least in part on the determined demographic group(s) of each user (at modified block 335′), one(s) of the first through M^{th} advertisements may be determined (at blocks 380-395), and the determined one(s) of the first through M^{th} advertisements may then be presented to the present users (at block 340′). Blocks 345′, 350′, 395′, and 355′ may be similar, if not identical, to blocks 345′, 350′, 395′, and 355′ in the embodiments of FIG. 3B described above in which blocks 315, 320′, 325′ are not omitted. In other words, advertisement may be generated based at least in part on presence detection of the users. This allows for targeted advertising to the group of users while ensuring that the users are present when the targeted advertisements are presented to the users; in such cases, the presentation of the advertisements should be relatively contemporaneous with detection/identification of the users to ensure presence of the users. In some cases, presence detection of the users (at blocks 305, 360, and 370) may additionally be repeated just prior to presentation of the determined one(s) of the first through M^{th} advertisements (at block 340′). In some instances, the determined one(s) of the first through M^{th} advertisements (at block 340′) may be presented, in response to a detection of the presence of the users (at the repeated blocks 305, 360, and 370, just prior to block 340′).

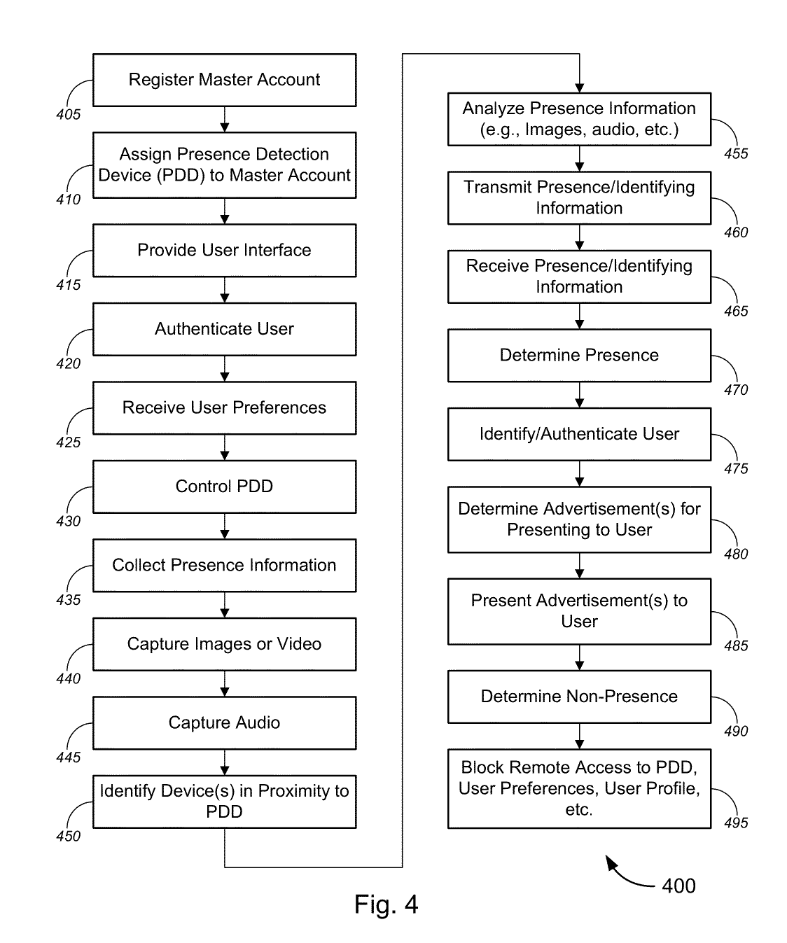

FIG. 4 illustrates a method 400 of enabling or implementing presence detection and/or advertising based on detected presence and/or based on monitored media content or monitored users, in accordance with one set of embodiments. While the techniques and procedures are depicted and/or described in a certain order for purposes of illustration, it should be appreciated that certain procedures may be reordered and/or omitted within the scope of various embodiments. Moreover, while the method illustrated by FIG. 4 can be implemented by (and, in some cases, are described below with respect to) the systems 100, 700, and/or 800 of FIGS. 1, 7, and/or 8, respectively (or components thereof), such methods may also be implemented using any suitable hardware implementation. Similarly, while each of the system 100 (and/or components thereof) of FIG. 1, the system 700 (and/or components thereof) of FIG. 7, and/or the system 800 (and/or components thereof) of FIG. 8 can operate according to the method illustrated by FIG. 4 (e.g., by executing instructions embodied on a computer readable medium), the system 100 can also operate according to other modes of operation and/or perform other suitable procedures. In some embodiments, method 400 might be implemented complementary to method 200 of FIG. 2 and/or method 300 of FIG. 3, while in other embodiments, each of method 200 or method 300 may be implemented independently, separately, or otherwise without implementing method 400.

Turning to FIG. 4, the method 400 might comprise registering a master account for a user (block 405). In accordance with various embodiments, registering a master account for a user can comprise a variety of operations. Merely by way of example, registering a master account can comprise creating a database entry for a particular user and/or assigning authentication credentials to that user; these credentials can be used to access the master account, as described in further detail below.

The method 400 can also include assigning one or more PDDs or ICDs (e.g., user devices 105 in FIG. 1) to the master account (block 410). As discussed above, the one or more PDDs or ICDs can be embodied by a video calling device, such as any of the video calling devices described herein, the VCDs described in the '182 patent, the video calling devices or users devices described in any of the Related Applications, a laptop computer, a desktop computer, a mobile phone, a smart phone, a tablet computer, a video game console, and/or a streaming media player, to name a few non-limiting examples. For instance, the user might identify any PDDs or ICDs that the user owns (or is otherwise associated with; e.g., members of the user's family might be associated with the devices owned by the user), and the system can assign those PDDs or ICDs to the user's master account. According to some embodiments, the user's master account might include any suitable number of sub-accounts. In one example, each member of the user's family might be associated with a sub-account linked with the master account. In some instances, the user (or some members of his or her family) might have a work/school sub-account and a home sub-account, the former being associated with profiles and/or media content appropriate for school or work, while the latter being associated with all, or all other, profiles and/or media content. In some embodiments, the master account and the plurality of sub-accounts might be organized as a hierarchy, with the master account (being at the top of the hierarchical structure) having full access to profiles and media content of each sub-account, the sub-accounts at the next level having access to profiles and/or media content of only those sub-accounts that the master account has given access to, and the sub-accounts at lower levels having limited access to profiles and/or media content. For example, the user's master account might have access to all profiles and/or media content associated with the master account and the sub-accounts. The user can provide his or her spouse with a sub-account having the same access to profiles and/or media content, while providing limited access to profiles and/or media content to each of the user's children's sub-account(s). In some instances, the user and/or the user's spouse might impose limits on access to profiles and/or media content for each of their work sub-accounts.

In some cases, each PDD or ICD might have an identifier, such as a hardware identifier, IP address, nickname, and/or the like, by which the system can address the PDD or ICD, and assigning a PDD or an ICD to the master account can comprise associating that identifier with the master account. When a PDD or an ICD is assigned to a master account, the user of that account will be able to access, configure, and/or control the PDD or ICD through the control server, for example as described in further detail below. In some cases, the user might own a plurality of PDDs or ICDs and might wish to control all of the PDDs or ICDs from a single master account. In an aspect, a user can identify such devices through a user interface to the control server.

In another aspect, as described briefly above, the assignment process can be simplified. When the user first configures a PDD or an ICD (usually locally, but perhaps over the network), the user can provide credentials to the PDD that associate the device with the master account. Thereafter, the PDD or ICD might be configured to communicate with the control server and identify itself using those credentials; at that point, the control server can assign the PDD or ICD to the master account, and no credentials need to be stored on the PDD or ICD from that point forward (other than perhaps the PDD's or ICD's own identifying information).

Hence, the method 400, in the illustrated embodiment, might further comprise providing a user interface to allow interaction between the user and the control server (block 415). For example, the user interface can be used to output information for a user, e.g., by displaying the information on a display device, printing information with a printer, playing audio through a speaker, etc.; the user interface can also function to receive input from a user, e.g., using standard input devices such as mice and other pointing devices, motion capture devices, touchpads and/or touchscreens, keyboards (e.g., numeric and/or alphabetic), microphones, etc. The procedures undertaken to provide a user interface, therefore, can vary depending on the nature of the implementation; in some cases, providing a user interface can comprise displaying the user interface on a display device; in other cases, however, in which the user interface is displayed on a device remote from the computer system (such as on a client computer, wireless device, etc.), providing the user interface might comprise formatting data for transmission to such a device and/or transmitting, receiving, and/or interpreting data that is used to create the user interface on the remote device. Alternatively and/or additionally, the user interface on a client computer (or any other appropriate user device) might be a web interface, in which the user interface is provided through one or more web pages that are served from a computer system (and/or a web server in communication with the computer system), and are received and displayed by a web browser on the client computer (or other capable user device). The web pages can display output from the computer system and receive input from the user (e.g., by using Web-based forms, via hyperlinks, electronic buttons, etc.). A variety of techniques can be used to create these Web pages and/or display/receive information, such as JavaScript, Java applications or applets, dynamic Hypertext Markup Language (“HTML”) and/or Asynchronous JavaScript and XML (or extensible markup language) (“AJAX”) technologies, to name but a few examples.

In many cases, providing a user interface will comprise providing one or more display screens each of which includes one or more user interface elements. As used herein, the term “user interface element” (also described as a “user interface mechanism” or a “user interface device”) means any text, image, or device that can be displayed on a display screen for providing information to a user and/or for receiving user input. Some such elements are commonly referred to as “widgets,” and can include, without limitation, text, text boxes, text fields, tables and/or grids, menus, toolbars, charts, hyperlinks, buttons, lists, combo boxes, checkboxes, radio buttons, and/or the like. While any illustrated exemplary display screens might employ specific user interface elements appropriate for the type of information to be conveyed/received by computer system in accordance with the described embodiments, it should be appreciated that the choice of user interface elements for a particular purpose is typically implementation-dependent and/or discretionary. Hence, the illustrated user interface elements employed by any display screens described herein should be considered exemplary in nature, and the reader should appreciate that other user interface elements could be substituted within the scope of various embodiments.

As noted above, in an aspect of certain embodiments, the user interface provides interaction between a user and a computer system. Hence, when this document describes procedures for displaying (or otherwise providing) information to a user, or to receiving input from a user, the user interface may be the vehicle for the exchange of such input/output. Merely by way of example, in a set of embodiments, the user interface allows the user to log on to a master account, access video calling devices, PDDs, or ICDs via the control server, access settings/preferences (e.g., viewing settings/preferences/histories, music or audio settings/preferences/histories, gaming settings/preferences/histories, videomail settings/preferences, etc.), access videomail or other messages, and/or the like.

In an aspect of some embodiments, the user logs onto his or her master account at the control server in order to access and/or control PDDs or ICDs assigned to that account, and/or access settings/preferences, and/or the like. Accordingly, at block 420, the method 400 can include authenticating the user with a set of credentials associated with the master account (e.g., with any of several known authentication schemes, such as a userid/password challenge, a certificate exchange process, and/or the like, as well as authentication techniques, described in further detail below, that employ sensors on a PDD or an ICD, such as facial recognition, voiceprint analysis, gesture-based identification, spoken identifiers, and/or the like). Once the user has been authenticated, the user interface can present the user with a variety of different information, including without limitation information about status of PDDs or ICDs assigned to the master account to which the user has logged on, options for controlling such PDDs or ICDs, options for accessing media content, options for modifying user settings or preferences, and/or the like.

Thus, in some aspects, the method 400 might further comprise receiving (e.g., via a network, such as the Internet, to name one example) user preferences (block 425), and in particular user preferences relating to the collection and/or use of presence information, including, without limitation, preferences such as those described above. The method 400, then, can further include controlling and/or configuring the PDD or ICD, in some cases based at least in part on the user preferences (block 430). In some embodiments, the user preferences might include user preferences for collecting presence information, user preferences for monitoring people within a room (i.e., room in which the PDD or ICD is located), user preferences for determining advertisements (e.g., basing determinations of advertisements on advertisements that are determined to likely be relevant to known friends, potential friends, and/or social media friends; basing determinations of advertisements on past viewing, listening, Internet browsing, or gaming history or patterns; basing determinations of advertisements on information obtained from user's communications; etc.), user preferences for notifying the user regarding advertisements, user preferences for advertisements, and/or the like.

Merely by way of example, the user might have specified in the user preferences that the PDD or ICD should not be used to collect presence information at all, in which case that feature might be turned off at the PDD or ICD. In the case that the user preferences indicate that presence information should be turned off (e.g., privacy settings may be set high, either permanently or temporarily, and/or with respect to certain user-established and/or preset conditions, or the like), some embodiments might establish a blocking feature for the user when other PDDs or ICDs send presence information for comparison matching processes with database user biometrics, the effect of which being that no match can be made, and thus the user's profiles and/or media content (and/or access thereto) is not ported to the other PDDs or ICDs. Alternatively and/or additionally, the user might have specified some limitations on the collection of presence information (such as about whom such information may be collected, times at which information can be collected, and/or purposes for which information may be collected, to name a few examples). Of course, in some embodiments, these preferences can be set directly at the PDD or the ICD, e.g., through a menu system displayed on a video device. It should also be recognized that some preferences (such as with whom presence information can be shared) might not affect the PDD or ICD and might be saved and/or operated on at the control server instead.

The amount of control imposed by the control server can vary according to embodiment and implementation. Merely by way of example, as noted above, in some embodiments, there might be no control server, and the PDD or ICD might incorporate all the functionality described herein with regard to the control server, including peer-to-peer functionality with other PDDs or ICDs. In other embodiments, the control server might provide fairly fine-grained control over the PDD or ICD, such as instructing the camera to capture images for purposes of determining presence, and/or the control server may receive the images directly and perform the presence determination, identification, and/or authentication procedures at the control server. The division of responsibility between the control server and the PDD or ICD can fall anywhere along this spectrum. In some cases, for instance, the control server might provide the user preferences to the PDD or ICD, which then is responsible for collecting presence information in accordance with those preferences and transmitting the presence information to the control server, which takes the appropriate action in response to the presence information, such as selecting an advertisement based on the presence information. Alternatively and/or additionally, the PDD or ICD itself might be responsible for taking such actions. Likewise, for determining advertisements, either the PDD/ICD or the control server might perform such functionality. In some cases, the PDD or ICD might determine advertisements based on local information (e.g., information associated with the user(s), reactions of the user(s), preferences/history/patterns of the user, and/or the like), while the control server might determine advertisements based on remote information (e.g., information associated with known friends, potential friends, and/or social media friends, information associated with demographic groups to which the user belongs, and/or the like).

At block 435, the method 400 can comprise collecting presence information. A variety of operations might be involved in the collection of presence information. For example, in some cases, the PDD or ICD captures one or more images of at least a portion of a room where it is located and/or of a user present in the room (block 440). Such images can be digital still images, a digital video stream, and/or the like. In other cases, the method can include capturing audio samples (block 445), identifying devices in proximity to the capturing device (block 450), and/or the like (for example as described above).

The method 400 can further comprise analyzing one or more of the collected presence information (block 455), including one or more of the images, video samples, audio samples, etc. Merely by way of example, the images and/or video samples might be analyzed with facial recognition software and/or other biometric/physiological recognition software, which can be used to determine the number of people in the room with the PDD or ICD and/or to identify any of such people (e.g., by determining a name, an age range, a gender, and/or other identifying or demographic information about a user, based on the output of the facial recognition software and/or other biometric/physiological recognition software). Alternatively and/or additionally, analyzing the images can comprise determining that a person is watching a display device, for example using eye-tracking software to identify a focus area of the person's eyes and correlating that focus area with the location on a screen or display of a television (or other suitable display device). In some cases, if the number of people and the identities (or at least demographic characteristics) of each of the people in the room can be determined, analyzing the images can further include determining a collective demographic of the people in the room (based, for example, on the demographic characteristics of a majority of people in the room). In further cases, the method might analyze audio samples using voiceprint analysis, compare user responses to stored challenge/response information, and/or the like. As yet another example, a camera of a PDD or ICD might capture user gestures, which can be compared with stored gestures (e.g., a particular pattern of hand waving, a pattern of fingers displayed by the user, etc.) in a gesture-based identification and/or authentication scheme. It should be noted that many embodiments can use various combinations of such techniques (such as a combination of facial analysis and spoken, gestured, or typed identifiers, to name a few examples) to provide two-factor authentication. Moreover, such identification techniques may be used to monitor reactions of users, which can then be used as one of the bases for generating media content recommendations and for determining advertisements, as described in detail above.

The identification analysis described above can be performed at the PDD/ICD and/or at the control server. Accordingly, in some embodiments, the PDD or ICD will transmit presence information or other identifying information that can be used (in part or in whole) for identifying the user. Such identifying information can include raw or analyzed presence information, as well as information derived from the presence information, such as, to name some examples, extracted features from an image, audio segment, and/or video segment; an excerpted image, video, and/or audio segment; and/or the like. Such presence information and/or identifying information can be transmitted from the PDD or ICD to the control server (block 460), although as noted above, this is not necessary in some embodiments (e.g., where identifying the user or other analysis is performed at the PDD or ICD). Such transmission might comprise IP communications over the Internet, (perhaps over a secure channel, such as a virtual private network (“VPN”)), and, as noted above, the presence/identifying information can include a wide variety of different types of information that enable the control server to determine presence and/or identify/authenticate a user. Hence, at block 465, the control server (in a cloud-based presence detection scheme) might receive the transmitted presence information. In the case that raw presence information is received by the control server, the control server might analyze the raw presence information in a similar manner as described above at block 455. At block 470, the method 400 comprises detecting and/or determining presence of a user. This determination can be made by the PDD/ICD and/or by the control server. In one case, for example, the PDD or ICD might transmit raw video segments, raw images, raw audio samples, etc. to the server, which might perform all analysis and presence determination. In another case, the PDD or ICD might perform this analysis and might notify the control server that a user is present. Receiving such a notification at the control server can be considered to be the control server detecting presence of a user.

At block 475, the method 400 can include identifying and/or authenticating a user. In some cases, this identification and/or authentication can be implicit in the operation of detecting user presence. For example, in performing facial recognition to detect that a user is present, the PDD or ICD (and/or control server) might further analyze the same image to determine an identity of the present user. Alternatively, however, detection of user presence and identification/authentication of the user might be performed as discrete steps (and might depend on device capabilities). For example, a PDD or ICD might have sufficient capabilities to detect the presence of the user, and if so, might send identifying information (such as a captured image, video sample, audio sample, etc.) to the control server to actually identify the user. Alternatively, the PDD or ICD might be capable of identifying the user on its own and might merely send the identity of the user (i.e., data identifying the user, such as a name, username, etc.) to the server.

In some instances, the PDD/ICD and/or the control server (i.e., in a cloud-based presence scheme) might have access to the user's profile or other personal information of the user (including, without limitation, communications, calendar items, contacts list, travel/itinerary information, IP address of user's PDD(s) or ICD(s), or the like). Such profile or other personal information might indicate that the user is visiting a friend or relative in a different city, state, or country. In the case that the friend or family member has a similar PDD or ICD linked to a common network with the control server or other PDDs or ICDs (i.e., in a peer-to-peer or distributed computing scheme), the user's PDD/ICD and/or the control server (if present) might facilitate identification and/or authentication of the user at the friend's or relative's PDD or ICD (“other PDD” or “other ICD”), by, for example, sending the user's biometric/physiological information to the other PDD or ICD and/or to a data center local to the other PDD or ICD, so as to reduce comparison/matching times for identification/authentication of the user at the other PDD or ICD. Such proactive autonomous facilitation functionality might, in some cases, be subject to the user's selection of such option in the user preferences (e.g., at block 425 above). In some cases, the user might disable and/or limit such functionality (e.g., for privacy reasons, for security reasons, and/or the like). In some embodiments, the IP address of a PDD or an ICD at which a user attempts to log in might be analyzed to determine the city in which the PDD or ICD is located. If the city (or neighborhood or customer premises) of the last PDD or ICD at which the user logged in (or is otherwise authenticated by) is determined to be different from the city (or neighborhood or customer premises) of the current PDD or ICD, then it can be inferred that the user has moved, or is travelling. Such inference may be used, in some embodiments, to further infer a general direction in which the user is travelling (or to infer a potential destination(s), if sufficient numbers of data points/locations are determined), and can be used to send ahead the user's profile and/or content to control servers and/or PDDs/ICDs that are at or near the determined potential destination(s).

Once the present user has been identified and/or authenticated, the control server (and/or the PDD or ICD at which the user is present) might enable or implement determination of at least one advertisement (e.g., based at least in part on the monitored media content presentation and/or based at least in part on monitoring of the user(s), and/or the like), in accordance with any or all of the processes in blocks 205-275, as described in detail above with respect to FIG. 2, and/or in blocks 305-395′, as described in detail above with respect to FIG. 3.

According to some aspects, in response to determining the presence of the user (at block 470) and/or identifying and authenticating the user (at block 475), method 400 might further comprise determining at least one advertisement for presenting to the user (block 480), which is described in detail above with respect to FIGS. 1-3. At block 485, method 400 might comprise presenting the at least one advertisement to the user, in some cases, in response to determining the presence of the user (at block 470) and/or identifying and authenticating the user (at block 475).

In some embodiments, the PDD, ICD, and the video calling device might be the same user device, in which case, the video calling device might detect presence of a user (as described in detail above with respect to the PDD or ICD), and might notify a computer about the detected presence of a user. Such a video calling device might then receive, over a network, control instructions from the computer to enable or implementing presence detection and/or advertising based on detected presence and/or based on monitored media content or monitored users, in response to the detected presence of the user.

In some embodiments, the method 400 might further comprise determining that a user is no longer present at the PDD or ICD (block 490). For example, as noted above, the system might continuously and/or periodically capture images and perform presence determination techniques (e.g., as described above) to determine whether the user is still present, and/or might actively query the user after some period of time to determine whether the user is still present. If the system determines that the user is no longer present, the system can block remote access (and control) of the PDD or ICD, remote access to user preferences, and remote access to the user profile, etc. over the network (block 495). For example, the system might delete any image or video content transmitted to the PDD or ICD, log out of any services for controlling remote PDDs or ICDs, revoke access to image and/or video content captured by the PDD(s) or ICD(s) (and/or post-processed using raw captured image data or raw captured video data from the PDD(s) or ICD(s)) stored in the cloud, revoke access to view or modify user preferences (including user preferences related to monitoring media content being presented, monitoring media content downloads, monitoring reactions of users, determining advertisements, sending notifications of determined advertisements, and/or the like), revoke access to view or respond to notifications of media content, and/or the like. This functionality is particularly useful and applicable to PDDs or ICDs (or other devices) that are neither owned nor associated with the user (e.g., a friend's or relative's device, devices at a vacation hotel or vacation rental property, etc.). Such determination and content/access removal might, in some instances, be based on a time-out system (e.g., 5, 15, 30, or 80 minutes, etc.), in which the system might account for the user's temporary absence from the room, while protecting the access to profiles (with which accessing and control of the PDD(s) or ICD(s) may be associated and/or with which user preferences may be associated), and/or content. In some cases, the user can select specific time-out periods, which can be stored in the user's profile, and such specific time-out periods can be universally applicable to some or all profiles, some or all media content, or some or all profiles and media content, or can be specific to particular profiles and/or media content. In some cases, user profiles might be associated with a much shorter time-out period (a time between 1-5 minutes) compared with media content (which might have a time-out period ranging from 15 minutes to 3 hours, or the like). The time-out system might be based on a counter or clock system that starts counting from the last time the system recognized that the user was in range of any of the sensors of the PDD or ICD. Any suitable techniques other than the time-out system described above may be implemented as appropriate. Of course, in response to detecting that the user is no longer present, the PDD(s) or ICD(s) might either stop presenting the at least one advertisement (if currently being presented) or not present the at least one advertisement (if not yet presented).

The reader should note that a wide variety of presence-based functions (including, without limitation, those described in the Related Applications) can be performed by the system in conjunction with various techniques described as part of the methods 200, 300, and/or 400, and that such functions can be combined in any suitable way. Based on this disclosure, the skilled reader will understand that such techniques can be combined in a number of different ways.

FIG. 5 illustrates a functional diagram of a system 500 for enabling or implementing presence detection and/or advertising based on detected presence and/or based on monitored media content or monitored users, in accordance with one set of embodiments. The skilled reader should note that the arrangement of the components illustrated in FIG. 5 is functional in nature, and that various embodiments can employ a variety of different structural architectures. Merely by way of example, one exemplary, generalized architecture for the system 500 is described below with respect to FIG. 8, but any number of suitable hardware arrangements can be employed in accordance with different embodiments.

In FIG. 5, a PDD 505 might correspond to ICD 105, video calling device 105, and/or PDD 105, while user device 545 might correspond to non-ICD user device 105, non-video calling device user device 105, or non-PDD user device 105, as described in detail above with respect to FIG. 1. Control server 510, network 515, and cloud storage system 530, in the example of FIG. 5, might correspond to control server 110, network 115, and cloud storage system 130, respectively, as described in detail above with respect to FIG. 1.

System 500 might further comprise a local content source 535 (e.g., a local content source as described above), a display device 540 (including, without limitation, a television (“TV”) and/or the like), and high-definition (“HD”) data cables 550 (or any other suitable data transmission media). In some cases, the HD data cables 550 might include, without limitation, high-definition multimedia interface (“HDMI”) cables. One or more of the PDDs 505 (e.g., the first PDD 505a and the second PDD 505b, as shown in FIG. 5) might be configured to provide pass-through audio and/or video from a local content source 535 to a display device 540 (e.g., using data cables 550). Merely by way of example, in some embodiments, an HDMI input port in the PDD 505 allows HD signals to be input from the corresponding local content source 535, and an HDMI output port in the PDD 505 allows HD signals to be output from the PDD 505 to the corresponding display device 540 (e.g., TV, which might include, but is not limited to, an Internet Protocol TV (“IPTV”), an HDTV, a cable TV, or the like). The output HD signal may, in some cases, be the input HD signal modified by the PDD 505. Local content source 535 might be any suitable local content source. An noted above, a local content source can be any device that provides an audio or video stream to a display device and thus can include, without limitation, a cable or satellite STB, an IPTV STB, devices that generate video and/or audio, and/or acquire video and/or audio from other sources, such as the Internet, and provide that video/audio to a display device; hence a local content source can include devices such as a video game console, a Roku® streaming media player, an AppleTV®, and/or the like. Hence, when situated functionally inline between a local content source and a display device, the PDD 505 can receive an audiovisual stream output from the local content source, modify that audiovisual stream in accordance with the methods described in the '182 patent, and provide the (perhaps modified) audiovisual stream as input to the display device 540. In some embodiments, first PDD 505a, local content source 535a, display device 540a, and user device 545a (if any) might be located at a first customer premises 560a, while second PDD 505b, local content source 535b, display device 540b, and user device 545b (if any) might be located at a second customer premises 560c. According to some embodiments, a user device 545, might be located at a customer premises 560, might be a portable user device (including, without limitation, a tablet computer, a laptop computer, a smart phone, a mobile phone, a portable gaming device, and/or the like) that is not bound to any particular customer premises 560. In some embodiments, system 500 might further comprise a plurality of customer premises through customer premises 560n, at each of which might be a PDD 505 (with PDD 505n at customer premises 560n) and a local content source 535 (with local content source 535n at customer premises 560n), and/or the like.

According to some embodiments, system 500 might further comprise one or more access points (not shown), each of which might be located in proximity to or in the first customer premises 560a, the second customer premises 560b, through the N^{th} customer premises 560n. The access point(s) can allow wireless communication between each PDD 505 and network 515. (Of course, a PDD 505 might also have a wired connection to an access point, router, residential gateway, etc., such as via an Ethernet cable, which can provide similar communication functionality.) In some cases (as shown), each PDD 505 might be communicatively coupled to network 515 (via either wired or wireless connection), without routing through any access points. In some cases, wired or wireless access to network 515 allows PDD 505 to obtain profiles from cloud storage system 530 and/or media content from content server 570 (e.g., content server 570a) and media content database 575 (e.g., media content database 575a) independent of the corresponding local content source 535, which is in communication with a television (“TV”) distribution network 565 (either via wireless connection or via wired connection). In some cases (not shown), TV distribution network 565 (which could be, for example, a cable television distribution network, a satellite television distribution network, an Internet Protocol television (“IPTV”) distribution network, and/or the like) might be communicatively coupled with content server 570, and thus local content source 535 might obtain media content from content server 570 and media content database 575 independently of PDD 505. Alternatively or in addition, the television distribution network 565 might be communicatively coupled to other content servers (e.g., content server 570b or the like) and/or other media content sources (e.g., media content database 575b or the like).

In this manner, PDD 505 can overlay the input signal from the corresponding local content source 535 with additional media content to produce an augmented output HD signal to the corresponding display device 540 via data cables 550. This functionality allows for supplemental content (which may be associated with the media content accessed by the local content source 535 for display on display device 540) to be accessed and presented using the first PDD 505, in some cases, as a combined presentation on the display device 540, which may be one of an overlay arrangement (e.g., a picture-in-picture (“PIP”) display, with the supplemental content overlaid on the main content), a split screen arrangement (with the supplemental content adjacent to, but not obscuring, any portion of the main content), a passive banner stream (with non-interactive supplemental content streaming in a banner(s) along one or more of a top, bottom, left, or right edge of a display field in which the main content is displayed on display device 540), and/or an interactive banner stream (with interactive supplemental content streaming in a banner(s) along one or more of a top, bottom, left, or right edge of a display field in which the main content is displayed on display device 540). Herein, examples of interactive supplemental content might include, without limitation, content that when streamed in a banner can be caused to slow, stop, and/or replay within the banner, in response to user interaction with the content and/or the banner (as opposed to passive banner streaming, in which information is streamed in a manner uncontrollable by the user). The interactive supplemental content that is streamed in the banner may, in some instances, also allow the user to invoke operations or functions by interacting therewith; for example, by the user highlighting and/or selecting the supplemental content (e.g., an icon or still photograph of a character, actor/actress, scene, etc. associated with the main content), links for related webpages, links to further content stored in media content database 575, or operations to display related content on display device 540 and/or user device 545 may be invoked. In some embodiments, the interactive supplemental content might include notifications or messages relating to recommendations of media content, the determination and generation of which are described in detail above. According to some embodiments, the interactive supplemental content (whether related or unrelated to the media content being presented) might include advertisement content (such as determined (i.e., selected and/or generated) according to embodiments described above with respect to FIGS. 1-4, or the like).

In some instances, PDD 505 might detect the presence and/or proximity of one or more user devices 545 associated with the user, and might (based on user profile information associated with the user that is stored, e.g., in cloud storage system 530) automatically send supplemental media content via wireless link 555 (directly from PDD 505 or indirectly via an access point (not shown)) for display on a display screen(s) of the one or more user devices 545. In one non-limiting example, a user associated with first PDD 505a might have established a user profile stored in cloud storage system 530 that indicates a user preference for any and all supplemental content for movies and television programs to be compiled and displayed on one or more user devices 545a (including, but not limited to, a tablet computer, a smart phone, a laptop computer, and/or a desktop computer, etc.) concurrent to display of the movie or television program being displayed on display device 540a. In such a case, when a movie is playing on display device 540a broadcast or streamed via local content source 535a from content server 570 and media content database 575 (and/or from some other content server and some other media content source) via network 565, first PDD 505a accesses supplemental content (if available) from content server 570 and media content database 575 via network 515, and sends the supplemental content to the user's tablet computer and/or smart phone via wireless link(s) 555. For example, bios of actors, actresses, and/or crew might be sent to the user's smart phone for display on the screen thereof, while schematics of machines, weapons, robots, tools, etc. associated with the movie or television show might be sent to and displayed on the user's tablet computer, behind the scenes videos or information, news/reviews associated with the main content, and/or music videos associated with the main content may also be sent to the user's smart phone and/or tablet computer, and so on.

Merely by way of example, in some embodiments, first media content might be received by local content source 535a (in customer premises 560a) from media content database 575b via content server 570 and content distribution network 565. The first PDD 505a might provide pass through capability for displaying video aspects (in some cases audio aspects as well) of the first media content from the local content source 535a. As the first media content passes through the first PDD 505a, the first PDD 505a might monitor the media content, and might generate or select advertisements based at least in part on the monitored media content. Alternatively, or in addition, the first PDD 505a might comprise sensors (e.g., camera, microphone, proximity sensors, user device sensors, communications links, etc.) that monitor the user(s) within the same room, e.g., to monitor or track reactions of each user (including, but not limited to, vocal expressions or outbursts, facial expressions, hand gestures, body gestures, eye movement, eye focus, shift in proximity with respect to the PDD, and/or the like), using any number or combination of techniques, including, without limitation, facial recognition techniques, facial expression recognition techniques, mood recognition techniques, emotion recognition techniques, voice recognition techniques, vocal tone recognition techniques, speech recognition techniques, eye movement tracking techniques, eye focus determination techniques, proximity detection techniques, and/or the like. The first PDD 505a might determine advertisements based at least in part on the monitored reactions of each user.

In some instances, the first PDD 505a might send the information associated with the monitored media content and/or information associated with the monitored reactions of each user to control server 510 over network 515, and control server 510 might determine (i.e., select and/or generate) advertisements based at least in part on the monitored media content and/or based at least in part on the monitored reactions of each user. In some cases, control server 510 might alternatively or additionally determine (i.e., select and/or generate) advertisements for the users associated with the first PDD 505a (herein, “first users”) based at least in part on the monitored media content from one or more of second through N^{th} PDDs 505b-505n and/or based at least in part on the monitored reactions of users monitored by (or otherwise associated with) second through N^{th} PDDs 505b-505n (herein, “second users”). Here, the second users might be friends of the first users (i.e., known friends, potential friends, or social media friends), might be unrelated yet belonging to a similar demographic group(s), or might be unrelated but representative of a particular population group (either a population group to which the first users belong or some other population group). Alternatively, or in addition, control server 510 might determine (i.e., select and/or generate) advertisements for the first users based at least in part on trending information, which might include, without limitation, first trending information regarding television programs similar to the first media content, second trending information regarding movies similar to the first media content, third trending information regarding music similar to the first media content, fourth trending information regarding gaming content similar to the first media content, fifth trending information regarding news programs similar to the first media content, sixth trending information regarding sports events similar to the first media content, seventh trending information regarding video clips similar to the first media content, eighth trending information regarding advertisement content similar to the first media content, or ninth trending information regarding Internet-based media content similar to the first media content, and/or the like.

In the embodiments in which multiple first users are present, determination (i.e., selection and/or generation) of advertisements might take into account similarities and differences amongst the first users, and as such might include determination (i.e., selection and/or generation) of one or more advertisements that are likely to be accepted by at least a majority of the group of first users. In some cases, likes, dislikes, or indifferences of each user with respect to particular advertisements or type of advertisements might be taken into account when determining (i.e., selecting or generating) advertisements for a group. Viewing patterns of each user (either alone or in particular groups with one or more of the present users of the group) might also be taken into account.

According to some embodiments, the detection of the presence of the user device 545 by the first PDD 505a through the N^{th} PDD 505n might allow identification of a user and thus access of profiles, content, and/or messages and notifications associated with the user's account, regardless of whether the first PDD 505a through the N^{th} PDD 505n is owned by and/or associated with the user. Herein, the user's media content might include, without limitation, at least one of purchased video content, purchased audio content, purchased video game, purchased image content, rented video content, rented audio content, rented video game, rented image content, user-generated video content, user-generated audio content, user-generated video game content, user generated image content, and/or free media content, while the user's profiles might include, but is not limited to, one or more of user profile information for a video game or video game console, web browser history and/or bookmarks, contact information for the user's contacts, user profile information for video or audio content, including without limitation recommended content, device preferences, messaging preferences, videomail preferences, user profile information for cloud services, and/or the like. Videomail, herein, might refer to videomail messages addressed to the user or callee. In some cases, the user's profile might also include identifying information—including, but not limited to, the user's biometric information (e.g., facial characteristics, voice characteristics, fingerprint characteristics, iris characteristics, pupil characteristics, retinal characteristics, etc.), user's past monitored reactions (e.g., vocal expressions or outbursts, facial expressions, hand gestures, body gestures, eye movement, eye focus, shift in proximity with respect to the PDD, and/or the like), or the like. In some examples, the user profile information for cloud services might include user log-in information (e.g., username, account number, and/or password/passphrase, etc.) or other suitable credentials for cloud services, which might include, without limitation, video calling service, videomail service, voice calling service, video broadcast/streaming service, audio broadcast/streaming service, on-line gaming service, banking/financial services, travel/accommodation/rental vehicle services, and/or dining/entertainment event reservation/ticketing services, or the like.

In one example, a user might be associated with first PDD 505a (located in the first customer premises 560a), while her friend might be associated with second PDD 505b (located in the second customer premises 560b), and the user and the friend are both subscribers of a similar service provided by control server 510 and/or the cloud service provider associated with control server 510. When the user visits her friend, the friend's PDD 505b might first detect presence of the user, by querying and/or obtaining the identification information for the user's smart phone and/or tablet computer or the like, by capturing video, image, and/or voice data of the user, by infrared detection of a living person in the room, and/or by audio detection of a living person in the room, etc. The friend's PDD 505b might then identify the user using the user's device(s) identification information and/or the captured video, image, and/or voice data, or might send such presence information to control server 510 for identification and authentication analysis. In some cases, detecting presence of, or identifying/authenticating, the user might include, without limitation, analyzing captured images or video segments using one or more of facial recognition software, pupil/iris recognition software, retinal identification software, fingerprint analysis software, and/or physiology recognition software, analyzing captured audio samples using one or more of voiceprint analysis and/or comparison with stored challenge/response information, and/or identification of a user device owned by and/or associated with the user (e.g., based on identification information of the device, which may be previously associated with the user or the user's profile(s), etc.). In terms of detection of the presence of the user's device, any suitable technique may be implemented including, but not limited to, at least one of detecting a Bluetooth connection of the user device, detecting that the user device is associated with a WiFi access point with which the video calling device has associated, and/or communicating with the user device using near field communication (“NFC”).

Once the user has been identified and authenticated, control server 510 might send copies of the user's profiles and/or content to the second PDD 505b (either from first PDD 505a and/or from cloud storage system 530, or the like), or at least provide the user with access to her profiles, notifications of media content recommendations, notification of determined advertisements, preferences for advertisements, videomail, and/or content from her friend's PDD 505b. In some embodiments, the identification and authentication processes might include comparing the user device identification information and/or the captured video, image, and/or voice data against all similar identification data for all users/subscribers of the cloud service that are stored in cloud storage system 530. In some cases, the process might be facilitated where PDDs 505a and 505b might already be associated with each other (e.g., where the user has previously made a video call from first PDD 505a to her friend on second PDD 505b, where the user might have added the friend to the user's contact list, and/or where the friend might have added the user to the friend's contact list). In other cases, the user's first PDD 505a might have access to the user's calendar and/or communications, which might indicate that the user is visiting the friend. The first PDD 505a might query control server 510 to determine whether the friend has a PDD 505b associated with the cloud service provider. In this example, the first PDD 505a determines that second PDD 505b is part of the same service and/or is in communication with control server 510, and based on such determination, first PDD 505a (and/or control server 510) might send the user's profiles and/or content to second PDD 505b, and/or provide second PDD 505b with access to the user's profiles, notifications of media content recommendations, notifications of determined advertisements, preferences for advertisements, videomail, and/or content. In some embodiments, the user's profiles, notifications of media content recommendations, notifications of determined advertisements, preferences for advertisements, videomail, and/or content, or access to profiles, notifications of media content recommendations, notifications of determined advertisements, preferences for advertisements, videomail, and/or content, might be encrypted, and might be released/decrypted upon identification and/or authentication by second PDD 505b (and/or by control server 510) when the user is detected by second PDD 505b. In this manner, the user's profiles, notifications of media content recommendations, notifications of determined advertisements, preferences for advertisements, videomail, and/or content can follow the user wherever she goes, so long as there is a device (e.g., PDD or video calling device) that is associated with the same or affiliate cloud service provider at her destination, and so long as the device can recognize and authenticate the user.

By the same token, if the user is no longer detected by the second PDD 505b, either after a predetermined number of prompts or queries for the user and/or after a predetermined period of time (e.g., after a specified number of minutes, hours, days, weeks, months, etc.), second PDD 505b (and/or control server 510) might determine that the user is no longer present at the location of second PDD 505b. Based on such a determination, second PDD 505b and/or control server 510 might remove the user's profiles, notifications of media content recommendations, notifications of determined advertisements, preferences for advertisements, videomail, and/or media content (or access thereto) from second PDD 505b. As described above, a time-out system might be utilized. Alternatively, other suitable systems may be used for determining the user is no longer present, and removing the user's profiles, notifications of media content recommendations, notifications of determined advertisements, preferences for advertisements, videomail, and/or media content (or access thereto) from the second PDD 505b. In some cases, once the user is determined to no longer be present at the location of the second PDD 505b, the system might either stop presenting the advertisement(s) (if currently being presented) or not present the advertisement(s) (if not yet presented).

In some embodiments, System 500 might further comprise an advertisement server 580 (which in some cases may be associated with an advertiser, while in other cases may be associated with the service provider) and database 585. In some cases, the advertisement server 580 might be used to calculate, select, determine, or generate one or more advertisements, based on a number of factors, which might include, but are not limited to, age factor of a media content, trending quotient or characteristic of the media content, geographical factor of the media content, topic of the media content, monitored information regarding the target user(s), profile information regarding the target user(s), or other factors discussed above with respect to FIGS. 1-4, and/or the like. Database 585 may be used to store some or all of the information used to generate the advertisements, to store generated advertisements, to store preference information of the user(s) regarding presentation of the generated advertisements to the user(s), and/or the like.

FIGS. 6A-6D (collectively, “FIG. 6”) are illustrations of user devices 600 used by users that present exemplary graphical user interfaces, in accordance with various embodiments. In particular, each of FIG. 6A-6D is an illustration of a user device used by users that presents an exemplary graphical user interface for notifying users regarding advertisements determined to be relevant to the users.

In FIG. 6, although user devices 600 in FIGS. 6A and 6D are shown as display devices (e.g., monitors, HDTVs, IPTVs, cable TVs, etc.), user device 600 in FIG. 6B is shown as a smart phone, and user device 600 in FIG. 6C is shown as a tablet computer, the various embodiments are not so limited, and user devices 600 might be any suitable user device comprising, without limitation, an HDTV, an IPTV, a cable TV, a desktop computer, a laptop computer, a tablet computer, a smart phone, a mobile phone, a portable gaming device, other suitable user devices, or any combination of these user devices.

Each user device 600 might comprise device housing 605, a display screen 605a, and the like. In some embodiments, display screen 605a might comprise a touchscreen display, a non-touchscreen display, and/or the like. In the examples of FIG. 6, a panel 610 of a graphical user interface (“GUI”) might present or display visual aspects of media content (including, without limitation, a movie, a television program, a game, news-related content, sports-related content, video clip, advertisement content, Internet-based media content, and/or the like).

In the embodiment illustrated in FIG. 6, a panel 615 might represent a notification panel (which might include, without limitation, a pop-up or PIP window 615 (as shown in FIGS. 6A, 6B, and 6D), a split screen arrangement, a passive banner (not shown), an interactive banner (not shown), etc., which are described above with respect to FIG. 2).

User device 600 might further include a camera or other image/video capture device(s) 620 or other sensors 620 (e.g., audio capture devices, proximity detection devices, motion sensing devices, heat sensing devices, communications devices, and/or the like, as described in detail above with respect to FIGS. 1-5).

In the example of FIG. 6C, GUI 610 might be a GUI for an electronic mail (i.e., e-mail) software application (in this example, “BMail”). The GUI 610 (which may be a free floating GUI window or panel filling a portion of the display screen 605a or may be a software application that fills the entire display screen 605a) might comprise a window that might be divided into two or more panels 615, 625, and 630, e.g., by using a split screen arrangement or a separate window arrangement (which might stack or tile the separate windows). Alternatively, the two or more panels 615, 625, and 630 might be independent windows or related but separate windows. GUI 410 might comprise a header portion 635, which might include a logo for the e-mail software application (in this case, “BMail”), a welcome notice for the user (who in this example has logged into the e-mail account), a link for the user to edit profiles, options, or otherwise manage his or her account (“My Account” link), and an option to log out of the e-mail account. GUI 610 might further comprise a search bar or search field 640, which might comprise an input search field, a search command button or link, and an option to access advanced search options (including, but not limited to, searching the user's e-mail by one or more of keywords, recipients, senders, dates or date ranges, or the like etc.).

In this case, an e-mail from the user's service provider might have been received by the user, the e-mail notifying the user regarding advertisements that are selected or generated for the user. The e-mail might include links or options within the e-mail (e.g., embedded in text in the message, e.g., as a hyperlink or the like) to view, listen, or play the advertisement, as well as links or options for viewing, listening, or playing other advertisements, etc. (not shown).

With respect to the advertisements, non-limiting examples are shown, e.g., in panels or windows 615 of FIGS. 6A-6D, including, without limitation, advertisements for travel packages (shown in FIG. 6A), flight deals (shown in FIG. 6B), media content (shown in FIG. 6C as a non-limiting e-mail advertisement for Blu-ray set for past seasons of television series 24), gaming content (shown in FIG. 6D as a non-limiting in-console (or in-game GUI or in-game notification) for game purchase, based on current gameplay by known friends or social media friends of the user), and/or the like. Although specific examples of advertisements are shown in FIG. 6, the various embodiments are not so limited, and any suitable type of advertisements may be generated for any suitable type of products or services. Suitable types of advertisements might include, but are not limited to, television advertisements, phone-based advertisements, e-newspaper advertisements, e-magazine advertisements, e-book reader-based advertisements, advertisements on websites visited by the user, advertisements on social media used by the user, e-mail advertisements, SMS advertisements, MMS advertisements, chat advertisements, in-video game advertisements, app-based advertisements for computing devices and/or mobile devices, in-store advertisements targeting users based on presence detection, presence detection-based targeted advertisement in any public or private venue, and/or the like. Suitable types of products might include, without limitation, media content products (e.g., videos, music, photos or images, etc. either in electronic form, in physical form, or in electronic recording media, and/or the like, as appropriate), consumer electronics, consumer products, groceries, cooking products or other kitchen and/or BBQ tools, cars or other vehicles, toys, household products, hygiene products, cleaning products, travel-related products, sports equipment, tickets for entertainment events, sports events, travel, brand products, and/or the like. Suitable types of service might include, discounts for any of the products listed or the like, discounts for restaurants, cleaning services, rental services, repair services, advertisement services, sales services, travel tour packages, discounts for admission to amusement parks, museums, local/state/national/international tourist sites, discounts for hotels or other accommodations, discounts for vehicle rentals, and/or the like.

FIG. 7 provides a schematic illustration of one embodiment of a computer system 700 that can perform the methods provided by various other embodiments, as described herein, and/or can function as a video calling device, ICD, PDD, user device, control server, server computer, web server, and/or the like. It should be noted that FIG. 7 is meant only to provide a generalized illustration of various components, of which one or more (or none) of each may be utilized as appropriate. FIG. 7, therefore, broadly illustrates how individual system elements may be implemented in a relatively separated or relatively more integrated manner.

The computer system 700 is shown comprising hardware elements that can be electrically coupled via a bus 705 (or may otherwise be in communication, as appropriate). The hardware elements may include one or more processors 710, including without limitation one or more general-purpose processors and/or one or more special-purpose processors (such as digital signal processing chips, graphics acceleration processors, and/or the like); one or more input devices 715, which can include, without limitation, a mouse, a keyboard, and/or the like; and one or more output devices 720, which can include, without limitation, a display device, a printer, and/or the like.

The computer system 700 may further include (and/or be in communication with) one or more storage devices 725, which can comprise, without limitation, local and/or network accessible storage, and/or can include, without limitation, a disk drive, a drive array, an optical storage device, solid-state storage device such as a random access memory (“RAM”) and/or a read-only memory (“ROM”), which can be programmable, flash-updateable, and/or the like. Such storage devices may be configured to implement any appropriate data stores, including, without limitation, various file systems, database structures, and/or the like.

The computer system 700 might also include a communications subsystem 730, which can include, without limitation, a modem, a network card (wireless or wired), an infra-red communication device, a wireless communication device and/or chipset (such as a Bluetooth™ device, an 802.11 device, a WiFi device, a WiMax device, a WWAN device, cellular communication facilities, etc.), and/or the like. The communications subsystem 730 may permit data to be exchanged with a network (such as the network described below, to name one example), with other computer systems, and/or with any other devices described herein. In many embodiments, the computer system 700 will further comprise a working memory 735, which can include a RAM or ROM device, as described above.

The computer system 700 also may comprise software elements, shown as being currently located within the working memory 735, including an operating system 740, device drivers, executable libraries, and/or other code, such as one or more application programs 745, which may comprise computer programs provided by various embodiments, and/or may be designed to implement methods, and/or configure systems, provided by other embodiments, as described herein. Merely by way of example, one or more procedures described with respect to the method(s) discussed above might be implemented as code and/or instructions executable by a computer (and/or a processor within a computer); in an aspect, then, such code and/or instructions can be used to configure and/or adapt a general purpose computer (or other device) to perform one or more operations in accordance with the described methods.

A set of these instructions and/or code might be encoded and/or stored on a non-transitory computer readable storage medium, such as the storage device(s) 725 described above. In some cases, the storage medium might be incorporated within a computer system, such as the system 700. In other embodiments, the storage medium might be separate from a computer system (i.e., a removable medium, such as a compact disc, etc.), and/or provided in an installation package, such that the storage medium can be used to program, configure, and/or adapt a general purpose computer with the instructions/code stored thereon. These instructions might take the form of executable code, which is executable by the computer system 700 and/or might take the form of source and/or installable code, which, upon compilation and/or installation on the computer system 700 (e.g., using any of a variety of generally available compilers, installation programs, compression/decompression utilities, etc.) then takes the form of executable code.

It will be apparent to those skilled in the art that substantial variations may be made in accordance with specific requirements. For example, customized hardware (such as programmable logic controllers, field-programmable gate arrays, application-specific integrated circuits, and/or the like) might also be used, and/or particular elements might be implemented in hardware, software (including portable software, such as applets, etc.), or both. Further, connection to other computing devices such as network input/output devices may be employed.

As mentioned above, in one aspect, some embodiments may employ a computer system (such as the computer system 700) to perform methods in accordance with various embodiments of the invention. According to a set of embodiments, some or all of the procedures of such methods are performed by the computer system 700 in response to processor 710 executing one or more sequences of one or more instructions (which might be incorporated into the operating system 740 and/or other code, such as an application program 745) contained in the working memory 735. Such instructions may be read into the working memory 735 from another computer readable medium, such as one or more of the storage device(s) 725. Merely by way of example, execution of the sequences of instructions contained in the working memory 735 might cause the processor(s) 710 to perform one or more procedures of the methods described herein.

According to some embodiments, system 700 might further comprise one or more sensors 750, which might include, without limitation, one or more cameras, one or more IR sensors, and/or one or more 3D sensors, or the like. In some cases, the one or more sensors 750 might be incorporated in (or might otherwise be one of) the input device(s) 715. The output device(s) 720 might, in some embodiments, further include one or more monitors, one or more TVs, and/or one or more display screens, or the like.

The terms “machine readable medium” and “computer readable medium,” as used herein, refer to any medium that participates in providing data that causes a machine to operate in a specific fashion. In an embodiment implemented using the computer system 700, various computer readable media might be involved in providing instructions/code to processor(s) 710 for execution and/or might be used to store and/or carry such instructions/code (e.g., as signals). In many implementations, a computer readable medium is a non-transitory, physical, and/or tangible storage medium. Such a medium may take many forms, including, but not limited to, non-volatile media, volatile media, and transmission media. Non-volatile media includes, for example, optical and/or magnetic disks, such as the storage device(s) 725. Volatile media includes, without limitation, dynamic memory, such as the working memory 735. Transmission media includes, without limitation, coaxial cables, copper wire and fiber optics, including the wires that comprise the bus 705, as well as the various components of the communication subsystem 730 (and/or the media by which the communications subsystem 730 provides communication with other devices). Hence, transmission media can also take the form of waves (including, without limitation, radio, acoustic, and/or light waves, such as those generated during radio-wave and infra-red data communications).

Common forms of physical and/or tangible computer readable media include, for example, a floppy disk, a flexible disk, a hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave as described hereinafter, or any other medium from which a computer can read instructions and/or code.

Various forms of computer readable media may be involved in carrying one or more sequences of one or more instructions to the processor(s) 710 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 700. These signals, which might be in the form of electromagnetic signals, acoustic signals, optical signals, and/or the like, are all examples of carrier waves on which instructions can be encoded, in accordance with various embodiments of the invention.

The communications subsystem 730 (and/or components thereof) generally will receive the signals, and the bus 705 then might carry the signals (and/or the data, instructions, etc. carried by the signals) to the working memory 735, from which the processor(s) 705 retrieves and executes the instructions. The instructions received by the working memory 735 may optionally be stored on a storage device 725 either before or after execution by the processor(s) 710.

As noted above, a set of embodiments comprises systems collecting presence information and/or enabling monitoring of media content presentation and determination (e.g., selection or generation) of advertisements, based on presence information (regardless of whether the user device detecting the presence detection is owned by and/or associated with the user). FIG. 8 illustrates a schematic diagram of a system 800 that can be used in accordance with one set of embodiments. The system 800 can include one or more user computers 805. In particular, a user computer 805 can be a video calling device, an ICD, a PDD, and/or a user device, as described above. More generally, a user computer 805 can be a general purpose personal computer (including, merely by way of example, desktop computers, workstations, tablet computers, laptop computers, handheld computers, mobile phones, smart phones, and the like), running any appropriate operating system, several of which are available from vendors such as Apple, Microsoft Corp., as well a variety of commercially-available UNIX™ or UNIX-like operating systems. A user computer 805 can also have any of a variety of applications, including one or more applications configured to perform methods provided by various embodiments (as described above, for example), as well as one or more office applications, database client and/or server applications, and/or web browser applications. Alternatively, a user computer 805 can be any other electronic device, such as a thin-client computer, Internet-enabled mobile telephone, and/or personal digital assistant, capable of communicating via a network (e.g., the network 810 described below) and/or of displaying and navigating web pages or other types of electronic documents. Although the exemplary system 800 is shown with two user computers 805, any number of user computers can be supported.

Certain embodiments operate in a networked environment, which can include a network 810. The network 810 can be any type of network familiar to those skilled in the art that can support data communications using any of a variety of commercially-available (and/or free or proprietary) protocols, including, without limitation, TCP/IP, SNA™, IPX™, AppleTalk™, and the like. Merely by way of example, the network 810 can include a local area network (“LAN”), including, without limitation, a fiber network, an Ethernet network, a Token-Ring™ network and/or the like; a wide-area network; a wireless wide area network (“WWAN”); a virtual network, such as a virtual private network (“VPN”); the Internet; an intranet; an extranet; a public switched telephone network (“PSTN”); an infra-red network; a wireless network, including without limitation a network operating under any of the IEEE 802.11 suite of protocols, the Bluetooth™ protocol known in the art, and/or any other wireless protocol; and/or any combination of these and/or other networks.

Embodiments can also include one or more server computers 815. Each of the server computers 815 may be configured with an operating system, including, without limitation, any of those discussed above with respect to the user computers 805, as well as any commercially (or freely) available server operating systems. Each of the servers 815 may also be running one or more applications, which can be configured to provide services to one or more clients 805 and/or other servers 815.

Merely by way of example, one of the servers 815 might be a control server, with the functionality described above. In another embodiment, one of the servers might be a web server, which can be used, merely by way of example, to provide communication between a user computer 805 and a control server, for example, to process requests for web pages or other electronic documents from user computers 805 and/or to provide user input to the control server. The web server can also run a variety of server applications, including HTTP servers, FTP servers, CGI servers, database servers, Java servers, and the like. In some embodiments of the invention, the web server may be configured to serve web pages that can be operated within a web browser on one or more of the user computers 805 to perform operations in accordance with methods provided by various embodiments.

The server computers 815, in some embodiments, might include one or more application servers, which can be configured with one or more applications accessible by a client running on one or more of the client computers 805 and/or other servers 815. Merely by way of example, the server(s) 815 can be one or more general purpose computers capable of executing programs or scripts in response to the user computers 805 and/or other servers 815, including, without limitation, web applications (which might, in some cases, be configured to perform methods provided by various embodiments). Merely by way of example, a web application can be implemented as one or more scripts or programs written in any suitable programming language, such as Java™, C, C#™ or C++, and/or any scripting language, such as Perl, Python, or TCL, as well as combinations of any programming and/or scripting languages. The application server(s) can also include database servers, including, without limitation, those commercially available from Oracle™, Microsoft™, Sybase™, IBM™, and the like, which can process requests from clients (including, depending on the configuration, dedicated database clients, API clients, web browsers, etc.) running on a user computer 805 and/or another server 815. In some embodiments, an application server can create web pages dynamically for displaying the information in accordance with various embodiments, such as providing a user interface for a control server, as described above. Data provided by an application server may be formatted as one or more web pages (comprising HTML, JavaScript, etc., for example) and/or may be forwarded to a user computer 805 via a web server (as described above, for example). Similarly, a web server might receive web page requests and/or input data from a user computer 805 and/or forward the web page requests and/or input data to an application server. In some cases, a web server may be integrated with an application server.

In accordance with further embodiments, one or more servers 815 can function as a file server and/or can include one or more of the files (e.g., application code, data files, etc.) necessary to implement various disclosed methods, incorporated by an application running on a user computer 805 and/or another server 815. Alternatively, as those skilled in the art will appreciate, a file server can include all necessary files, allowing such an application to be invoked remotely by a user computer 805 and/or server 815.

It should be noted that the functions described with respect to various servers herein (e.g., application server, database server, web server, file server, etc.) can be performed by a single server and/or a plurality of specialized servers, depending on implementation-specific needs and parameters. Further, as noted above, the functionality of one or more servers 815 might be implemented by one or more containers or virtual machines operating in a cloud environment and/or a distributed, cloud-like environment based on shared resources of a plurality of user video calling devices, a plurality of ICDs, and/or a plurality of PDDs.

In certain embodiments, the system can include one or more data stores 820. The nature and location of the data stores 820 is discretionary: merely by way of example, one data store 820 might comprise a database 820a that stores information about master accounts, user profiles, user preferences, assigned video calling devices, viewing/listening/Internet browsing/gaming patterns, viewing/listening/Internet browsing/gaming history, etc. Alternatively and/or additionally, a data store 820b might be a cloud storage environment for storing master accounts, user profiles, user preferences, uploaded monitored reactions of users, and/or the like.

As the skilled reader can appreciate, the database 820a and the cloud storage environment 820b might be collocated and/or separate from one another. Some or all of the data stores 820 might reside on a storage medium local to (and/or resident in) a server 815a. Conversely, any of the data stores 820 (and especially the cloud storage environment 820b) might be remote from any or all of the computers 805, 815, so long as it can be in communication (e.g., via the network 810) with one or more of these. In a particular set of embodiments, a database 820a can reside in a storage-area network (“SAN”) familiar to those skilled in the art, and/or the cloud storage environment 820b might comprise one or more SANs. (Likewise, any necessary files for performing the functions attributed to the computers 805, 815 can be stored locally on the respective computer and/or remotely, as appropriate.) In one set of embodiments, the database 820a can be a relational database, such as an Oracle database, that is adapted to store, update, and retrieve data in response to SQL-formatted commands. The database might be controlled and/or maintained by a database server, as described above, for example.

As noted above, the system can also include a first PDD 825, a second PDD 830, and a third PDD 835. The first PDD 825 in the context of the examples described herein corresponds to the device associated with the user or audience member, while the second and third PDDs 830-835 might correspond to devices associated with known friends, potential friends, and/or social media friends associated with the user, and/or might correspond to devices associated with people unrelated to the user (which might include people belonging to similar demographic groups as the user, people within a similar geographic region (but not necessarily within similar demographic groups), people who generally represent average persons within a population, and/or the like). Although only three PDDs are illustrated in FIG. 8, it should be appreciated that any number of PDDs 825-835 may be implemented in accordance with various embodiments.

Using the techniques described herein, each of the first PDD 825, the second PDD 830, and the third PDD 835 can determine presence of one or more users or audience members, identify users or audience members, access profiles of the identified users or audience members, determine advertisements for each user or audience member, determine advertisements for a group, and/or the like. In some cases, determining advertisements for each user might be based on one or more of user preferences of each user; known viewing/listening/gaming patterns from the user profile of each user; monitored reactions of each user (including, but not limited to, vocal expressions or outbursts, facial expressions, hand gestures, body gestures, eye movement, eye focus, shift in proximity with respect to the PDD, and/or the like); media content viewed/listened/played by known friends, potential friends, social media friends, and demographic group members; trending media content (including, without limitation, trending television programs, trending movies, trending music, trending gaming content, trending gaming content, trending news programs, trending sports events, trending video clips, trending advertisement content, trending Internet-based media content, and/or the like); and/or the like.

Each of the first PDD 825, the second PDD 830, and the third PDD 835 may be (or may have similar functionality as) a video calling device 105, a user device 105, an ICD 105, or a PDD 105, as described in detail above; in some cases, each of the first PDD 825, the second PDD 830, and the third PDD 835 might be (or may have similar functionality as) a VCD as described in the '182 patent.

While certain features and aspects have been described with respect to exemplary embodiments, one skilled in the art will recognize that numerous modifications are possible. For example, the methods and processes described herein may be implemented using hardware components, software components, and/or any combination thereof. Further, while various methods and processes described herein may be described with respect to particular structural and/or functional components for ease of description, methods provided by various embodiments are not limited to any particular structural and/or functional architecture but instead can be implemented on any suitable hardware, firmware, and/or software configuration. Similarly, while certain functionality is ascribed to certain system components, unless the context dictates otherwise, this functionality can be distributed among various other system components in accordance with the several embodiments.

Moreover, while the procedures of the methods and processes described herein are described in a particular order for ease of description, unless the context dictates otherwise, various procedures may be reordered, added, and/or omitted in accordance with various embodiments. Moreover, the procedures described with respect to one method or process may be incorporated within other described methods or processes; likewise, system components described according to a particular structural architecture and/or with respect to one system may be organized in alternative structural architectures and/or incorporated within other described systems. Hence, while various embodiments are described with—or without—certain features for ease of description and to illustrate exemplary aspects of those embodiments, the various components and/or features described herein with respect to a particular embodiment can be substituted, added, and/or subtracted from among other described embodiments, unless the context dictates otherwise. Consequently, although several exemplary embodiments are described above, it will be appreciated that the invention is intended to cover all modifications and equivalents within the scope of the following claims.

What is claimed is:

1. A method, comprising:
collecting, with a presence detection device, presence information of a user;
identifying the user, with a first computer, based at least in part on identifying information derived from at least a portion of the presence information;
determining, with a second computer, at least one advertisement based at least in part on profile information of the identified user; and
presenting the at least one advertisement to the user.

2. The method of claim 1, wherein the presence detection device comprises:
a video input interface to receive video input from a local content source;
an audio input interface to receive audio input from the local content source;
a video output interface to provide video output to a display device;
an audio output interface to provide audio output to an audio receiver;
an image capture device to capture at least one of image data or video data;
an audio capture device to capture audio data;
a network interface;
at least one processor; and
a storage medium in communication with the at least one processor.

3. The method of claim 2, wherein the presence information comprises at least one of an image captured by the image capture device, a video segment captured by the image capture device, an audio sample captured by the audio capture device, or a detected presence of a user device in proximity to the first presence detection device.

4. The method of claim 2, wherein collecting the presence information comprises capturing one or more images of at least a portion of a room with the image capture device.

5. The method of claim 4, wherein the one or more images comprises a video stream.

6. The method of claim 4, wherein collecting the presence information comprises analyzing the one or more images.

7. The method of claim 6, wherein analyzing the one or more images comprises:
determining a number of people in the room.

8. The method of claim 6, wherein analyzing the one or more images comprises:
determining a collective demographic of a plurality of people in the room.

9. The method of claim 6, wherein at least one of analyzing the one or more images or identifying the user comprises:
determining an identity of at least one person in the room, using facial recognition technology.

10. The method of claim 6, wherein analyzing the one or more images comprises:
determining that a person is watching a display device, using eye tracking technology.

11. The method of claim 10, wherein determining that a person is watching a display device, using eye tracking technology, comprises:
determining that a person is watching particular portions of a display device corresponding to particular portions of media content being displayed on the display device, using eye tracking technology.

12. The method of claim 1, wherein the second computer and the first computer are the same computer.

13. The method of claim 1, wherein at least one of the first computer or the second computer is a control server in communication with the presence detection device over a network.

14. The method of claim 13, wherein presenting the at least one advertisement to the user comprises instructing, with the control server, the presence detection device to present the at least one advertisement to the user.

15. The method of claim 1, wherein presenting the at least one advertisement to the user comprises presenting the at least one advertisement to the user by inserting the at least one advertisement into a video stream.

16. The method of claim 15, wherein inserting the at least one advertisement into a video stream comprises overlaying the video stream with the at least one advertisement using the presence detection device, wherein the presence detection device is inline between a set top box and a television.

17. The method of claim 1, wherein presenting the at least one advertisement to the user comprises sending a message with the at least one advertisement to a user device associated with the first user, wherein the at least one advertisement is in a form of at least one of a video-based advertisement, an audio-based advertisement, an image-based advertisement, a text-based advertisement, or a multi-media-based advertisement, and wherein the message comprises one or more of a text message, a short message service message, a multi-media messaging service message, a chat message, an e-mail message, a videomail message, or a voicemail message.

18. The method of claim 17, wherein the user device associated with the first user comprises at least one of a laptop computer, a smart phone, a mobile phone, a portable gaming device, a desktop computer, a television, a set-top box, or a wearable computing device.

19. The method of claim 1, further comprising collecting, with the presence detection device, feedback from the user regarding the at least one advertisement.

20. The method of claim 19, wherein the at least one advertisement is associated with an advertiser, the method further comprising providing the feedback to the advertiser.

21. The method of claim 1, further comprising:
receiving, with the presence detection device, first media content from a local content source;
monitoring, with the presence detection device, information associated with the first media content;
sending, with the presence detection device, the monitored information associated with the first media content to the second computer over a network;
receiving, with the presence detection device and from the second computer, the determined at least one advertisement, wherein determining the at least one advertisement is based at least in part on the monitored information associated with the first media content and at least in part on the profile information of the identified user.

22. The method of claim 21, wherein the first media content comprises media content type selected from a group consisting of television program content, movie content, music content, gaming content, news-related content, sports-related content, video clip content, advertisement content, and Internet-based media content.

23. The method of claim 21, wherein the information associated with the first media content comprises media content-based information comprising at least one of:
type of media content of the first media content;
genre of media content of the first media content;
duration of the first media content;
time of day that the first media content is received or presented;
performers associated with the first media content;
producers associated with the first media content;
year of release of the first media content;
reviews of the first media content; or
other media content related to the first media content.

24. The method of claim 21, further comprising:
monitoring, with the presence detection device, information associated with the presented at least one advertisement; and
determining, with the second computer, at least one second advertisement, based at least in part on the monitored information associated with the first media content, at least in part on the monitored information associated with the presented at least one advertisement, and at least in part on the profile information of the identified user.

25. The method of claim 24, wherein each of the information associated with the first media content or the information associated with the presented at least one advertisement comprises audience-based information comprising at least one of:
number of audience members present during presentation of particular portions of the first media content or the presented at least one advertisement;
identity of each audience member;
gender of each audience member;
age of each audience member;
demographic group to which each audience member belongs;
viewing patterns of each audience member;
specific reactions of each audience member during presentation of particular portions of the first media content or particular portions of the presented at least one advertisement;
overall reactions of each audience member throughout presentation of the first media content or the presented at least one advertisement;
consistency of audience member reactions of each audience member compared with personal preferences of the audience member; or
consistency of audience member reactions of each audience member compared with past reactions of the audience member.

26. The method of claim 25, wherein each of the specific reactions or the overall reactions comprises reactions selected from a group consisting of:
vocal expressions;
facial expressions;
hand gestures;
body gestures;
eye movement;
eye focus; and
shift in proximity with respect to the presence detection device.

27. The method of claim 25, wherein the audience-based information is monitored using one or more of:
facial recognition techniques;
facial expression recognition techniques;
mood recognition techniques;
emotion recognition techniques;
voice recognition techniques;
vocal tone recognition techniques;
speech recognition techniques;
eye movement tracking techniques;
eye focus determination techniques; or
proximity detection techniques.

28. The method of claim 21, wherein the determination of the at least one advertisement is based at least in part on analysis of one or more of:
identification of each person in a room in which the presence detection device is located;
identification of each person viewing the first media content being displayed on a display device communicatively coupled to a video output interface of the presence detection device; or
identification of each person listening to the first media content being presented over a speaker communicatively coupled to an audio receiver that is communicatively coupled to an audio output interface of the presence detection device.

29. An apparatus, comprising:
a non-transitory computer readable medium having encoded thereon a set of instructions executable by one or more processors to perform one or more operations, the set of instructions comprising:
instructions for receiving presence information from a presence detection device; and
instructions for determining at least one advertisement to serve, based at least in part on the presence information.

30. A system, comprising:
a computer; and
a presence detection device;
the computer comprising:
one or more first processors; and
a first non-transitory computer readable medium in communication with the one or more first processors, the first non-transitory computer readable medium having encoded thereon a first set of instructions executable by the one or more first processors to perform one or more operations, the first set of instructions comprising:
instructions for receiving presence information of a user from the presence detection device; and
instructions for determining at least one advertisement to serve, based at least in part on the presence information of the user;
the presence detection device configured to collect the presence information, the presence detection device comprising:
a video input interface to receive video input from a local content source;
an audio input interface to receive audio input from the local content source;
a video output interface to provide video output to a display device;
an audio output interface to provide audio output to an audio receiver;
an image capture device to capture at least one of image data or video data;
an audio capture device to capture audio data;
a network interface;
one or more second processors; and
a second non-transitory computer readable medium in communication with the one or more second processors, the second non-transitory computer readable medium having encoded thereon a second set of instructions executable by the one or more second processors to control operation of the presence detection device, the second set of instructions comprising:
instructions for controlling the image capture device to capture one of a video stream or at least one image of the user;
instructions for controlling the audio capture device to capture an audio stream;
instructions for encoding the captured video stream and the captured audio stream to produce a series of data packets comprising presence information of the user;
instructions for transmitting, using the network interface, the series of data packets comprising presence information of the user, for reception by the computer;
instructions for receiving, from the computer, the determined at least one advertisement that is based at least in part on the presence information of the user; and
instructions for presenting the determined at least one advertisement to the user.

31. An image capture device configured to be accessible over a network, the image capture device comprising:
an image sensor to capture at least one of image data or video data;
a communication system;
one or more processors; and
a computer readable medium in communication with the one or more processors, the computer readable medium having encoded thereon a set of instructions executable by the computer system to perform one or more operations, the set of instructions comprising:
instructions for collecting presence information of a user; and
instructions for sending the collected presence information to a computer over a network to determine at least one advertisement to serve to the user, based at least in part on profile information of the user.

32. The system of claim 31, wherein the set of instructions further comprises:
instructions for identifying the user, based at least in part on identifying information derived from at least a portion of the presence information,
wherein the instructions for sending the collected presence information to the computer comprises instructions for sending information pertaining to an identification of the user.

33. The system of claim 31, wherein the set of instructions further comprises:
instructions for presenting the at least one advertisement to the user.
